(19) United States
(12) Patent Application Publication
(10) Pub. No.: US 2023/0312772 A1
(43) Pub. Date: Oct. 5, 2023

(54) Multidentate Lewis Base Catalysts and Methods for use Thereof

(71) Applicant: ExxonMobil Chemical Patents Inc., Baytown, TX (US)

(72) Inventors: Irene C. Cai, Webster, TX (US); Hua Zhou, Missouri City, TX (US); Jo Ann M. Canich, Houston, TX (US); John R, Hagadorn, Houston, TX (US); Dmitry V. Uborsky, Moscow (RU); Georgy P. Goryunov, Moscow (RU); Mikhail I. Sharikov, Moscow (RU); Alexander Z. Voskoboynikov, Moscow (RU)

(21) Appl. No.: 18/299,510

(22) PCT Filed: Oct. 20, 2021
(86) PCT No.: PCT/US2021/055831

§ 371 Date: Apr. 12, 2023

Related U.S. Application Data
(60) Provisional application No. 63/104,299, filed on Oct. 22, 2020.

(51) Int. Cl. C08F 4/64

(52) U.S. Cl. CPC C08F 4/64189

(57) ABSTRACT

This invention relates to transition metal complexes of a multi-dentate ligand that features a neutral heterocyclic Lewis base and a second Lewis base, where the multi-dentate ligand coordinates to the metal center to form at least one 8-membered chelate ring.

### CROSS-REFERENCE TO RELATED APPLICATIONS

This application claims the benefit of U.S. Provisional Patent Application 63/104,299, filed Oct. 22, 2020, the entirety of which is hereby incorporated by reference.

This application is related to International Patent Application PCT/US2021/022888, filed Mar. 18, 2021, the entirety of which is hereby incorporated by reference.

### FIELD

This invention relates to novel catalyst compounds comprising a multi-dentate ligand having a neutral heterocyclic Lewis base and a second Lewis base, where the multi-dentate ligand coordinates to the metal center to form at least one 8-membered chelate ring, catalyst systems comprising such, and uses thereof.

### BACKGROUND

Olefin polymerization catalysts are of great use in industry. Hence there is interest in finding new catalyst systems that increase the commercial usefulness of the catalyst and allow the production of polymers having improved properties.

Catalysts for olefin polymerization are often based on transition metal compounds as catalyst precursors, which are activated typically with the help of an alumoxane or an activator containing a non-coordinating anion.

US 2020/0254431 A1, US2020/0255553, and US2020/0255561 disclose olefin polymerization catalyst compounds and catalyst systems comprising group 4 bis(phenolate) complexes having 8-membered chelate rings.

Japanese publication JP 2016-050175, published Apr. 11, 2016 (for JP application number 2014-174451, filed Aug. 28, 2014 entitled Transition Metal Compound, Catalyst For Olefin Polymerization, Method For Producing Olefin Polymer, And Method For Producing 1-Butene) discloses catalyst systems comprising group 4 bis(phenolate) complexes containing a multidentate ligand featuring a bidentate Lewis base having saturated linking groups to the phenolates.

There is still a need in the art for new and improved catalyst systems for the polymerization of olefins, in order to achieve specific polymer properties, such as high melting point, targeted (high or low) molecular weights, to increase conversion or comonomer incorporation, or to alter comonomer distribution without deteriorating the resulting polymer's properties.

It is therefore an object of the present invention to provide novel catalyst compounds, catalysts systems comprising such compounds, and processes for the polymerization of olefins using such compounds and systems.

### SUMMARY

This invention relates to transition metal complexes of a multi-dentate ligand that features a neutral heterocyclic Lewis base and a second Lewis base, where the multi-dentate ligand coordinates to the metal center to form at least one 8-membered chelate ring.

This invention relates to a catalyst compound represented by the Formula (I):

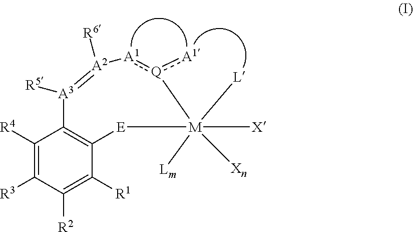

wherein:
M is a group 3, 4, 5, or 6 transition metal or Lanthanide;
E is O, S, or NR⁹⁹, where R⁹⁹ is hydrogen, C₁-C₄₀ hydrocarbyl, C₁-C₄₀ substituted hydrocarbyl, monovalent heteroatom, or a monovalent substituted heteroatom group;
Q is group 14, 15, or 16 atom that forms a bond to metal M;
A¹ and A^{1′} are independently C, N, or C(R³²), where R³² is selected from hydrogen, C₁-C₂₀ hydrocarbyl, C₁-C₂₀ substituted hydrocarbyl, monovalent heteroatom, or a monovalent substituted heteroatom group;
A¹QA^{1′} are part of a heterocyclic Lewis base containing 4 to 40 non-hydrogen atoms;
A² and A³ are independently a group 14 atom;
each R^{5′} and R^{6′} is independently hydrogen, C₁-C₄₀ hydrocarbyl, C₁-C₄₀ substituted hydrocarbyl, monovalent heteroatom, or a monovalent substituted heteroatom group;
R^{6′}-A²=A³-R^{5′} is a divalent group containing 2 to 40 non-hydrogen atoms, where R^{5′} and R^{6′} optionally join to form a hydrocarbyl ring, a substituted hydrocarbyl ring, a heterocyclic ring, or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
L′ is a neutral Lewis base joined to the heterocyclic Lewis base containing A¹QA^{1′};
X′ is an anionic ligand that is optionally joined to L′;
L is a neutral Lewis base;
X is an anionic ligand;
n is 1 or 2;
m is 0 or 1;
n+m is 0, 1 or 2;
each of R¹, R², R³, and R⁴ is independently hydrogen, C₁-C₄₀ hydrocarbyl, C₁-C₄₀ substituted hydrocarbyl, monovalent heteroatom, or a monovalent substituted heteroatom group, or optionally one or more of R¹ and R², R² and R³, R³ and R⁴, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms; and
an X group may be joined to an L group to form a monoanionic bidentate group, and any two X groups may be joined together to form a dianionic ligand group.

This invention further relates to catalyst systems comprising the catalyst compounds described here and at least one activator.

This invention relates to a method to polymerize olefins comprising contacting a catalyst system comprising catalyst compound described herein with an activator and one or more monomers.

This invention further relates to polymer compositions produced by the methods described herein.

### DETAILED DESCRIPTION

### Definitions

For the purposes of this invention and the claims thereto, the new numbering scheme for the Periodic Table Groups is used as described in Chemical and Engineering News, v. 63(5), pg. 27 (1985). Therefore, a “group 4 metal” is an element from group 4 of the Periodic Table, e.g. Hf, Ti, or Zr.

“Catalyst productivity” is a measure of the mass of polymer produced using a known quantity of polymerization catalyst. Typically, “catalyst productivity” is expressed in units of (g of polymer)/(g of catalyst) or (g of polymer)/(mmols of catalyst) or the like. If units are not specified then the “catalyst productivity” is in units of (g of polymer)/(g of catalyst). For calculating catalyst productivity only the weight of the transition metal component of the catalyst is used (i.e. the activator and/or co-catalyst is omitted).

“Conversion” is the amount of monomer that is converted to polymer product, and is reported as mol % and is calculated based on the polymer yield and the amount of monomer fed into the reactor.

“Catalyst activity” is a measure of how active the catalyst is and is reported as the grams of product polymer (P) produced per millimole of catalyst (cat) used per hour (gP·mmolcat⁻¹·h⁻¹). For calculating catalyst activity, also referred to as catalyst productivity, only the weight of the transition metal component of the catalyst is used.

The term “heteroatom” means any element except carbon and hydrogen. The term “group 13 to 17 heteroatom” refers to any non-carbon group 13, 14, 15, 16, or 17 element. A group 13 to 17 heteroatom may include B, Si, Ge, Sn, N, P, As, O, S, Se, Te, F, Cl, Br, and I. The terms “heteroatom” and “group 13 to 17 heteroatom” may include the aforementioned elements with hydrogens attached, such as BH, BH₂, SiH₂, OH, NH, NH₂, etc. The term “substituted heteroatom” describes a heteroatom that has one or more of these hydrogen atoms replaced by a hydrocarbyl or substituted hydrocarbyl group(s). The term “monovalent heteroatom” refers to a heteroatom, which may (or may not) have hydrogens attached, that forms a single covalent bond, such as, but not limited to, —F, —Cl, —Br, —I, —OH, —SH, —NH₂, —PH₂, —SiH₃, —GeH₃, —BH₂. The term “monovalent substituted heteroatom” refers to a substituted heteroatom group that can form a single covalent bond via the heteroatom. The term “monovalent substituted group 13 to 16 heteroatom” refers to partially substituted non-carbon group 13, 14, 15 and 16 heteroatom group that can form a single covalent bond via the heteroatom, such as, but not limited to, —O(R*), —OS(O)₂(R*), —OS(O)₂CF₃, —S(R*), —N(R*)₂, —NH(R*), —P(R*)₂, —PH(R*), —Si(R*)₃, —SiH(R*)₂, —SiH₂(R*), —Ge(R*)3, —B(R*)₂, —BH(R*) wherein R* is hydrocarbyl or substituted hydrocarbyl, such as, but not limited to, arylalkyl, alkylaryl, alkenyl, alkynyl, cycloalkyl, and the like, and wherein two or more adjacent R* may join together to form a cyclic or polycyclic structure.

For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on.

An oligomer is a polymer having a low molecular weight, such as an Mn of 21,000 g/mol or less (preferably 10,000 g/mol or less), and/or a low number of mer units, such as 100 mer units or less (preferably 75 mer units or less).

The term “alpha-olefin” refers to an olefin having a terminal carbon-to-carbon double bond in the structure thereof ((R¹R²)—C═CH₂, where R¹ and R² can be independently hydrogen or any hydrocarbyl group; preferably R¹ is hydrogen and R² is an alkyl group). A “linear alpha-olefin” is an alpha-olefin defined in this paragraph wherein R¹ is hydrogen, and R² is hydrogen or a linear alkyl group.

For the purposes of this invention, ethylene shall be considered an α-olefin.

As used herein, and unless otherwise specified, the term “Cₙ” means hydrocarbon(s) having n carbon atom(s) per molecule, wherein n is a positive integer.

The term “hydrocarbon” means compounds consisting of hydrogen and carbon atoms only.

The terms “group,” “radical,” and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl naphthyl, and the like.

Unless otherwise indicated, (e.g., the definition of “substituted hydrocarbyl”, “substituted aromatic,” etc.), the term “substituted” means that at least one hydrogen atom has been replaced with at least one non-hydrogen group, such as a hydrocarbyl group, a heteroatom (such as a monovalent heteroatom), or a substituted heteroatom (such as a monovalent substituted heteroatom group), such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or substituted heteroatom group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring, optionally the heteroatom or substituted heteroatom group are monovalent.

The term “substituted aromatic” means an aromatic group having 1 or more hydrogen groups replaced by a hydrocarbyl, substituted hydrocarbyl, a heteroatom (such as a monovalent heteroatom), or a substituted heteroatom group (such as a monovalent substituted heteroatom group).

The term “substituted phenyl” means a phenyl group having 1 or more hydrogen groups replaced by a hydrocarbyl, substituted hydrocarbyl, a heteroatom (such as a monovalent heteroatom), or a substituted heteroatom group (such as a monovalent substituted heteroatom group).

The term “substituted benzyl” means a benzyl group having 1 or more hydrogen groups replaced by a hydrocarbyl, substituted hydrocarbyl, a heteroatom (such as a monovalent heteroatom), or a substituted heteroatom group (such as a monovalent substituted heteroatom group), preferably a substituted benzyl” group is represented by the formula:

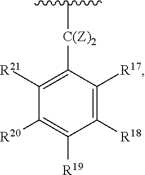

where each of R¹⁷, R¹⁸, R¹⁹, R²⁰, R²¹ and Z is independently selected from hydrogen, C₁-C₄₀ hydrocarbyl or C₁-C₄₀ substituted hydrocarbyl, a heteroatom or a heteroatom-containing group (provided that at least one of R¹⁷, R¹⁸, R¹⁹, R²⁰, R²¹ and Z is not H), or two or more of R¹⁷, R¹⁸, R¹⁹, R²⁰, R²¹ and Z are joined together to form a C₄-C₆₂ cyclic or polycyclic ring structure, or a combination thereof.

A “halocarbyl” is a halogen substituted hydrocarbyl group.

The terms “alkoxy” or “alkoxide” and aryloxy or aryloxide mean an alkyl or aryl group bound to an oxygen atom, such as an alkyl ether or aryl ether group/radical connected to an oxygen atom and can include those where the alkyl group is a C₁ to C₁₀ hydrocarbyl. The alkyl group may be straight chain, branched, or cyclic. The alkyl group may be saturated or unsaturated. Examples of suitable alkoxy and aryloxy radicals can include methoxy, ethoxy, n-propoxy, iso-propoxy, n-butoxy, iso-butoxy, sec-butoxy, tert-butoxy, phenoxy, and the like.

The terms “alkyl radical,” and “alkyl” are used interchangeably throughout this disclosure. For purposes of this disclosure, “alkyl radical” is defined to be a saturated hydrocarbon radical that may be linear, branched, or cyclic. Examples of such radicals can include C₁-C₁₀₀ saturated hydrocarbon radicals (C₁-C₁₀₀ alkyls), such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a hydrocarbyl group, a heteroatom (such as a monovalent heteroatom), or a substituted heteroatom group (such as a monovalent substituted heteroatom group), such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

As used herein, and unless otherwise specified, the term “aromatic” refers to unsaturated cyclic hydrocarbons having a delocalized conjugated π system. Typical aromatics comprise 5 to 20 carbon atoms (aromatic C₅-C₂₀ hydrocarbon), particularly from 5 to 12 carbon atoms (aromatic C₅-C₁₂ hydrocarbon), and particularly from 5 to 10 carbon atoms (aromatic C₅-C₁₂ hydrocarbon). Exemplary aromatics include, but are not limited to benzene, toluene, xylenes, mesitylene, ethylbenzenes, cumene, naphthalene, methylnaphthalene, dimethylnaphthalenes, ethylnaphthalenes, acenaphthalene, anthracene, phenanthrene, tetraphene, naphthacene, benzanthracenes, fluoranthrene, pyrene, chrysene, triphenylene, and the like, and combinations thereof. As used herein, the term “aromatic” also refers to pseudoaromatic heterocycles which are heterocyclic substituents that have similar properties and structures (nearly planar) to aromatic heterocyclic groups, but are not by definition aromatic.

The term “aryl” or “aryl group” means an aromatic ring (typically made of 6 carbon atoms) such as phenyl, xylyl. Likewise, heteroaryl means an aryl group where a ring carbon atom (or two or three ring carbon atoms) has been replaced with a heteroatom, such as N, O, or S.

An “arylalkyl” group is a alkyl group substituted with an aryl group. An “alkylaryl” group is an aryl substituted with an alkyl group.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tertbutyl).

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol⁻¹).

The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, p-tBu is para-tertiary butyl, Hx is hexyl, Cy is cyclohexyl, Oct is octyl, Ph is phenyl, Bz and Bn are benzyl (i.e., CH₂Ph), MAO is methylalumoxane, dme is 1,2-dimethoxyethane, TMS is trimethylsilyl, TIBAL is triisobutylaluminum, TNOAL is tri(n-octyl)aluminum, THF (also referred to as thf) is tetrahydrofuran, tol is toluene, and RT is room temperature (and is 23° C. unless otherwise indicated).

A “catalyst system” is a combination of at least one catalyst compound, at least one activator, an optional co-activator, and an optional support material. When “catalyst system” is used to describe such a pair before activation, it means the unactivated catalyst complex (precatalyst) together with an activator and, optionally, a co-activator. When it is used to describe such a pair after activation, it means the activated complex and the activator or other charge-balancing moiety. The transition metal compound may be neutral as in a precatalyst, or a charged species with a counter ion as in an activated catalyst system. For the purposes of this invention and the claims thereto, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer.

In the description herein, the catalyst may be described as a catalyst, a catalyst precursor, a pre-catalyst compound, catalyst compound or a transition metal compound, and these terms are used interchangeably.

An “anionic ligand” is a negatively charged ligand which donates one or more pairs of electrons to a metal ion. A “neutral donor ligand” is a neutrally charged ligand which donates one or more pairs of electrons to a metal ion.

A “Lewis base” is a neutrally charged ligand which donates one or more pairs of electrons to a metal ion. Examples of Lewis bases include ethyl ether, trimethylamine, pyridine, tetrahydrofuran, dimethylsulfide, and triphenylphosphine. The term “heterocyclic Lewis base” refers to Lewis bases that are also heterocycles. Examples of heterocyclic Lewis bases include pyridine, imidazole, thiazole, 1,3-azaphosphole, and furan.

The term “ring atom” means an atom that is part of a cyclic ring structure. By this definition, a benzyl group has six ring atoms and tetrahydrofuran has 5 ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

The term “continuous” means a system that operates without interruption or cessation. For example a continuous process to produce a polymer would be one where the reactants are continually introduced into one or more reactors and polymer product is continually withdrawn.

### DESCRIPTION

This invention relates to transition metal complexes of a multi-dentate ligand that features a neutral heterocyclic Lewis base and a second Lewis base, where the multi-dentate ligand coordinates to the metal center to form at least one 8-membered chelate ring.

This invention relates to a catalyst compound, and catalyst systems comprising activator and a compound, represented by the formula:

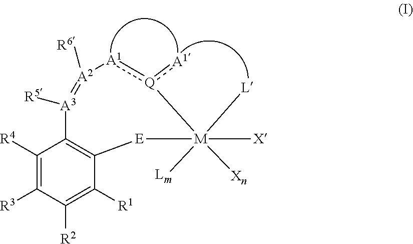

wherein:
M is a group 3, 4, 5, or 6 transition metal or Lanthanide;
E is O, S, or NR⁹⁹, where R⁹⁹ is hydrogen, C₁-C₄₀ hydrocarbyl, C₁-C₄₀ substituted hydrocarbyl, monovalent heteroatom, or a monovalent substituted heteroatom group;
Q is group 14, 15, or 16 atom that forms a bond to metal M;
A¹ and A^{1′} are independently C, N, or C(R³²), where R³² is selected from hydrogen, C₁-C₂₀ hydrocarbyl, C₁-C₂₀ substituted hydrocarbyl, monovalent heteroatom, or a monovalent substituted heteroatom group;
A¹QA^{1′} are part of a heterocyclic Lewis base containing 4 to 40 non-hydrogen atoms;
A² and A³ are independently a group 14 atom;
each R^{5′} and R^{6′} is independently hydrogen, C₁-C₄₀ hydrocarbyl, C₁-C₄₀ substituted hydrocarbyl, monovalent heteroatom, or a monovalent substituted heteroatom group;
R^{6′}-A²=A³-R^{5′} is a divalent group containing 2 to 40 non-hydrogen atoms, where R^{5′} and R^{6′} optionally join to form a hydrocarbyl ring, a substituted hydrocarbyl ring, a heterocyclic ring, or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
L′ is a neutral Lewis base joined to the heterocyclic Lewis base containing A¹QA^{1′};
X′ is an anionic ligand that is optionally joined to L′;
L is a neutral Lewis base;
X is an anionic ligand;
n is 1 or 2;
m is 0 or 1;
n+m is 0, 1 or 2;
each of R¹, R², R³, and R⁴ is independently hydrogen, C₁-C₄₀ hydrocarbyl, C₁-C₄₀ substituted hydrocarbyl, monovalent heteroatom, or a monovalent substituted heteroatom group, or optionally one or more of R¹ and R², R² and R³, R³ and R⁴, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms; and
an X group may be joined to an L group to form a monoanionic bidentate group, and any two X groups may be joined together to form a dianionic ligand group.

The catalyst systems described herein can be used to polymerize one or more olefins, such as C₂ to C₄₀ olefins, such as ethylene and/or propylene to produce polymers having excellent properties.

### Catalyst Compounds

This invention relates to transition metal complexes of a multi-dentate ligand that features a neutral heterocyclic Lewis base and a second Lewis base, where the multi-dentate ligand coordinates to the metal center to form at least one 8-membered chelate ring.

This invention relates to a catalyst compound represented by the Formula (I):

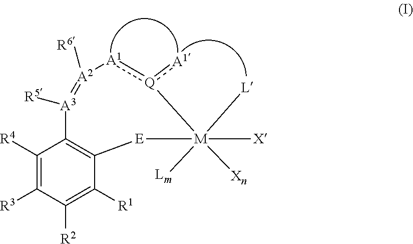

wherein:
M is a group 3, 4, 5, or 6 transition metal or Lanthanide, preferably a group;
E is O, S, or NR⁹⁹, where R⁹⁹ is hydrogen, C₁-C₄₀ hydrocarbyl, C₁-C₄₀ substituted hydrocarbyl, monovalent heteroatom, or a monovalent substituted heteroatom group;
Q is group 14, 15, or 16 atom that forms a bond to metal M;
A¹ and A^{1′} are independently C, N, or C(R³²), where R³² is selected from hydrogen, C₁-C₂₀ hydrocarbyl, C₁-C₂₀ substituted hydrocarbyl, monovalent heteroatom, or a monovalent substituted heteroatom group;
A¹QA^{1′} are part of a heterocyclic Lewis base containing 4 to 40 non-hydrogen atoms;
A² and A³ are independently a group 14 atom, such as C, Ge or Si;
each R^{5′} and R^{6′} is independently hydrogen, C₁-C₄₀ hydrocarbyl, C₁-C₄₀ substituted hydrocarbyl, monovalent heteroatom, or a monovalent substituted heteroatom group;
R^{6′}-A²=A³-R^{5′} is a divalent group containing 2 to 40 non-hydrogen atoms, where R^{5′} and R^{6′} optionally join to form a hydrocarbyl ring, a substituted hydrocarbyl ring, a heterocyclic ring, or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
L′ is a neutral Lewis base joined to the heterocyclic Lewis base containing A¹QA^{1′};
X′ is an anionic ligand that is optionally joined to L′;
L is a neutral Lewis base;
X is an anionic ligand;
n is 1 or 2;
m is 0 or 1;
n+m is 0, 1 or 2;
each of R¹, R², R³, and R⁴ is independently hydrogen, C₁-C₄₀ hydrocarbyl, C₁-C₄₀ substituted hydrocarbyl, monovalent heteroatom, or a monovalent substituted heteroatom group, or optionally one or more of R¹ and R², R² and R³, R³ and R⁴, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms; and
an X group may be joined to an L group to form a monoanionic bidentate group, or any two X groups may be joined together to form a dianionic ligand group.

Alternately, M is Sc, Y, Ti, Z, Hf, V, Nb, Ta, Cr, Mo, W or La, alternately Ti, Zr Hf, preferably M is Ti, Hf or Zr.

Alternately, E is NR⁹⁹, where R⁹⁹ is hydrogen or a C₁-C₂₀ (such as C₁ to C₁₂) hydrocarbyl, C₁-C₂₀ (such as C₁ to C₁₂) substituted hydrocarbyl, or a heteroatom-containing group, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, carbazolyl, trimethylsilyl, and isomers thereof, preferably R⁹⁹ is phenyl, tolyl, xylyl, mesityl, tert-butyl, admantanyl, butyl, hexyl, ethyl, or isopropyl.

Alternately, Q is C, N, O, Si, P, S, Ge, Sn, Sb, Te Se, preferably Q is C, N, O, or S.

Alternately, A¹ and A^{1′} are independently C, N, or C(R³²), where R³² is selected from C₁-C₂₀ hydrocarbyl and C₁-C₂₀ substituted hydrocarbyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

Alternately, A¹ and A^{1′} are each independently a C(R³²) group where the R³² groups join to form a heterocyclic ring or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms, such as furanyl, imidazolyl, pyrazolyl, triazolyl, pyridyl, pyrimidinyl, pyrazinyl, thiophenyl, oxazolyl, or thiazolyl, or isomers thereof, which may be substituted or unsubstituted.

Alternately, the heterocyclic Lewis base (of Formula I) represented by A¹QA^{1′} combined with the curved line joining A¹ and A^{1′} is preferably selected from the following, with each R²⁴ group selected from hydrogen, heteroatoms, C₁-C₂₀ alkyls, C₁-C₂₀ alkoxides, C₁-C₂₀ amides, and C₁-C₂₀ substituted alkyls.

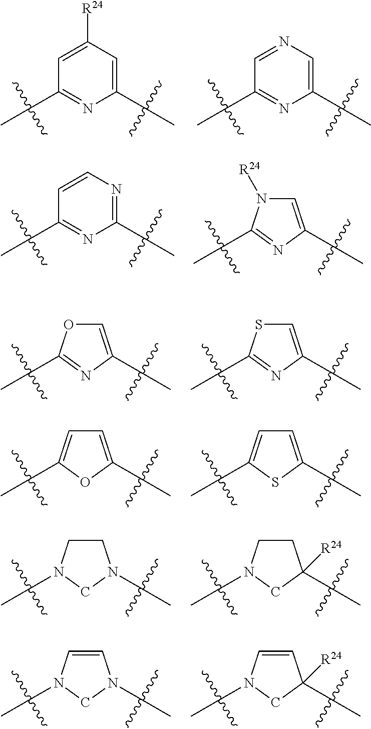

In some embodiments, the heterocyclic Lewis base (of Formula (I or Formula 1a (further below) or Formula 1b (further below))) represented by A¹QA^{1′} combined with the curved line joining A¹ and A^{1′} is a six membered ring containing one ring heteroatom with Q being the ring heteroatom, or a five membered ring containing one or two ring heteroatoms but with Q being a ring carbon or a ring heteroatom. Alternatively, the heterocyclic Lewis base represented by A¹QA^{1′} combined with the curved line joining A¹ and A^{1′} is a five membered ring containing one or two ring heteroatoms with Q being nitrogen.

Alternately, A² and A³ are each independently C, Si, Ge, Sn, preferably Q is C.

Alternately, each R^{5′}, R^{6′} is independently hydrogen, C₁-C₄₀ (such as C₁ to C₂₀, such as C₁ to C₁₂) hydrocarbyl, C₁-C₄₀ (such as C₁ to C₂₀, such as C₁ to C₁₂) substituted hydrocarbyl, monovalent heteroatom, or a monovalent substituted heteroatom group, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof, preferably R^{5′} and R^{6′} each independently is methyl, ethyl, or propyl.

Alternately, R^{6′}-A²=A³-R^{5′} is a divalent group containing 2 to 40 (such as 4 to 20) non-hydrogen atoms (such as C, N, O, S), where R^{5′} and R^{6′} optionally join to form a hydrocarbyl ring, a substituted hydrocarbyl ring, a heterocyclic ring, or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms, such as phenyl.

Alternately, L′ is a neutral Lewis base coordinated to the metal center M (as a neutral 2-electron donor), such as pyridine, 1-methyl-1H-imidizole, trimethylamine, or ether, joined to the heterocyclic Lewis base containing A¹QA^{1′}.

Alternately, X′ is selected from the group consisting of hydrocarbyl radicals having from 1 to 20 carbon atoms, aryls, hydrides, amides, alkoxides, sulfides, phosphides, halides, dienes, amines, phosphines, ethers, and a combination thereof, preferably X′ is selected from halides, C₁ to C₅ alkyl groups, and phenoxides, preferably X′ is a phenoxy, benzyl, phenyl, methyl, ethyl, propyl, butyl, pentyl, or chloro group. Alternately, X′ may be, independently, a halide, a hydride, an alkyl group, an alkenyl group or an arylalkyl group.

Alternately, L can be independently selected from ethers, amines, phosphines, thioethers, esters, Et₂O, MeOtBu, Et₃N, PhNMe₂, MePh₂N, tetrahydrofuran, and dimethylsulfide.

Alternately, X is, independently, selected from the group consisting of hydrocarbyl radicals having from 1 to 20 carbon atoms, aryls, hydrides, amides, alkoxides, sulfides, phosphides, halides, dienes, amines, phosphines, ethers, and a combination thereof, (two X's may form a part of a fused ring or a ring system), preferably each X is independently selected from halides and C₁ to C₅ alkyl groups, preferably each X is a phenyl, benzyl, methyl, ethyl, propyl, butyl, pentyl, or chloro group. Alternately, each X may be, independently, a halide, a hydride, an alkyl group, an alkenyl group or an arylalkyl group.

Alternately, n is 1 or 2, typically n is 2, and m is 0 or 1, typically m is 0, where n+m is 1 or 2.

Alternately, each of R¹, R², R³, and R⁴ is independently hydrogen, C₁-C₄₀ (such as C₁ to C₂₀, such as C₁ to C₁₂) hydrocarbyl, C₁-C₄₀ (such as C₁ to C₂₀, such as C₁ to C₁₂) substituted hydrocarbyl, a heteroatom or a heteroatom-containing group, or optionally one or more of R¹ and R², R² and R³, R³ and R⁴, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms. Alternately, each of R¹, R², R³, and R⁴ is independently hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof, preferably each of R¹, R², R³, and R⁴ is independently hydrogen, methyl, propyl, butyl, adamantanyl, or phenyl.

Alternately, an X group is joined to an L group to form a monoanionic bidentate group, such as methoxyphenyl.

Alternately, two X groups may be joined together to form a dianionic ligand group, such as oxalate.

Alternately, the fragment R^{6′}-A²=A³-R^{5′} forms an aromatic ring, such as a 5 or 6 membered aromatic ring.

Alternately, E is oxygen and the fragment R^{6′}-A²=A³-R^{5′} forms an aromatic ring, such as a 5 or 6 membered aromatic ring.

Alternately, A¹QA^{1′} form a pyridyl ring, which may be substituted or unsubstituted.

Alternately, X′ is an anionic ligand that may be joined to L′, such as represented by Formula (II), where L′ is a heterocyclic Lewis base containing R²², R²¹, R²⁰ (defined below) and X is connected to the heterocycle at the R²³ position.

Another exemplary embodiment relates to a catalyst compound represented by the Formula (Ia):

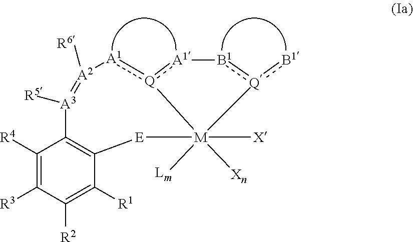

wherein, M, m, n, L, X, X′, E, R¹, R², R³, R⁴, R³², R⁹⁹, A¹, Q, A^{1′}, A², A³, R^{5′}, and R^{6′}, are as described above;
Q′ is group 14, 15, or 16 atom that forms a bond to metal M;
B¹ and B^{1′} are independently C, N, or C(R³²), where R³² is selected from hydrogen, C₁-C₂₀ hydrocarbyl, C₁-C₂₀ substituted hydrocarbyl, monovalent heteroatom, or a monovalent substituted heteroatom group;
B¹QB^{1′} are part of a heterocyclic Lewis base containing 4 to 40 non-hydrogen atoms joined to the heterocyclic Lewis base containing A¹QA^{1′};
X′ is an anionic ligand that is optionally joined to the heterocyclic Lewis base containing B¹Q′B^{1′}.

Alternately, Q′ is C, N, O, Si, P, S, Ge, Sn, Sb, Te Se, preferably Q′ is C, N, O, or S.

Alternately, B¹ and B^{1′} are independently C, N, or C(R³²), where R³² is selected from C₁-C₂₀ hydrocarbyl and C₁-C₂₀ substituted hydrocarbyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

Alternately, B¹ and B^{1′} are each independently a C(R³²) group where the R³² groups join to form a heterocyclic ring or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms, such as furanyl, imidazolyl, pyrazolyl, triazolyl, pyridyl, pyrimidinyl, pyrazinyl, thiophenyl, oxazolyl, or thiazolyl, or isomers thereof, which may be substituted or unsubstituted.

Alternately, the heterocyclic Lewis base (of Formula I, Formula 1a, or Formula 1b (below)) represented by B¹Q′B^{1′} combined with the curved line joining B¹ and B^{1′} is preferably selected from the following, with each R²⁴ group selected from hydrogen, heteroatoms, C₁-C₂₀ alkyls, C₁-C₂₀ alkoxides, C₁-C₂₀ amides, and C₁-C₂₀ substituted alkyls.

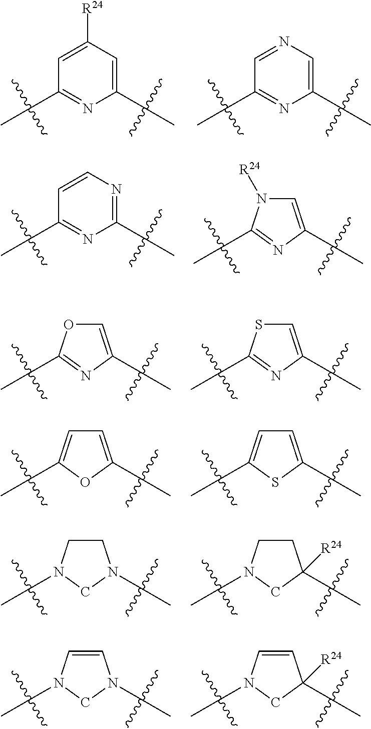

In some embodiments, the heterocyclic Lewis base (of Formula (I)) represented by B¹Q′B^{1′} combined with the curved line joining B¹ and B^{1′} is a six membered ring containing one ring heteroatom with Q′ being the ring heteroatom, or a five membered ring containing one or two ring heteroatoms with Q′ being a ring carbon, or a ring heteroatom. Alternatively, the heterocyclic Lewis base represented by B¹Q′B^{1′} combined with the curved line joining B¹ and B^{1′} is a five membered ring containing one or two ring heteroatoms with Q′ being nitrogen.

Another exemplary embodiment relates to a catalyst compound represented by the Formula (Ib):

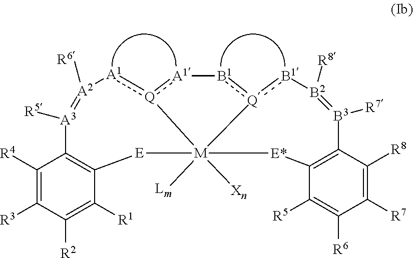

wherein, M, m, n, L, X, X′, E, R¹, R², R³, R⁴, R³², R⁹⁹, A¹, Q, A^{1′}, A², A³, R^{5′}, R^{6′}, B¹, Q′, and B^{1′}, are as described above;
B² and B³ are independently a group 14 atom, such as C, Ge or Si;
each R^{7′} and R^{8′} is independently hydrogen, C₁-C₄₀ hydrocarbyl, C₁-C₄₀ substituted hydrocarbyl, monovalent heteroatom, or a monovalent substituted heteroatom group;
R^{7′}—B³═B²—R^{8′} is a divalent group containing 2 to 40 non-hydrogen atoms, where R^{5′} and R^{6′} optionally join to form a hydrocarbyl ring, a substituted hydrocarbyl ring, a heterocyclic ring, or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
each R⁵, R⁶, R⁷, and R⁸, is independently a hydrogen, a C₁-C₄₀ hydrocarbyl, a C₁-C₄₀ substituted hydrocarbyl, a heteroatom (such as a monovalent heteroatom), or substituted heteroatom (such as a monovalent substituted heteroatom group), or optionally one or more adjacent R groups, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
E* is O, S, or NR⁹⁹, where R⁹⁹ is hydrogen, C₁-C₄₀ hydrocarbyl, C₁-C₄₀ substituted hydrocarbyl, or a heteroatom-containing group.

Alternately, B² and B³ are each independently C, Si, Ge, Sn, preferably Q is C.

Alternately, each R^{7′}, R^{8′} is independently hydrogen, C₁-C₄₀ (such as C₁ to C₂₀, such as C₁ to C₁₂) hydrocarbyl, C₁-C₄₀ (such as C₁ to C₂₀, such as C₁ to C₁₂) substituted hydrocarbyl, monovalent heteroatom, or a monovalent substituted heteroatom group, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof, preferably R^{7′} and R^{8′} each independently is methyl, ethyl, or propyl.

Alternately, R^{8′}—B²═B³—R^{7′} is a divalent group containing 2 to 40 (such as 4 to 20) non-hydrogen atoms (such as C, N, O, S), where R^{5′} and R^{6′} optionally join to form a hydrocarbyl ring, a substituted hydrocarbyl ring, a heterocyclic ring, or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms, such as phenyl.

Alternately, each R⁵, R⁶, R⁷, and R⁸ is independently hydrogen, C₁-C₄₀ (such as C₁ to C₂₀, such as C₁ to C₁₂) hydrocarbyl, C₁-C₄₀ (such as C₁ to C₂₀, such as C₁ to C₁₂) substituted hydrocarbyl, a heteroatom (such as a monovalent heteroatom), or substituted heteroatom (such as a monovalent substituted heteroatom group), or optionally one or more adjacent R groups, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms. Alternately, each of R⁵, R⁶, R⁷, and R⁸ is independently hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof, preferably each of R⁵, R⁶, R⁷, and R⁸ are independently methyl, ethyl, propyl, butyl, pentyl, hexyl, heptyl, octyl, nonyl, or decyl.

Alternately, E* is NR⁹⁹, where R⁹⁹ is hydrogen or a C₁-C₂₀ (such as C₁ to C₁₂) hydrocarbyl, C₁-C₂₀ (such as C₁ to C₁₂) substituted hydrocarbyl, or a heteroatom (such as a monovalent heteroatom), or substituted heteroatom (such as a monovalent substituted heteroatom group), such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, trimethylsilyl, triethylsilyl, trimethylgermyl, triphenylsilyl, triisopropylsilyl, and isomers thereof, preferably R⁹⁹ is methyl, phenyl, xylyl, mesityl, butyl, propyl, or adamantanyl.

Alternately, the Lewis bases (of Formulas (I), (Ia) and (Ib)), represented by A¹QA^{1′} combined with the curved line joining A¹ and A^{1′} and by L′ or B¹QB^{1′} combined with the curved line joining B¹ and B^{1′}, form a bipyridyl or substituted bipyridiyl. Alternately, the Lewis bases (of Formulas (I), (Ia) and (Ib)), represented by A¹QA^{1′} combined with the curved line joining A¹ and A^{1′} and by L′ or B¹QB^{1′} combined with the curved line joining B¹ and B^{1′}, do not form a bipyridyl or substituted bipyridiyl. This invention relates to a catalyst compound represented by the Formula (II):

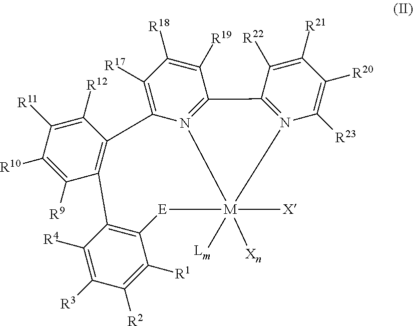

wherein, M, m, n, L, X, X′, E, R¹, R², R³, R⁴, R³², and R⁹⁹, are as describe above and each R⁹, R¹⁰, R¹¹, R¹², R¹⁷, R¹⁸, R¹⁹, R²⁰ R²¹, R²², and R²³, is independently a hydrogen, a C₁-C₄₀ hydrocarbyl, a C₁-C₄₀ substituted hydrocarbyl, a heteroatom (such as a monovalent heteroatom), or substituted heteroatom (such as a monovalent substituted heteroatom group), or optionally one or more adjacent R groups, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms.

Alternately, each R⁹, R¹⁰, R¹¹, R¹², R¹⁷, R¹⁸, R¹⁹, R²⁰ R²¹, R²², and R²³ is independently hydrogen, C₁-C₄₀ (such as C₁ to C₂₀, such as C₁ to C₁₂) hydrocarbyl, C₁-C₄₀ (such as C₁ to C₂₀, such as C₁ to C₁₂) substituted hydrocarbyl, a heteroatom (such as a monovalent heteroatom), or substituted heteroatom (such as a monovalent substituted heteroatom group), or optionally one or more adjacent R groups, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms. Alternately, each of R⁹, R¹⁰, R¹¹, R¹², R¹⁷, R¹⁸, R¹⁹, R²⁰ R²¹, R²², and R²³ is independently hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof, preferably each of R⁹, R¹⁰, R¹¹, R¹², R¹⁷, R¹⁸, R¹⁹, R²⁰ R²¹, R²², and R²³ are is independently hydrogen, methyl, ethyl, propyl, butyl, pentyl, hexyl, heptyl, octyl, nonyl, or decyl.

This invention relates to a catalyst compound represented by the Formula (III):

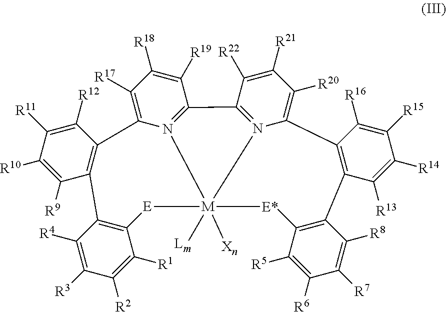

wherein, M, m, n, L, X, E, E*, R¹, R², R³, R⁴, R⁵, R⁶, R⁷, R⁸, R⁹, R¹⁰, R¹¹, R¹², R¹⁷, R¹⁸, R¹⁹, R²⁰ R²¹, R²², R²³, R³², and R⁹⁹ are as described above;
each R¹³, R¹⁴, R¹⁵, and R¹⁶, is independently a hydrogen, a C₁-C₄₀ hydrocarbyl, a C₁-C₄₀ substituted hydrocarbyl, a heteroatom (such as a monovalent heteroatom), or substituted heteroatom (such as a monovalent substituted heteroatom group), or optionally one or more adjacent R groups, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms.

Alternately, each R¹³, R¹⁴, R¹⁵, and R¹⁶ is independently hydrogen, C₁-C₄₀ (such as C₁ to C₂₀, such as C₁ to C₁₂) hydrocarbyl, C₁-C₄₀ (such as C₁ to C₂₀, such as C₁ to C₁₂) substituted hydrocarbyl, a heteroatom (such as a monovalent heteroatom), or substituted heteroatom (such as a monovalent substituted heteroatom group), or optionally one or more adjacent R groups, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms. Alternately, each of R¹³, R¹⁴, R¹⁵, and R¹⁶ is independently hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof, preferably each of R¹³, R¹⁴, and R¹⁵, R¹⁶ are is independently methyl, ethyl, propyl, butyl, pentyl, hexyl, heptyl, octyl, nonyl, or decyl.

In some embodiments, of Formula (Ib), the heterocyclic Lewis base represented by A¹QA^{1′} combined with the curved line joining A¹ and A^{1′} which is bonded to the a second heterocyclic Lewis base represented by B¹Q′B^{1′} combined with the curved line joining B¹ and B^{1′} is preferably selected from the following, wherein each G is selected from S, O, and NR²⁴, each G′ is selected from O and S, and each R²⁴ group and each R⁴⁴ group is independently selected from hydrogen, heteroatoms, C₁-C₂₀ alkyls, C₁-C₂₀ alkoxides, C₁-C₂₀ amides, and C₁-C₂₀ substituted alkyls, and wherein two adjacent R²⁴ and or R⁴⁴ groups on the same ring can be joined to form one or more hydrocarbyl rings, substituted hydrocarbyl rings, heterocyclic rings or a substituted heterocyclic rings, where each ring has 5, 6, 7, or 8 ring atoms, and where substituents on the ring can join to form one or more additional hydrocarbyl rings, substituted hydrocarbyl rings, heterocyclic rings, or substituted heterocyclic rings:

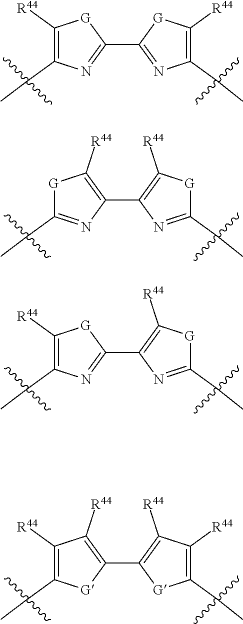

More preferably the heterocyclic Lewis base represented by A¹QA^{1′} combined with the curved line joining A¹ and A^{1′} which is bonded to the a second heterocyclic Lewis base represented by B¹Q′B^{1′} combined with the curved line joining B¹ and B^{1′} is selected from

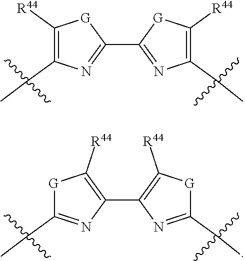

In some embodiments of Formula (Ib), the heterocyclic Lewis base represented by A¹QA^{1′} combined with the curved line joining A¹ and A^{1′} which is bonded to the a second heterocyclic Lewis base represented by B¹Q′B^{1′} combined with the curved line joining B¹ and B^{1′} is preferably selected from the following, with each R²⁴ group and each R⁴⁴ group independently selected from hydrogen, heteroatoms, C₁-C₂₀ alkyls, C₁-C₂₀ alkoxides, C₁-C₂₀ amides, and C₁-C₂₀ substituted alkyls, and wherein two adjacent R²⁴ and or R⁴⁴ groups on the same ring can be joined to form one or more hydrocarbyl rings, substituted hydrocarbyl rings, heterocyclic rings or a substituted heterocyclic rings, where each ring has 5, 6, 7, or 8 ring atoms, and where substituents on the ring can join to form one or more additional hydrocarbyl rings, substituted hydrocarbyl rings, heterocyclic rings, or substituted heterocyclic rings:

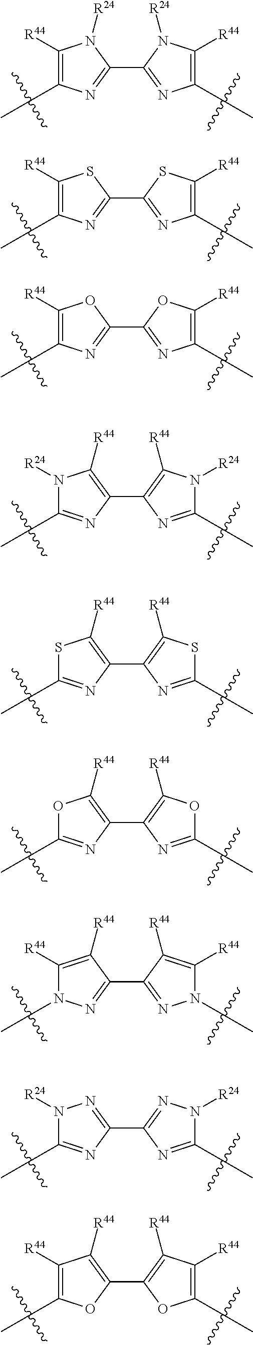

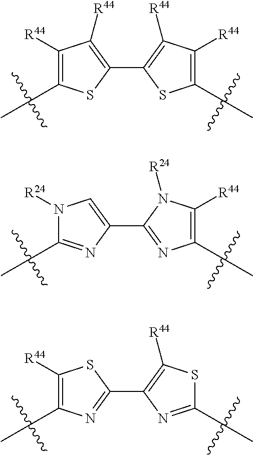

More preferably the heterocyclic Lewis base represented by A¹QA^{1′} combined with the curved line joining A¹ and A^{1′} which is bonded to the a second heterocyclic Lewis base represented by B¹Q′B^{1′} combined with the curved line joining B¹ and B is selected from:

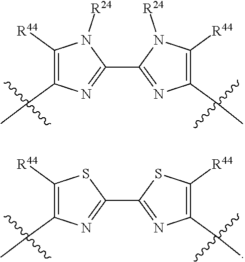

Other exemplary embodiments relate to a catalyst compound represented by the Formula (IV):

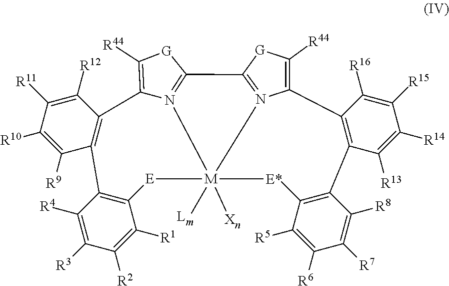

wherein, M, m, n, L, X, E, E*, R¹, R², R³, R⁴, R⁵, R⁶, R⁷, R⁸, R⁹, R¹⁰, R¹¹, R¹², R¹³, R¹⁴, R¹⁵, R¹⁶, R²⁴ R⁴⁴, and R⁹⁹ are as described above, and each G is independently S, O, or NR²⁴.

In some embodiments of Formula (IV), E and E* are preferably O, G is preferably S or NR²⁴, R²⁴ is preferably C₁-C₂₀ alkyl, more preferably C₁-C₁₀ alkyl (such as methyl, ethyl, propyl and the like), and R⁴⁴ is preferably hydrogen, C₁-C₂₀ alkyl, more preferably hydrogen.

In some embodiments of Formulas (II), (III), and (IV), when E and E* are oxygen it is advantageous that each phenolate group be substituted in the position that is next to the oxygen atom (i.e. R¹ and R⁵ in Formulas (II), (III), and (IV). Thus, when E and E* are oxygen it is preferred that each of R¹ and R⁵ is independently a C₁-C₄₀ hydrocarbyl, a C₁-C₄₀ substituted hydrocarbyl, a heteroatom or a heteroatom-containing group, alternatively, each of R¹ and R⁵ is independently an aromatic group or non-aromatic cyclic alkyl group with one or more five- or six-membered rings (such as phenyl, substituted phenyl, carbazolyl, substituted carbazolyl, indolyl, substituted indolyl, pyrrolyl, substituted pyrrolyl, naphthyl, substituted naphthyl, anthracenyl, substituted anthracenyl, fluorenyl, substituted fluorenyl including 9-methylfluorenyl, cyclohexyl, cyclooctyl, cyclododecyl, adamantanyl, or 1-methylcyclohexyl, or substituted adamantanyl). Additional examples of R¹ and R⁵ in Formulas (II), (III), or (IV) include methyl, ethyl, and all isomers of propyl, butyl, pentyl, hexyl, heptyl, octyl, nonyl, decyl, undecyl, docecyl, such as iso-propyl, tert-butyl, tert-pentyl, neopentyl, tert-octyl, and the like.

In some embodiments of Formulas (II), (III), and (IV), R¹ and R⁵ may additionally be selected from chloro, bromo, fluoro, a C₁-C₄₀ trialkylsilyl, a C₁-C₄₀ substituted trialkylsilyl, a C₁-C₄₀ triarylsilyl, a C₁-C₄₀ substituted triarylsilyl, a C₁-C₄₀ dialkylarylsilyl, a C₁-C₄₀ substituted dialkylarylsilyl, a C₁-C₄₀ alkyldiarylsilyl, and a C₁-C₄₀ substituted alkyldiarylsilyl, for example trimethylsilyl, triethylsilyl, tripropylsilyl, tributylsilyl, trihexylsilyl, trioctylsilyl, dimethyloctylsilyl and the like.

In some embodiments of Formulas (II), (III), and (IV), R², R³, R⁴, R⁶, R⁷, R⁸, R⁹, R¹⁰, R¹¹, R¹², R¹³, R¹⁴, R¹⁵, and R¹⁶ are independently hydrogen or a C₁-C₁₀ alkyl, such as R², R³, R⁴, R⁶, R⁷, R⁸, R⁹, R¹⁰, R¹¹, R¹², R¹³, R¹⁴, R¹⁵, and R¹⁶ can be independently hydrogen, methyl, ethyl, propyl, or isopropyl.

In some embodiments of Formulas (II), (III), and (IV), R³ and R⁷ are independently selected from a C₁-C₄₀ hydrocarbyl, a C₁-C₄₀ substituted hydrocarbyl, a C₁-C₄₀ trialkylsilyl, a C₁-C₄₀ substituted trialkylsilyl, a C₁-C₄₀ triarylsilyl, a C₁-C₄₀ substituted triarylsilyl, a C₁-C₄₀ dialkylarylsilyl, a C₁-C₄₀ substituted dialkylarylsilyl, C₁-C₄₀ alkyldiarylsilyl, and C₁-C₄₀ substituted alkyldiarylsilyl, such as for example, methyl, ethyl, and all isomers of propyl, butyl, pentyl, hexyl, heptyl, octyl, nonyl, decyl, undecyl, dodecyl and the like, for example methyl, ethyl, tert-butyl, cyclohexyl, tert-pentyl, tert-octyl, adamantyl and the like, with additional examples being trimethylsilyl, triethylsilyl, tripropylsilyl, tributylsilyl, trihexylsilyl, trioctylsilyl, dimethyloctylsilyl and the like.

Alternately, select R groups in Formulas (I), (Ia), (Ib), (II), (III), and (IV) may combine to form a fused ring or multicenter fused ring system where the rings may be aromatic, partially saturated or saturated. For example, one, two, three, four or more of R¹ and R², R² and R³, R³ and R⁴, R⁴ and R^{5′}, R^{5′} and R^{6′}, R⁴ and R⁹, R⁹ and R¹⁰, R¹⁰ and R¹¹, R¹¹ and R¹², R¹² and R¹⁷, R¹⁷ and R¹⁸, R¹⁸ and R¹⁹, R²² and R²¹, R²¹ and R²⁰, R²⁰ and R²³, R²⁰ and R¹⁶, R¹⁶ and R¹⁵, R¹⁵ and R¹⁴, R¹⁴ and R¹³, R¹³ and R⁸, R⁸ and R⁷, R⁷ and R⁶, and R⁶ and R⁵, adjacent R²⁴ and R⁴⁴, adjacent R¹² and R⁴⁴, and adjacent R¹⁶ and R⁴⁴ may combine to form a fused ring or multicenter fused ring system where the rings may be aromatic, partially saturated or saturated.

Catalyst compounds that are particularly useful in this invention include one or more of.

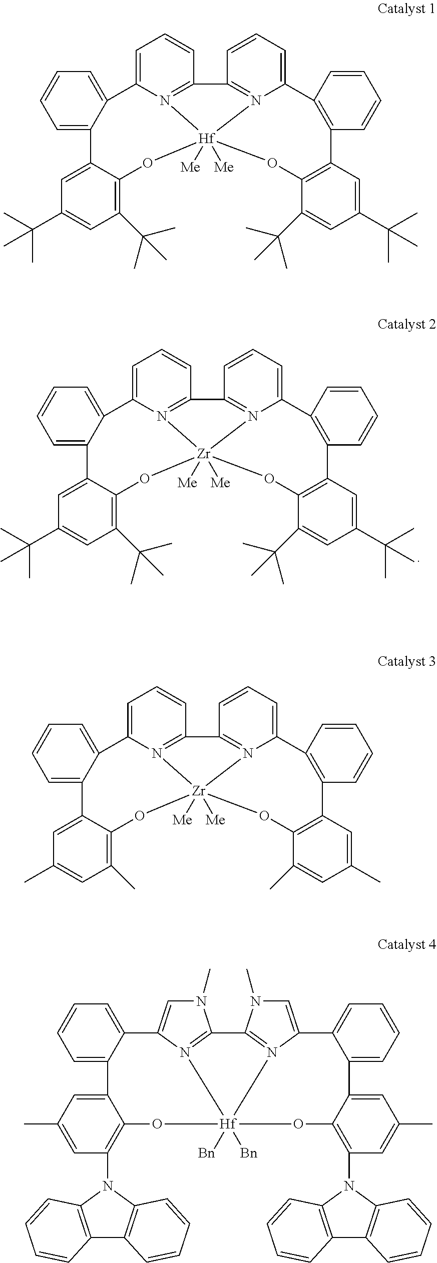

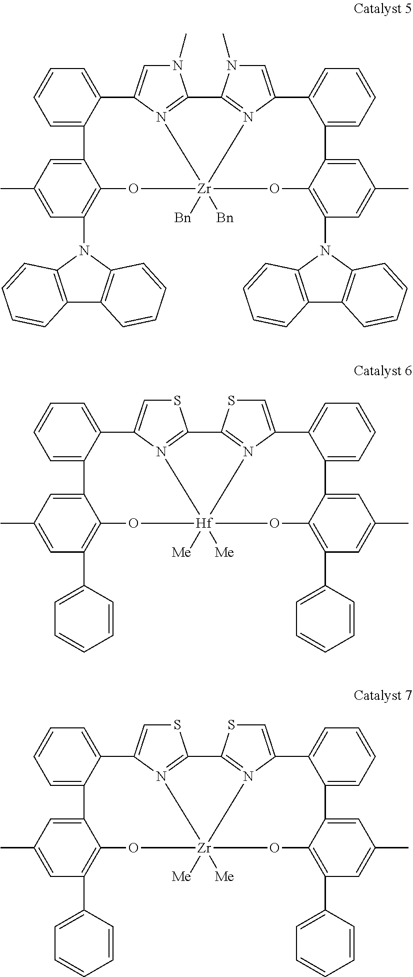

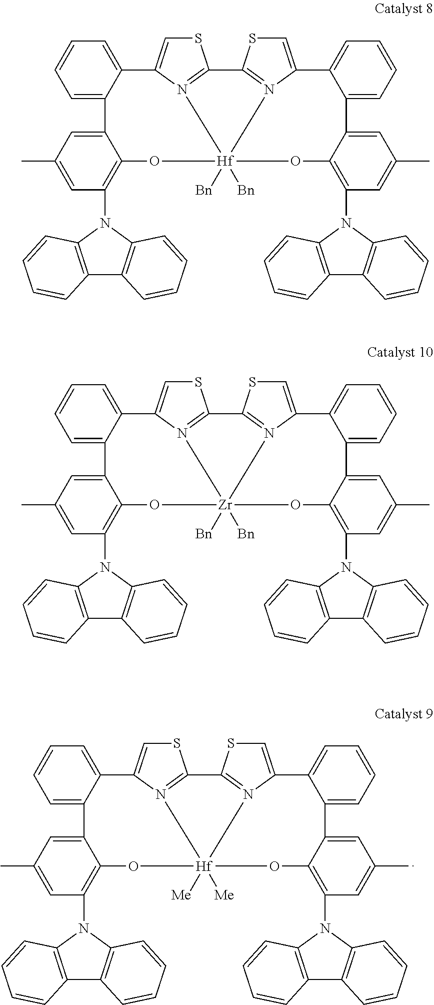

In a preferred embodiment in any of the processes described herein one catalyst compound is used, e.g. the catalyst compounds are not different. For purposes of this invention one catalyst compound is considered different from another if they differ by at least one atom.

In some embodiments, two or more different catalyst compounds are present in the catalyst system used herein. In some embodiments, two or more different catalyst compounds are present in the reaction zone where the process(es) described herein occur. When two transition metal compound based catalysts are used in one reactor as a mixed catalyst system, the two transition metal compounds are preferably chosen such that the two are compatible. A simple screening method such as by ¹H or ¹³C NMR, known to those of ordinary skill in the art, can be used to determine which transition metal compounds are compatible. It is preferable to use the same activator for the transition metal compounds, however, two different activators, such as a non-coordinating anion activator and an alumoxane, can be used in combination. If one or more transition metal compounds contain an X or X′ ligand which is not a hydride, hydrocarbyl, or substituted hydrocarbyl, then an alumoxane or aluminum alkyl is typically contacted with the transition metal compounds prior to addition of a non-coordinating anion activator.

The two different transition metal compounds (pre-catalysts) may be used in any ratio. Preferred molar ratios of (A) transition metal compound to (B) transition metal compound fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10 to 99.9% A to 0.1 to 90% B, alternatively 25 to 99% A to 0.5 to 50% B, alternatively 50 to 99% A to 1 to 25% B, and alternatively 75 to 99% A to 1 to 10% B.

### Methods to Prepare the Catalyst Compounds.

The following describes methods to prepare catalysts described herein. Schemes 1 and 2 illustrate general synthesis routes to prepare the multidentate Lewis base ligands and multidentate Lewis base transition metal complexes. Catalyst compounds of this type will be synthesized as described below (including the Examples below), where free ligand can be obtained via a multiple reaction process in order to join together the three fragments (i.e., heterocyclic group, aryl linker group, and the phenol). Abbreviations used in Scheme 1 are as follows: P is a protecting group; examples of suitable protecting groups include, but are not limited to, methoxymethyl (MOM), ethoxymethyl, tetrahydropyranyl ether (THP), and benzyl. R is a hydrocarbyl or monovalent heteroatom or heteroatom-bound monovalent group; examples include phenyl, mesityl, cumyl, methyl, tert-butyl, isopropyl, cyclohexyl, adamantanyl, methylcyclohexyl, and carbazolyl. M′ is a group 1, 2, 11, 12, or 13 element or substituted element such as lithium, magnesium chloride, magnesium bromide, copper, zinc, copper chloride, zinc chloride, B(OH)₂, or B(pinacolate). The metal M, anionic ligand X, heterocyclic Lewis base containing Q, neutral Lewis base L′ and anionic ligand X′ are as described earlier.

The formation of the multidentate Lewis base ligand by the coupling of compound A (Scheme 1) or compound F (Scheme 2) with compound B may be accomplished by known Pd- and Ni-catalyzed couplings, such as Negishi, Suzuki, or Kumada couplings. Compound B may be prepared from compound E by reaction of compound E with either an organolithium reagent or magnesium metal, followed by optional reaction with a main-group metal halide (e.g. ZnCl₂) or boron-based reagent (e.g. B(OⁱPr)₃, ⁱPrOB(pin)). Compound E may be prepared in a non-catalyzed reaction from by the reaction of an aryllithium or aryl Grignard reagent (compound C) with a dihalogenated arene (compound D), such as 1-bromo-2-chlorobenzene, followed by deprotection. Compound E may also be prepared in a Pd- or Ni-catalyzed reaction by reaction of an arylzinc or aryl-boron reagent (compound C) with a dihalogenated arene (compound D), followed by deprotection.

Once the free ligand has been prepared, the free ligand can be converted to the corresponding transition metal complex by reaction with metal-containing reagents. Examples of suitable metal-containing reagents may include metal halides, metal amides, and organometallics. For example, metal-containing reagents may include ZrCl4, HfCl4, Zr(NMe2)2Cl2(1,2-dimethoxyethane), Hf(NMe2)2Cl2(1,2-dimethoxyethane), Zr(NMe2)4, Hf(NEt2)4, Zr(CH2Ph)4, Hf(CH2Ph)4, or TiCl4. The free ligand may be: i) reacted directly with the metal-containing reagents; or ii) deprotonated by reaction with a main-group metal reagent (e.g., BuLi, NaH, iPrMgBr, MeMgBr) prior to reaction with the transition metal reagent. Alternatively, the metal halide reagents may be reacted with an alkylating agent, such as an organomagnesium reagent, to form in situ a transition metal organometallic species that can be subsequently reacted with the free ligand to form the catalyst complex.

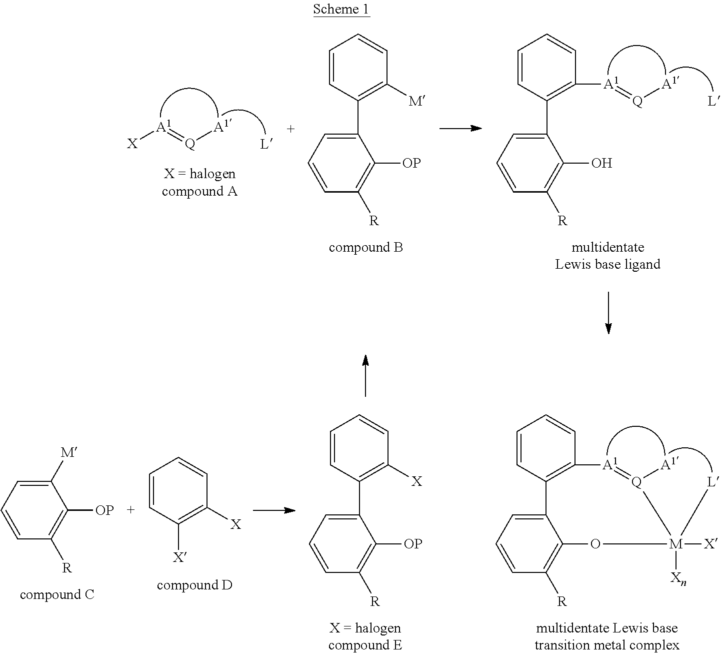

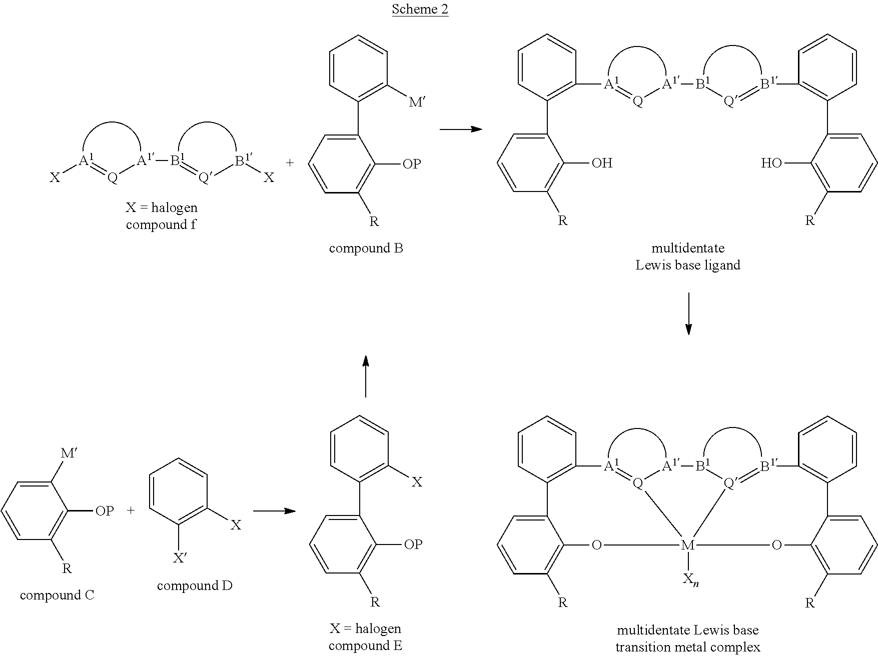

### Activators

The terms “cocatalyst” and “activator” are used herein interchangeably.

The catalyst systems described herein typically comprises a catalyst complex, such as the complexes described above, and an activator such as alumoxane or a non-coordinating anion containing activator. These catalyst systems may be formed by combining the catalyst components described herein with activators in any manner known from the literature. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, include alumoxanes, ionizing activators, which may be neutral or ionic, and conventional-type cocatalysts. Preferred activators typically include alumoxane compounds, modified alumoxane compounds, and ionizing anion precursor compounds that abstract a reactive metal ligand making the metal compound cationic and providing a charge-balancing non-coordinating or weakly coordinating anion, e.g. a non-coordinating anion.

### Alumoxane Activators

Alumoxane activators can be utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) suhc as those described in U.S. Pat. No. 5,041,584. Another useful alumoxane is solid polymethylaluminoxane as described in U.S. Pat. Nos. 9,340,630; 8,404,880; and 8,975,209.

When the activator is an alumoxane (modified or unmodified), typically the maximum amount of activator is at up to a 5,000-fold molar excess Al/M over the catalyst compound (per metal catalytic site). The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. Preferably, alumoxane is present at zero mole %, alternately the alumoxane is present at a molar ratio of aluminum to catalyst compound transition metal less than 500:1, preferably less than 300:1, preferably less than 100:1, preferably less than 1:1.

### Ionizing/Non Coordinating Anion Activators

The term “non-coordinating anion” (NCA) means an anion which either does not coordinate to a cation or which is only weakly coordinated to a cation thereby remaining sufficiently labile to be displaced, typically by a neutral Lewis base. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization. The term NCA includes multicomponent NCA-containing activators, such as N,N-dimethylanilinium tetrakis(pentafluorophenyl)borate, that contain an acidic cationic group and the non-coordinating anion, and neutral Lewis acids, such as tris(pentafluorophenyl)boron, that can react with a catalyst to form an activated species by abstraction of an anionic group. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon.

It is within the scope of this invention to use an ionizing activator, neutral or ionic. It is also within the scope of this invention to use neutral or ionic activators alone or in combination with alumoxane or modified alumoxane activators.

In embodiments of the invention, the activator is represented by the Formula (III):

(Z)_{d}⁺(A^{d-}) (III)

wherein Z is (L-H) or a reducible Lewis Acid, L is an neutral Lewis base; H is hydrogen; (L-H)⁺ is a Bronsted acid; A^{d-} is a non-coordinating anion having the charge d−; and d is an integer from 1 to 3 (such as 1, 2 or 3).

The anion component A^{d-} includes those having the formula [M^{k+}Qₙ]^{d-} wherein k is 1, 2, or 3; n is 1, 2, 3, 4, 5, or 6 (preferably 1, 2, 3, or 4); n−k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 50 carbon atoms (optionally with the proviso that in not more than 1 occurrence is Q a halide). Preferably, each Q is a fluorinated hydrocarbyl group having 1 to 50 (such as 1 to 40, such as 1 to 30, such as 1 to 20) carbon atoms, more preferably each Q is a fluorinated aryl group, such as a perfluorinated aryl group and most preferably each Q is a pentafluoryl aryl group or perfluoronaphthalenyl group. Examples of suitable A^{d-} also include diboron compounds as disclosed in U.S. Pat. No. 5,447,895, which is fully incorporated herein by reference.

When Z is the activating cation (L-H), it can be a Bronsted acid, capable of donating a proton to the transition metal catalytic precursor resulting in a transition metal cation, including ammoniums, oxoniums, phosphoniums, sulfoniums, and mixtures thereof, such as ammoniums of methylamine, aniline, dimethylamine, diethylamine, N-methylaniline, N-methyl-4-nonadecyl-N-octadecylaniline, N-methyl-4-octadecyl-N-octadecylaniline, diphenylamine, trimethylamine, triethylamine, N,N-dimethylaniline, methyldiphenylamine, pyridine, p-bromo N,N-dimethylaniline, p-nitro-N,N-dimethylaniline, dioctadecylmethylamine, phosphoniums from triethylphosphine, triphenylphosphine, and diphenylphosphine, oxoniums from ethers such as dimethyl ether, diethyl ether, tetrahydrofuran and dioxane, sulfoniums from thioethers, such as diethyl thioethers, tetrahydrothiophene, and mixtures thereof. In one embodiment, the borate activator comprises tetrakis(heptafluoronaphth-2-yl)borate and or tetrakis(pentafluorophenyl)borate.

Optionally, Z is (Ar₃C⁺), where Ar is aryl or aryl substituted with a heteroatom, a C₁ to C₄₀ hydrocarbyl, or a substituted C₁ to C₄₀ hydrocarbyl.

Alternately (Z)_{d}⁺ is represented by the formula:

[R^{1′}R^{2′}R^{3′}EH]_{d}⁺

wherein: E is nitrogen or phosphorous; d is 1, 2 or 3; R^{1′}, R^{2′}, and R^{3′} are independently hydrogen or a C₁ to C₅₀ hydrocarbyl group optionally substituted with one or more alkoxy groups, silyl groups, a halogen atoms, or halogen containing groups, wherein R^{1′}, R^{2′}, and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Alternately E is nitrogen; R^{1′} is hydrogen, and R^{2′}, and R^{3′} are independently a C₆-C₄₀ hydrocarbyl group optionally substituted with one or more alkoxy groups, silyl groups, a halogen atoms, or halogen containing groups, wherein R^{2′}, and R^{3′} together comprise 14 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Alternately E is nitrogen; R^{1′} is hydrogen, and R^{2′} is a C₆-C₄₀ hydrocarbyl group optionally substituted with one or more alkoxy groups, silyl groups, a halogen atoms, or halogen containing groups, and R^{3′} is a substituted phenyl group, wherein R^{2′}, and R^{3′} together comprise 14 or more carbon atoms.

Alternately, (Z)_{d}⁺ is represented by the formula:

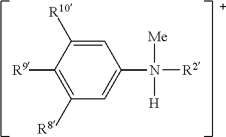

wherein: N is nitrogen, H is hydrogen, Me is methyl, R^{2′} is a C₆-C₄₀ hydrocarbyl group optionally substituted with one or more alkoxy groups, silyl groups, a halogen atoms, or halogen containing groups; R^{8′}, R^{9′}, and R₁₀′ are independently a C₄-C₃₀ hydrocarbyl or substituted C₄-C₃₀ hydrocarbyl group.

Optionally, R^{8′} and R¹⁰′ are hydrogen atoms and R^{9′} is a C₄-C₃₀ hydrocarbyl group which is optionally substituted with one or more alkoxy groups, silyl groups, a halogen atoms, or halogen containing groups.

Optionally, R^{9′} is a C₅-C₂₂ hydrocarbyl group which is optionally substituted with one or more alkoxy groups, silyl groups, a halogen atoms, or halogen containing groups.

Optionally, R^{2′} and R^{3′} are independently a C₁₂-C₂₂ hydrocarbyl group.

Optionally, R^{1′}, R^{2′} and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{2′} and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{8′}, R^{9′}, and R¹⁰′ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, when Q in the formula [M^{k+}Qₙ]^{d-} is a fluorophenyl group, then R^{2′} is not a C₁-C₄₀ linear alkyl group (alternately R^{2′} is not an optionally substituted C₁-C₄₀ linear alkyl group).

Optionally, each Q in the formula [M^{k+}Qₙ]^{d-} is an aryl group (such as phenyl or naphthalenyl), wherein at least one Q is substituted with at least one fluorine atom, preferably each Q is a perfluoroaryl group (such as perfluorophenyl or perfluoronaphthalenyl).

Optionally, R^{1′} is a methyl group; R^{2′} is C₆-C₅₀ aryl group; and R^{3′} is independently C₁-C₄₀ linear alkyl or C₅-C₅₀-aryl group.

Optionally, each of R^{2′} and R^{3′} is independently unsubstituted or substituted with at least one of halide, C₁-C₃₅ alkyl, C₅-C₁₅ aryl, C₆-C₃₅ arylalkyl, C₆-C₃₅ alkylaryl, wherein R², and R³ together comprise 20 or more carbon atoms.

Optionally, each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical, provided that when Q is a fluorophenyl group, then R^{2′} is not a C₁-C₄₀ linear alkyl group, preferably R^{2′} is not an optionally substituted C₁-C₄₀ linear alkyl group (alternately when Q is a substituted phenyl group, then R^{2′} is not a C₁-C₄₀ linear alkyl group, preferably R^{2′} is not an optionally substituted C₁-C₄₀ linear alkyl group). Optionally, when Q is a fluorophenyl group (alternately when Q is a substituted phenyl group), then R^{2′} is a meta- and/or para-substituted phenyl group, where the meta and para substituents are, independently, an optionally substituted C₁ to C₄₀ hydrocarbyl group (such as a C₆ to C₄₀ aryl group or linear alkyl group, a C₁₂ to C₃₀ aryl group or linear alkyl group, or a C₁₀ to C₂₀ aryl group or linear alkyl group), an optionally substituted alkoxy group, or an optionally substituted silyl group. Optionally, each Q is a fluorinated hydrocarbyl group having 1 to 30 carbon atoms, more preferably each Q is a fluorinated aryl (such as phenyl or naphthalenyl) group, and most preferably each Q is a perflourinated aryl (such as phenyl or naphthalenyl) group. Examples of suitable [Mt^{k+}Qₙ]^{d-} also include diboron compounds as disclosed in U.S. Pat. No. 5,447,895, which is fully incorporated herein by reference. Optionally, at least one Q is not substituted phenyl. Optionally all Q are not substituted phenyl. Optionally at least one Q is not perfluorophenyl. Optionally all Q are not perfluorophenyl.

Useful cation components (Z)_{d}⁺ include those represented by the formulas:

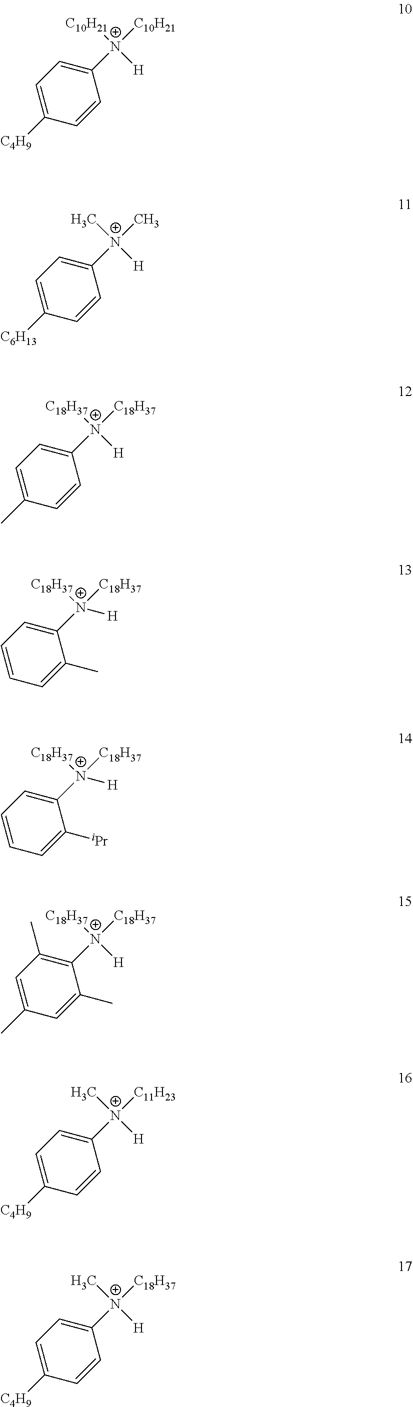

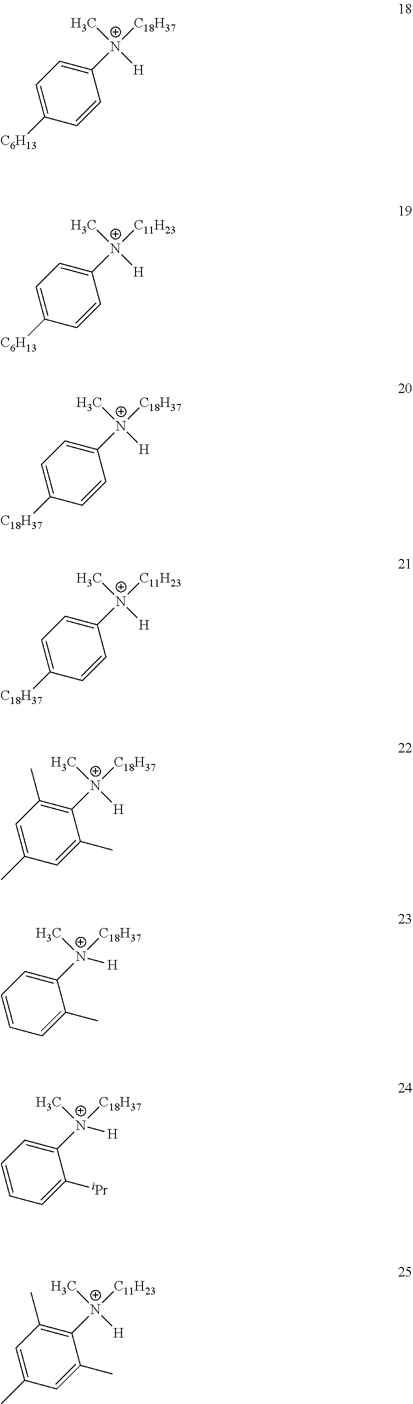

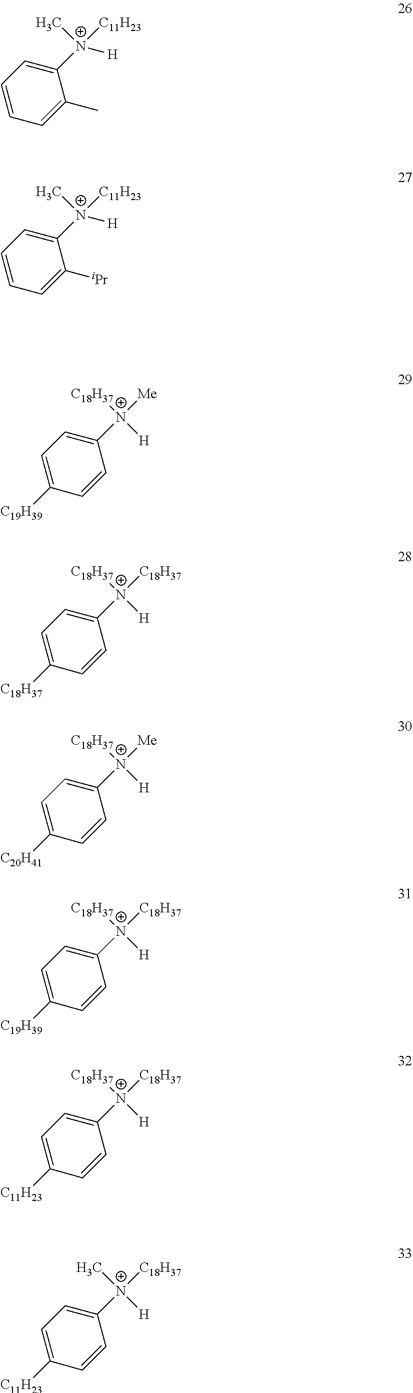

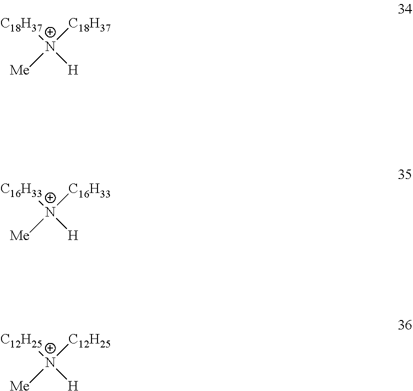

Useful cation components in (Z)_{d}⁺ include those represented by the formulas:

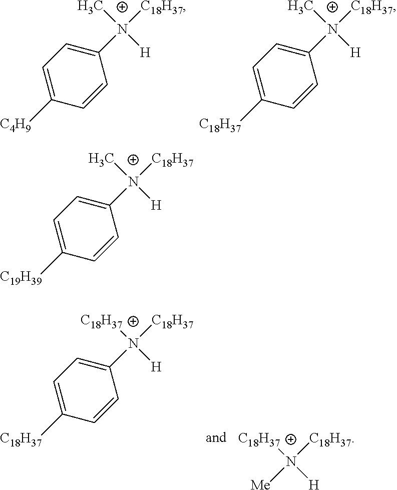

Anions for use in the non-coordinating anion activators described herein also include those represented by Formula 7, below:

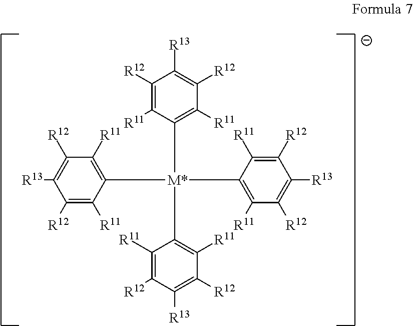

wherein:
M* is a group 13 atom, preferably B or Al, preferably B;
each R¹¹ is, independently, a halide, preferably a fluoride;
each R¹² is, independently, a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹² is a fluoride or a perfluorinated phenyl group;
each R¹³ is a halide, a C₆ to C₂₀ substituted aromatic hydrocarbyl group or a siloxy group of the formula —O—Si—Rₐ, where R^{a} is a C₁ to C₂₀ hydrocarbyl or hydrocarbylsilyl group, preferably R¹³ is a fluoride or a C₆ perfluorinated aromatic hydrocarbyl group;
wherein R¹² and R¹³ can form one or more saturated or unsaturated, substituted or unsubstituted rings, preferably R¹² and R¹³ form a perfluorinated phenyl ring. Preferably the anion has a molecular weight of greater than 700 g/mol, and, preferably, at least three of the substituents on the M* atom each have a molecular volume of greater than 180 cubic Å.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in “A Simple “Back of the Envelope” Method for Estimating the Densities and Molecular Volumes of Liquids and Solids,” Jrnl. of Chem. Ed., v. 71(11), November 1994, pp. 962-964. Molecular volume (MV), in units of cubic Å, is calculated using the formula: MV=8.3V_{S}, where V_{S} is the scaled volume. V_{S} is the sum of the relative volumes of the constituent atoms, and is calculated from the molecular formula of the substituent using Table A below of relative volumes. For fused rings, the V_{S} is decreased by 7.5% per fused ring. The Calculated Total MV of the anion is the sum of the MV per substituent, for example, the MV of perfluorophenyl is 183 Å³, and the Calculated Total MV for tetrakis(perfluorophenyl)borate is four times 183 Å³, or 732 Å³.

TABLE A

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Exemplary anions useful herein and their respective scaled volumes and molecular volumes are shown in Table B below. The dashed bonds indicate bonding to boron.

TABLE B

| | | Molecular | | MV | |
|---|---|---|---|---|---|
| | | Formula of | | Per | Calculated |
| | | Each | | subst. | Total MV |
| Ion | Structure of Boron Substituents | Substituent | Vₛ | (Å³) | (Å³) |
| tetrakis(perfluorophenyl)borate | 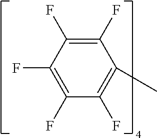 | C₆F₅ | 22 | 183 | 732 |
| tris(perfluorophenyl)- (perfluoronaphthalenyl)borate | 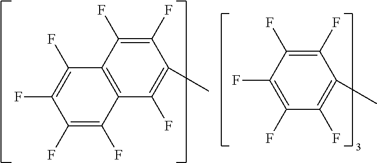 | C₆F₅ C₁₀F₇ | 22 34 | 183 261 | 810 |
| (perfluorophenyl)tris- (perfluoronaphthalenyl)borate | 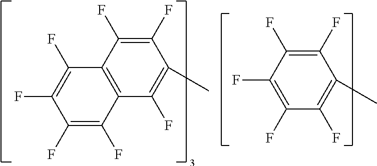 | C₆F₅ C₁₀F₇ | 22 34 | 183 261 | 966 |
| tetrakis(perfluoronaphthalenyl)borate | 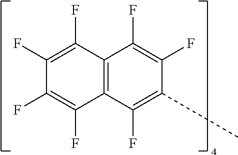 | C₁₀F₇ | 34 | 261 | 1044 |
| tetrakis(perfluorobiphenyl)borate | 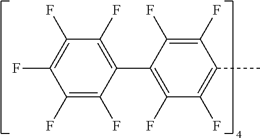 | C₁₂F₉ | 42 | 349 | 1396 |
| [(C₆F₃(C₆F₅)₂)₄B] | 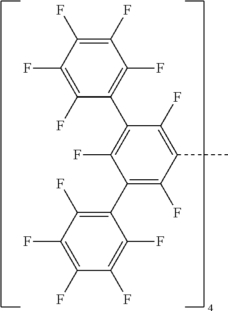 | C₁₈F₁₃ | 62 | 515 | 2060 |

The activators may be added to a polymerization in the form of an ion pair using, for example, [M2HTH]+ [NCA]− in which the di(hydrogenated tallow)methylamine (“M2HTH”) cation reacts with a basic leaving group on the transition metal complex to form a transition metal complex cation and [NCA]−. Alternatively, the transition metal complex may be reacted with a neutral NCA precursor, such as B(C₆F₅)₃, which abstracts an anionic group from the complex to form an activated species.

Activator compounds that useful in this invention include one or more of:
di(hydrogenated tallow)methylammonium[tetrakis(pentafluorophenyl)borate],
di(octadecyl)tolylammonium [tetrakis(pentafluorophenyl)borate],
N,N-dimethylanilinium [tetrakis(heptafluoronaphth-2-yl)borate],
N,N-dimethylanilinium [tetrakis(pentafluorophenyl)borate],
N,N-di(hydrogenated tallow)methylammonium [tetrakis(perfluorophenyl) borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

Preferred activators for use herein also include:
N-methyl-4-nonadecyl-N-octadecylbenzenaminium tetrakis(pentafluorophenyl)borate,
N-methyl-4-nonadecyl-N-octadecylbenzenaminium tetrakis(perfluoronaphthalenyl)borate,
N,N-dimethylanilinium tetrakis(perfluoronaphthalenyl)borate,
N,N-dimethylanilinium tetrakis(perfluorobiphenyl)borate,
N,N-dimethylanilinium tetrakis(perfluorophenyl)borate,
N,N-dimethylanilinium tetrakis(3,5-bis(trifluoromethyl)phenyl)borate,
triphenylcarbenium tetrakis(perfluoronaphthalenyl)borate,
triphenylcarbenium tetrakis(perfluorobiphenyl)borate,
triphenylcarbenium tetrakis(3,5-bis(trifluoromethyl)phenyl)borate,
triphenylcarbenium tetrakis(perfluorophenyl)borate,
[Me₃NH⁺][B(C₆F₅)₄⁻];
1-(4-(tris(pentafluorophenyl)borate)-2,3,5,6-tetrafluorophenyl)pyrrolidinium; and
tetrakis(pentafluorophenyl)borate, 4-(tris(pentafluorophenyl)borate)-2,3,5,6-tetrafluoropyridine.

In a preferred embodiment, the activator comprises a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthalenyl)borate, triphenylcarbenium tetrakis(perfluorobiphenyl)borate, triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, dioctadecylmethylammonium tetrakis(pentafluorophenyl)borate, dioctadecylmethylammonium tetrakis(perfluoronaphthalenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthalenyl)borate, N,N-dialkylanilinium tetrakis(perfluoronaphthalenyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

Likewise, useful activators also include N,N-dimethylanilinium tetrakis(pentafluorophenyl)borate, N,N-dimethylanilinium tetrakis(heptafluoro-2-naphthalenyl)borate, dioctadecylmethylammonium tetrakis(pentafluorophenyl)borate, and dioctadecylmethylammonium tetrakis(perfluoronaphthyl)borate.

Additional useful activators and the synthesis of non-aromatic-hydrocarbon soluble activators are described in U.S. Ser. No. 16/394,166 filed Apr. 25, 2019, U.S. Ser. No. 16/394,186, filed Apr. 25, 2019, and U.S. Ser. No. 16/394,197, filed Apr. 25, 2019, which are incorporated by reference herein.

For a more detailed description of useful activators please see WO 2004/026921 page 72, paragraph [00119] to page 81 paragraph [00151]; U.S. Pat. Nos. 8,658,556; 6,211,105; US 2019/0330139; and US 2019/0330392. A list of useful activators that can be used in the practice of this invention may be found at page 72, paragraph [00177] to page 74, paragraph [00178] of WO 2004/046214.

The typical activator-to-catalyst ratio, e.g., all NCA activators-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

It is also within the scope of the present disclosure that the catalyst compounds can be combined with combinations of alumoxanes and NCA's (see for example, U.S. Pat. Nos. 5,153,157; 5,453,410; EP 0 573 120 B1; WO 1994/007928; and WO 1995/014044 (the disclosures of which are incorporated herein by reference in their entirety) which discuss the use of an alumoxane in combination with an ionizing activator).

In useful embodiments of the invention, the activator is soluble in non-aromatic-hydrocarbon solvents, such as aliphatic solvents.

In one or more embodiments, a 20 wt % mixture of the activator compound in n-hexane, isohexane, cyclohexane, methylcyclohexane, or a combination thereof, forms a clear homogeneous solution at 25° C., preferably a 30 wt % mixture of the activator compound in n-hexane, isohexane, cyclohexane, methylcyclohexane, or a combination thereof, forms a clear homogeneous solution at 25° C.

In embodiments of the invention, the activators described herein have a solubility of more than 10 mM (or more than 20 mM, or more than 50 mM) at 25° C. (stirred 2 hours) in methylcyclohexane.

In embodiments of the invention, the activators described herein have a solubility of more than 1 mM (or more than 10 mM, or more than 20 mM) at 25° C. (stirred 2 hours) in isohexane.

In embodiments of the invention, the activators described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

In a preferred embodiment, the activator is a non-aromatic-hydrocarbon (such as toluene) soluble activator compound.

### Optional Scavengers, Co-Activators, Chain Transfer Agents

In addition to activator compounds, scavengers or co-activators may be used.

A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In some embodiments a co-activator can be pre-mixed with the transition metal compound to form an alkylated transition metal compound.

Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and diethyl zinc.

Chain transfer agents may be used in the compositions and or processes described herein. Useful chain transfer agents are typically alkylalumoxanes, a compound represented by the formula AlR₃, ZnR₂ (where each R is, independently, a C₁-C₈ aliphatic radical, preferably methyl, ethyl, propyl, butyl, penyl, hexyl octyl or an isomer thereof) or a combination thereof, such as diethyl zinc, methylalumoxane, trimethylaluminum, triisobutylaluminum, trioctylaluminum, or a combination thereof.

### Optional Support Materials

In embodiments herein, the catalyst system may comprise an inert support material. Preferably the supported material is a porous support material, for example, talc, and inorganic oxides. Other support materials include zeolites, clays, organoclays, or any other organic or inorganic support material and the like, or mixtures thereof.

Preferably, the support material is an inorganic oxide in a finely divided form. Suitable inorganic oxide materials for use in catalyst systems herein include Groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support materials, however, can be employed, for example, finely divided functionalized polyolefins, such as finely divided polyethylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. Preferred support materials include Al₂O₃, ZrO₂, SiO₂, and combinations thereof, more preferably SiO₂, Al₂O₃, or SiO₂/Al₂O₃.

It is preferred that the support material, most preferably an inorganic oxide, has a surface area in the range of from about 10 to about 700 m²/g, pore volume in the range of from about 0.1 to about 4.0 cc/g and average particle size in the range of from about 5 to about 500 μm. More preferably, the surface area of the support material is in the range of from about 50 to about 500 m²/g, pore volume of from about 0.5 to about 3.5 cc/g and average particle size of from about 10 to about 200 μm. Most preferably the surface area of the support material is in the range is from about 100 to about 400 m²/g, pore volume from about 0.8 to about 3.0 cc/g and average particle size is from about 5 to about 100 μm. The average pore size of the support material useful in the invention is in the range of from 10 to 1000 Å, preferably 50 to about 500 Å, and most preferably 75 to about 350 Å. In some embodiments, the support material is a high surface area, amorphous silica (surface area=300 m²/gm; pore volume of 1.65 cm³/gm). Preferred silicas are marketed under the tradenames of DAVISON™ 952 or DAVISON™ 955 by the Davison Chemical Division of W.R. Grace and Company. In other embodiments DAVISON™ 948 is used.

The support material should be dry, that is, free of absorbed water. Drying of the support material can be effected by heating or calcining at about 100° C. to about 1,000° C., preferably at least about 600° C. When the support material is silica, it is heated to at least 200° C., preferably about 200° C. to about 850° C., and most preferably at about 600° C.; and for a time of about 1 minute to about 100 hours, from about 12 hours to about 72 hours, or from about 24 hours to about 60 hours. The calcined support material must have at least some reactive hydroxyl (OH) groups to produce supported catalyst systems of this invention. The calcined support material is then contacted with at least one polymerization catalyst comprising at least one catalyst compound and an activator.

The support material, having reactive surface groups, typically hydroxyl groups, is slurried in a non-polar solvent and the resulting slurry is contacted with a solution of a catalyst compound and an activator. In some embodiments, the slurry of the support material is first contacted with the activator for a period of time in the range of from about 0.5 hours to about 24 hours, from about 2 hours to about 16 hours, or from about 4 hours to about 8 hours. The solution of the catalyst compound is then contacted with the isolated support/activator. In some embodiments, the supported catalyst system is generated in situ. In alternate embodiment, the slurry of the support material is first contacted with the catalyst compound for a period of time in the range of from about 0.5 hours to about 24 hours, from about 2 hours to about 16 hours, or from about 4 hours to about 8 hours. The slurry of the supported catalyst compound is then contacted with the activator solution.

The mixture of the catalyst, activator and support is heated to about 0° C. to about 70° C., preferably to about 23° C. to about 60° C., preferably at room temperature. Contact times typically range from about 0.5 hours to about 24 hours, from about 2 hours to about 16 hours, or from about 4 hours to about 8 hours.

Suitable non-polar solvents are materials in which all of the reactants used herein, i.e., the activator, and the catalyst compound, are at least partially soluble and which are liquid at reaction temperatures. Preferred non-polar solvents are alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

### Polymerization Processes

In embodiments herein, the invention relates to polymerization processes where monomer (such as ethylene), and optionally comonomer, are contacted with a catalyst system comprising an activator and at least one catalyst compound, as described above. The catalyst compound and activator may be combined in any order, and are combined typically prior to contacting with the monomer.

Monomers useful herein include substituted or unsubstituted C₂ to C₄₀ alpha olefins, preferably C₂ to C₂₀ alpha olefins, preferably C₂ to C₁₂ alpha olefins, preferably ethylene, propylene, butene, pentene, hexene, heptene, octene, nonene, decene, undecene, dodecene and isomers thereof.

In embodiments of the invention, the monomer comprises propylene and optional comonomer(s) comprising one or more of ethylene and C₄ to C₄₀ olefins, preferably C₄ to C₂₀ olefins, or preferably C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups.

In embodiments of the invention, the monomer comprises ethylene and optional comonomer(s) comprising one or more C₃ to C₄₀ olefins, preferably C₄ to C₂₀ olefins, or preferably C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups.

Exemplary C₂ to C₄₀ olefin monomers and optional comonomers include ethylene, propylene, butene, pentene, hexene, heptene, octene, nonene, decene, undecene, dodecene, norbornene, norbomadiene, dicyclopentadiene, cyclopentene, cycloheptene, cyclooctene, cyclooctadiene, cyclododecene, substituted derivatives thereof, and isomers thereof, preferably hexene, heptene, octene, nonene, decene, dodecene, cyclooctene, 5-methylcyclopentene, cyclopentene, dicyclopentadiene, norbornene, norbomadiene, and their respective homologs and derivatives, preferably norbornene, norbomadiene, and dicyclopentadiene.

In embodiments of the invention one or more dienes are present in the polymer produced herein at up to 10 weight %, preferably at 0.00001 to 1.0 weight %, preferably 0.002 to 0.5 weight %, even more preferably 0.003 to 0.2 weight %, based upon the total weight of the composition. In some embodiments 500 ppm or less of diene is added to the polymerization, preferably 400 ppm or less, preferably or 300 ppm or less. In other embodiments at least 50 ppm of diene is added to the polymerization, or 100 ppm or more, or 150 ppm or more.

Diolefin monomers useful in this invention include any hydrocarbon structure, preferably C₄ to C₃₀, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e. di-vinyl monomers). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and polybutadienes having an Mw of less than 1000 g/mol. Preferred cyclic dienes include cyclopentadiene, vinylnorbornene, norbornadiene, ethylidene norbomene, divinylbenzene, dicyclopentadiene or higher ring containing diolefins with or without substituents at various ring positions.

### Polymerization

A solution polymerization is a polymerization process in which the polymer is dissolved in a liquid polymerization medium, such as an inert solvent or monomer(s) or their blends. A solution polymerization is typically homogeneous. A homogeneous polymerization is one where polymer product is dissolved in the polymerization medium, such as 80 wt % or more, 90 wt % or more or 100% of polymer product is dissolved in the reaction medium. Such systems are preferably not turbid as described in J. Vladimir Oliveira, Ind. Eng. Chem. Res., v. 29, 2000, pg. 4627.

A bulk polymerization means a polymerization process in which the monomers and/or comonomers being polymerized are used as a solvent or diluent using little or no inert solvent as a solvent or diluent. A small fraction of inert solvent might be used as a carrier for catalyst and scavenger. A bulk polymerization system typically contains less than 25 wt % of inert solvent or diluent, preferably less than 10 wt %, preferably less than 1 wt %, preferably 0 wt %.

Polymerization processes of this invention can be carried out in any manner known in the art. Any suspension, homogeneous, bulk, solution, slurry, or gas phase polymerization process known in the art can be used. Such processes can be run in a batch, semi-batch, or continuous mode. Homogeneous polymerization processes are typically useful, such as homogeneous polymerization process where at least 90 wt % of the product is soluble in the reaction media. A bulk homogeneous process is also useful, such as a process where monomer concentration in all feeds to the reactor is 70 volume % or more. Alternately, no solvent or diluent is present or added in the reaction medium, (except for the small amounts used as the carrier for the catalyst system or other additives, or amounts typically found with the monomer; e.g., propane in propylene). In another embodiment, the process is a slurry process, e.g., a polymerization process typically using a supported catalyst where at least 95 wt % of polymer products derived from the supported catalyst is in granular form as solid particles (not dissolved in the diluent or polymerization medium).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™ fluids); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, preferably aromatics are present in the solvent at less than 1 wt %, preferably less than 0.5 wt %, preferably less than 0 wt % based upon the weight of the solvents.

In a preferred embodiment, the feed concentration of the monomers and comonomers for the polymerization is 60 vol % solvent or less, preferably 40 vol % or less, or preferably 20 vol % or less, based on the total volume of the feedstream. Preferably the polymerization is run in a bulk process.

Preferred polymerizations can be run at any temperature and/or pressure suitable to obtain the desired ethylene polymers. Typical temperatures and/or pressures include a temperature in the range of from about 0° C. to about 300° C., preferably about 20° C. to about 200° C., preferably about 35° C. to about 150° C., preferably from about 40° C. to about 120° C., preferably from about 45° C. to about 80° C.; and at a pressure in the range of from about 0.35 MPa to about 10 MPa, preferably from about 0.45 MPa to about 6 MPa, or preferably from about 0.5 MPa to about 4 MPa.

In a typical polymerization, the run time of the reaction is up to 300 minutes, preferably in the range of from about 5 to 250 minutes, or preferably from about 10 to 120 minutes.

In some embodiments hydrogen is present in the polymerization reactor at a partial pressure of 0.001 to 50 psig (0.007 to 345 kPa), preferably from 0.01 to 25 psig (0.07 to 172 kPa), more preferably 0.1 to 10 psig (0.7 to 70 kPa).

In an alternate embodiment, the activity of the catalyst is at least 50 g/mmol/hour, preferably 500 or more g/mmol/hour, preferably 5000 or more g/mmol/hr, preferably 50,000 or more g/mmol/hr. In an alternate embodiment, the conversion of olefin monomer is at least 10%, based upon polymer yield and the weight of the monomer entering the reaction zone, preferably 20% or more, preferably 30% or more, preferably 50% or more, preferably 80% or more.

In a preferred embodiment, little or no alumoxane is used in the process to produce the polymers. Preferably, alumoxane is present at zero mol %, alternately the alumoxane is present at a molar ratio of aluminum to transition metal less than 500:1, preferably less than 300:1, preferably less than 100:1, preferably less than 1:1.

In a preferred embodiment, little or no scavenger is used in the process to produce the ethylene polymer. Preferably, scavenger (such as tri alkyl aluminum) is present at zero mol %, alternately the scavenger is present at a molar ratio of scavenger metal to transition metal of less than 100:1, preferably less than 50:1, preferably less than 15:1, preferably less than 10:1.

In a preferred embodiment, the polymerization: 1) is conducted at temperatures of 0 to 300° C. (preferably 25 to 150° C., preferably 40 to 120° C., preferably 45 to 80° C.); 2) is conducted at a pressure of atmospheric pressure to 10 MPa (preferably 0.35 to 10 MPa, preferably from 0.45 to 6 MPa, preferably from 0.5 to 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably where aromatics are preferably present in the solvent at less than 1 wt %, preferably less than 0.5 wt %, preferably at 0 wt % based upon the weight of the solvents); 4) wherein the catalyst system used in the polymerization comprises less than 0.5 mol %, preferably 0 mol % alumoxane, alternately the alumoxane is present at a molar ratio of aluminum to transition metal less than 500:1, preferably less than 300:1, preferably less than 100:1, preferably less than 1:1; 5) the polymerization preferably occurs in one reaction zone; 6) the productivity of the catalyst compound is at least 80,000 g/mmol/hr (preferably at least 150,000 g/mmol/hr, preferably at least 200,000 g/mmol/hr, preferably at least 250,000 g/mmol/hr, preferably at least 300,000 g/mmol/hr); 7) optionally scavengers (such as trialkyl aluminum compounds) are absent (e.g. present at zero mol %, alternately the scavenger is present at a molar ratio of scavenger metal to transition metal of less than 100:1, preferably less than 50:1, preferably less than 15:1, preferably less than 10:1); and 8) optionally hydrogen is present in the polymerization reactor at a partial pressure of 0.001 to 50 psig (0.007 to 345 kPa) (preferably from 0.01 to 25 psig (0.07 to 172 kPa), more preferably 0.1 to 10 psig (0.7 to 70 kPa)). In a preferred embodiment, the catalyst system used in the polymerization comprises no more than one catalyst compound. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone. Room temperature is 23° C. unless otherwise noted.

Other additives may also be used in the polymerization, as desired, such as one or more scavengers, promoters, modifiers, reducing agents, oxidizing agents, hydrogen, aluminum alkyls, silanes, or chain transfer agents (such as alkylalumoxanes, a compound represented by the formula AlR₃ or ZnR₂ (where each R is, independently, a C₁-C₅ aliphatic radical, preferably methyl, ethyl, propyl, butyl, penyl, hexyl octyl or an isomer thereof) or a combination thereof, such as diethyl zinc, methylalumoxane, trimethylaluminum, triisobutylaluminum, trioctylaluminum, or a combination thereof).

### Polyolefin Products

This invention also relates to compositions of matter produced by the methods described herein.

The process of this invention produces olefin polymers, preferably polyethylene and polypropylene homopolymers and copolymers. In a preferred embodiment, the polymers produced herein are homopolymers of ethylene or propylene, are copolymers of ethylene preferably having from 0 to 25 mole % (alternately from 0.5 to 20 mole %, alternately from 1 to 15 mole %, preferably from 3 to 10 mole %) of one or more C₃ to C₂₀ olefin comonomer (preferably C₃ to C₁₂ alpha-olefin, preferably propylene, butene, hexene, octene, decene, dodecene, preferably propylene, butene, hexene, octene), or are copolymers of propylene preferably having from 0 to 25 mole % (alternately from 0.5 to 20 mole %, alternately from 1 to 15 mole %, preferably from 3 to 10 mole %) of one or more of C₂ or C₄ to C₂₀ olefin comonomer (preferably ethylene or C₄ to C₁₂ alpha-olefin, preferably ethylene, butene, hexene, octene, decene, dodecene, preferably ethylene, butene, hexene, octene).

In a preferred embodiment, the monomer is ethylene and the comonomer is hexene, preferably from 1 to 15 mole % hexene, alternately 1 to 10 mole %.

Typically, the polymers produced herein have an Mw of 5,000 to 1,000,000 g/mol (preferably 25,000 to 750,000 g/mol, preferably 50,000 to 500,000 g/mol), and/or an Mw/Mn of greater than 1 to 40 (alternately 1.2 to 20, alternately 1.3 to 10, alternately 1.4 to 5, 1.5 to 4, alternately 1.5 to 3).

In a preferred embodiment the polymer produced herein has a unimodal or multimodal molecular weight distribution as determined by Gel Permeation Chromotography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

### Blends

In another embodiment, the polymer (preferably the polyethylene or polypropylene) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In a preferred embodiment, the polymer (preferably the ethylene or propylene polymers) is present in the above blends, at from 10 to 99 wt %, based upon the weight of the polymers in the blend, preferably 20 to 95 wt %, even more preferably at least 30 to 90 wt %, even more preferably at least 40 to 90 wt %, even more preferably at least 50 to 90 wt %, even more preferably at least 60 to 90 wt %, even more preferably at least 70 to 90 wt %.

The blends described above may be produced by mixing the polymers of the invention with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; and the like.

### End Uses

Any of the foregoing polymers and compositions in combination with optional additives (anti-oxidants, colorants, dyes, stabilizers, filler, etc.) may be used in a variety of end-use applications produced by methods known in the art. Exemplary end uses are waxes, films, film-based products, diaper backsheets, housewrap, wire and cable coating compositions, articles formed by molding techniques, e.g., injection or blow molding, extrusion coating, foaming, casting, and combinations thereof. End uses also include products made from films, e.g., bags, packaging, and personal care films, pouches, medical products, such as for example, medical films and intravenous (IV) bags.

### Films

Any of the foregoing polymers or blends thereof, may be used in a variety of end-use applications. Such applications include, for example, mono- or multi-layer blown, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. For example, the films can be oriented in the Machine Direction (MD) at a ratio of up to 15, such as from about 5 to about 7, and in the Transverse Direction (TD) at a ratio of up to 15, such as from about 7 to about 9. However, in another embodiment the film is oriented to the same extent in both the MD and TD directions.

The films may vary in thickness depending on the intended application; however, films of a thickness from 1 μm to 50 μm can be suitable. Films intended for packaging can be from 10 μm to 50 μm thick. The thickness of the sealing layer can be from 0.2 μm to 50 μm. There may be a sealing layer on both the inner and outer surfaces of the film or the sealing layer may be present on only the inner or the outer surface.

In another embodiment, one or more layers may be modified by corona treatment, electron beam irradiation, gamma irradiation, flame treatment, or microwave. In at least one embodiment, one or both of the surface layers is modified by corona treatment.

### Waxes

Polyolefin waxes, such as polyethylene waxes, having low molecular weight of about 250 g/mol to about 15,000 g/mol, for example, can be prepared in a solution polymerization process using the catalysts described herein. The production of polyolefin waxes may be performed at a temperature of from about 50° C. to about 220° C., such as from about 100° C. to about 200° C., such as from about 120° C. to about 160° C. The production of polyolefin waxes may be performed at a reactor pressure of from about 0.5 MPa to about 25 MPa, such as from about 0.7 MPa to about 6 MPa. The production of polyolefin waxes may be performed in the presence of added hydrogen at a partial pressure of from 0 psig to about 100 psig, such as from 0 psig to about 40 psig, such as 0 psig.

This invention further relates to:

1. A catalyst compound represented by the Formula (I):

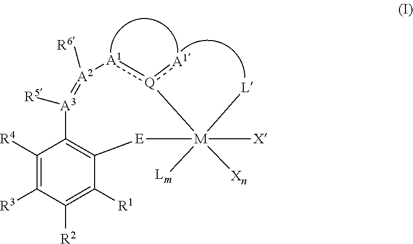

wherein:
M is a group 3, 4, 5, or 6 transition metal or Lanthanide;
E is O, S, or NR⁹⁹, where R⁹⁹ is hydrogen, C₁-C₄₀ hydrocarbyl, C₁-C₄₀ substituted hydrocarbyl, monovalent heteroatom, or a monovalent substituted heteroatom group;
Q is group 14, 15, or 16 atom that forms a bond to metal M;
A¹ and A^{1′} are independently C, N, or C(R³²), where R³² is selected from hydrogen, C₁-C₂₀ hydrocarbyl, C₁-C₂₀ substituted hydrocarbyl, monovalent heteroatom, or a monovalent substituted heteroatom group;
A¹QA^{1′} are part of a heterocyclic Lewis base containing 4 to 40 non-hydrogen atoms;
A² and A³ are independently a group 14 atom;
each R^{5′} and R^{6′} is independently hydrogen, C₁-C₄₀ hydrocarbyl, C₁-C₄₀ substituted hydrocarbyl, monovalent heteroatom, or a monovalent substituted heteroatom group;
R^{6′}-A²=A³-R^{5′} is a divalent group containing 2 to 40 non-hydrogen atoms, where R^{5′} and R^{6′} optionally join to form a hydrocarbyl ring, a substituted hydrocarbyl ring, a heterocyclic ring, or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
L′ is a neutral Lewis base joined to the heterocyclic Lewis base containing A¹QA^{1′};
X′ is an anionic ligand that is optionally joined to L′;
L is a neutral Lewis base;
X is an anionic ligand;
n is 1 or 2;
m is 0 or 1;
n+m is 0, 1 or 2;
each of R¹, R², R³, and R⁴ is independently hydrogen, C₁-C₄₀ hydrocarbyl, C₁-C₄₀ substituted hydrocarbyl, monovalent heteroatom, or a monovalent substituted heteroatom group, or optionally one or more of R¹ and R², R² and R³, R³ and R⁴, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms; and
an X group may be joined to an L group to form a monoanionic bidentate group, and any two X groups may be joined together to form a dianionic ligand group.
   2. The catalyst compound of paragraph 1 wherein the catalyst compound is represented by the Formula (Ia):

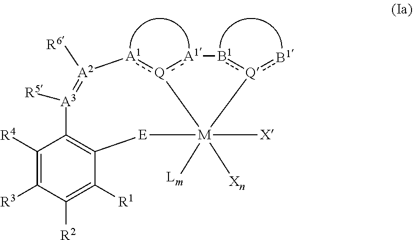

wherein, M, m, n, L, X, X′, E, R¹, R², R³, R⁴, R³², R⁹⁹, A¹, Q, A^{1′}, A², A³, R^{5′}, and R^{6′}, are as described in paragraph 1;
Q′ is group 14, 15, or 16 atom that forms a bond to metal M;
B¹ and B^{1′} are independently C, N, or C(R³²), where R³² is selected from hydrogen, C₁-C₂₀ hydrocarbyl, C₁-C₂₀ substituted hydrocarbyl, monovalent heteroatom, or a monovalent substituted heteroatom group;
B¹QB^{1′} are part of a heterocyclic Lewis base containing 4 to 40 non-hydrogen atoms joined to the heterocyclic Lewis base containing A¹QA^{1′};
X′ is an anionic ligand that is optionally joined to the heterocyclic Lewis base containing B¹Q′B^{1′}.
   3. The catalyst compound of paragraph 1 wherein the catalyst compound is represented by the Formula (Ib):

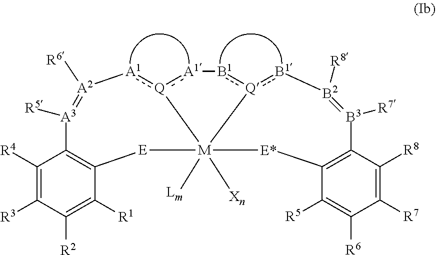

wherein, M, m, n, L, X, X′, E, R¹, R², R³, R⁴, R³², R⁹⁹, A¹, Q, A^{1′}, A², A³, R^{5′}, R^{6′}, B¹, Q′, and B^{1′}, are as described in the above paragraphs;
B² and B³ are independently a group 14 atom, such as C, Ge or Si;
each R^{7′} and R^{8′} is independently hydrogen, C₁-C₄₀ hydrocarbyl, C₁-C₄₀ substituted hydrocarbyl, monovalent heteroatom, or a monovalent substituted heteroatom group;
R^{7′}—B³═B²—R^{8′} is a divalent group containing 2 to 40 non-hydrogen atoms, where R^{5′} and R^{6′} optionally join to form a hydrocarbyl ring, a substituted hydrocarbyl ring, a heterocyclic ring, or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
each R⁵, R⁶, R⁷, and R⁸, is independently a hydrogen, a C₁-C₄₀ hydrocarbyl, a C₁-C₄₀ substituted hydrocarbyl, a heteroatom (such as a monovalent heteroatom), or substituted heteroatom (such as a monovalent substituted heteroatom group), or optionally one or more adjacent R groups, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
E* is O, S, or NR⁹⁹, where R⁹⁹ is hydrogen, C₁-C₄₀ hydrocarbyl, C₁-C₄₀ substituted hydrocarbyl, or a heteroatom-containing group.
   4. The catalyst compound of paragraph 1 where the catalyst compound is represented by the Formula (III):

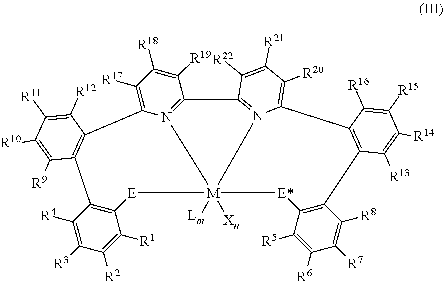

wherein, M, m, n, L, X, E, E*, R¹, R², R³, R⁴, R⁵, R⁶, R⁷, R⁸, R⁹, R¹⁰, R¹¹, R¹², R¹⁷, R¹⁸, R¹⁹, R²⁰ R²¹, R²², R²³, R³², and R⁹⁹ are as described in the above paragraphs;
each R¹³, R¹⁴, R¹⁵, and R¹⁶, is independently a hydrogen, a C₁-C₄₀ hydrocarbyl, a C₁-C₄₀ substituted hydrocarbyl, a heteroatom (such as a monovalent heteroatom), or substituted heteroatom (such as a monovalent substituted heteroatom group), or optionally one or more adjacent R groups, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms.
   5. The catalyst compound of paragraph 1 where the catalyst compound is represented by Formula (IV):

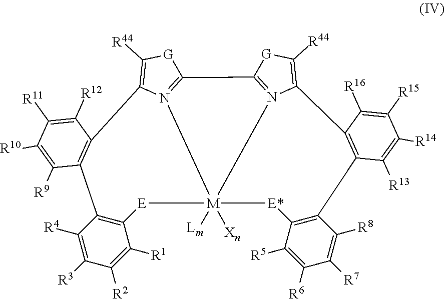

wherein, M, m, n, L, X, E, E*, R¹, R², R³, R⁴, R⁵, R⁶, R⁷, R⁸, R⁹, R¹⁰, R¹¹, R¹², R¹³, R¹⁴, R¹⁵, R¹⁶, and R⁹⁹ are as described in the above paragraphs, each G is independently S, O, or NR²⁴ and each R²⁴ group and each R⁴⁴ group is independently selected from hydrogen, heteroatoms, C₁-C₂₀ alkyls, C₁-C₂₀ alkoxides, C₁-C₂₀ amides, and C₁-C₂₀ substituted alkyls, and wherein two adjacent R²⁴ and or R⁴⁴ groups on the same ring can be joined to form one or more hydrocarbyl rings, substituted hydrocarbyl rings, heterocyclic rings or a substituted heterocyclic rings, where each ring has 5, 6, 7, or 8 ring atoms, and where substituents on the ring can join to form one or more additional hydrocarbyl rings, substituted hydrocarbyl rings, heterocyclic rings, or substituted heterocyclic rings.
6. The catalyst compound of any of paragraphs 1 to 5, wherein M is Hf, Ti and/or Zr, alternatively Hf or Zr.
7. The catalyst compound of any of paragraphs 1 to 6, wherein E and E* if present are oxygen.
8. The catalyst compound of any of paragraphs 1 to 3, 6, and 7, wherein Q is nitrogen.
9. The catalyst compound of any of paragraphs 1 to 3 and 6 to 8, wherein the fragment R^{6′}-A²=A³-R^{5′} forms an aromatic ring.
10. The catalyst compound of any of paragraphs 1 to 3 and 6 to 9, wherein the fragment R^{6′}-A²=A³-R^{5′} forms a 5 or 6 membered aromatic ring.
11. The catalyst compound of any of paragraphs 1 to 3 and 6 to 10, wherein A¹QA^{1′} forms a substituted or unsubstituted pyridyl ring.
12. The catalyst compound of paragraph 1 to 3 and 6 to 11, wherein L′ is a substituted or unsubstituted pyridyl ring.
13. The catalyst compound of paragraph 5, wherein E and E* are O, each G is S or NR²⁴, each R²⁴ is selected from C₁-C₂₀ alkyl, and each R⁴⁴ is selected from hydrogen or C₁-C₂₀ alkyl.
14. The catalyst compound of paragraph 13, wherein each G is NR²⁴, each R²⁴ is methyl, ethyl, or propyl, and each R⁴⁴ is hydrogen.
15. The catalyst compound of paragraph 13, wherein each G is S and each R⁴⁴ is hydrogen.
16. The catalyst compound of paragraphs 1 to 5, wherein R¹ and R⁵ (if present) is independently all isomers of methyl, ethyl, propyl, butyl, pentyl, hexyl, heptyl, octyl, nonyl, decyl, undecyl, docecyl, phenyl, substituted phenyl, carbazolyl, substituted carbazolyl, indolyl, substituted indolyl, pyrrolyl, substituted pyrrolyl, naphthyl, substituted naphthyl, anthracenyl, substituted anthracenyl, fluorenyl, substituted fluorenyl, cyclohexyl, cyclooctyl, cyclododecyl, adamantanyl, and substituted adamantanyl.
17. The catalyst compound of paragraph 1, wherein the catalyst compound comprises one or more of the following catalyst compounds:

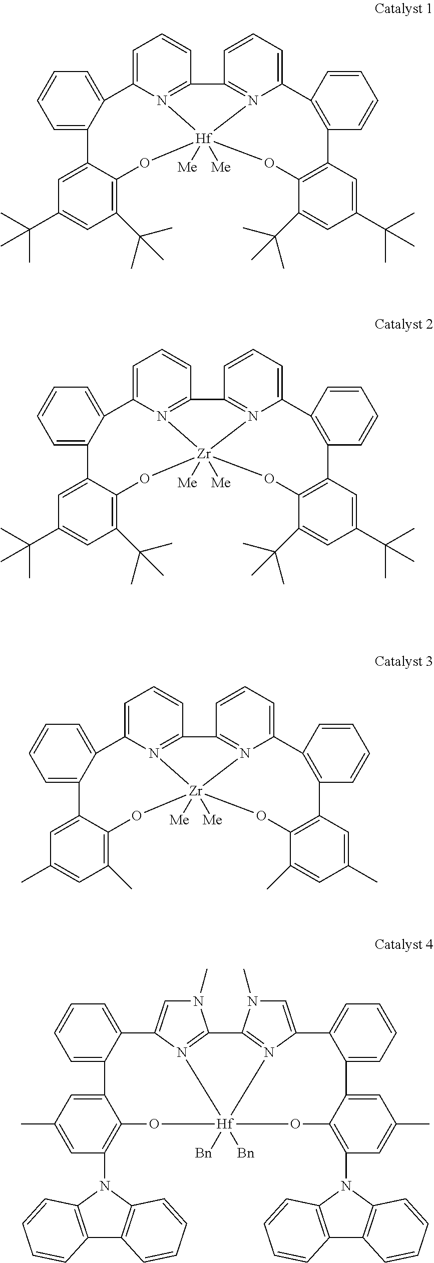

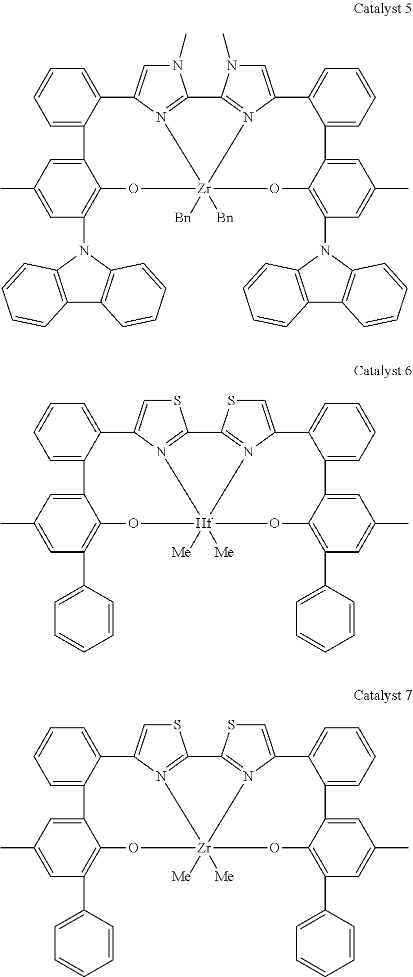

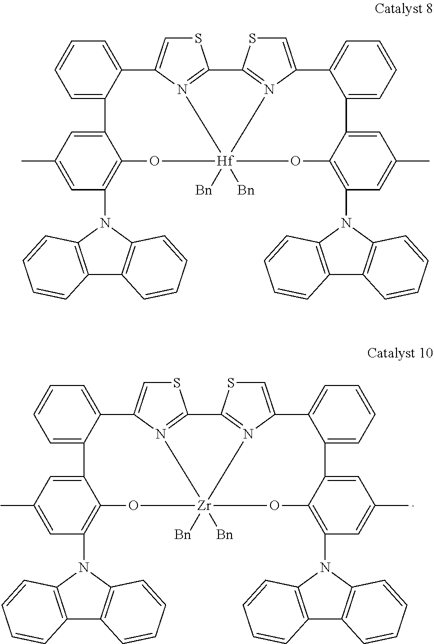

18. A catalyst system comprising activator and the catalyst compound of any of paragraphs 1 to 17.
19. The catalyst system of paragraph 18 wherein the activator comprises alumoxane and or a non-coordinating anion activator.
20. The catalyst system of paragraph 18 wherein activator is represented by the formula:

(Z)_{d}⁺(A^{d-})

wherein A^{d-} is a non-coordinating anion having the charge d−; d is an integer from 1 to 3, and (Z)_{d}⁺ is represented by the formula:

[R^{1′}R^{2′}R^{3′}EH]_{d}⁺

wherein E is nitrogen or phosphorous; d is 1, 2 or 3; R^{1′}, R^{2′}, and R^{3′} are independently hydrogen or a C₁ to C₅₀ hydrocarbyl group optionally substituted with one or more alkoxy groups, silyl groups, a halogen atoms, or halogen containing groups, wherein R^{1′}, R^{2′}, and R^{3′} together comprise 15 or more carbon atoms.
21. The catalyst system of paragraph 18, wherein the activator is one or more of methylalumoxane,
dioctadecylmethylammonium tetrakis(pentafluorophenyl)borate,
dioctadecylmethylammonium tetrakis(perfluoronaphthyl)borate,
N,N-dimethylanilinium tetrakis(pentafluorophenyl)borate, and
N,N-dimethylanilinium tetrakis(perfluoronaphthyl)borate.
   22. The catalyst system of any of paragraphs 18 to 21, further comprising support.
   23. A process to polymerize olefins comprising contacting one or more olefins with a catalyst system of any of paragraphs 18 to 22.
   24. The process of paragraph 23 wherein the process occurs at a temperature of from about 0° C. to about 300° C., at a pressure in the range of from about 0.35 MPa to about 10 MPa, and at a time up to 300 minutes.
   25. The process of paragraph 23 or 24, further comprising obtaining polymer.
   26. The process of any of paragraphs 23 to 25 wherein the olefins comprise C₂ to C₄₀ olefins.

### EXAMPLES

### General Considerations for Synthesis

All reagents were purchased from commercial vendors (Aldrich) and used as received unless otherwise noted. Solvents were sparged with N₂ and dried over 3 Å molecular sieves. All chemical manipulations were performed in a nitrogen environment unless otherwise stated. Flash column chromatography was carried out with Sigma Aldrich silica gel 60 Å (70 Mesh-230 Mesh) using solvent systems specified. NMR spectra were recorded on a Bruker 400 and/or 500 NMR with chemical shifts referenced to residual solvent peaks. All anhydrous solvents were purchased from Fisher Chemical and were degassed and dried over molecular sieves prior to use. Deutrated solvents were purchased from Cambridge Isotope Laboratories and were degassed and dried over molecular sieves prior to use. ¹H NMR spectroscopic data were acquired at 250 MHz, 400 MHz, or 500 MHz using solutions prepared by dissolving approximately 10 mg of a sample in either C₆D₆, CD₂Cl₂, CDCl₃, toluene-ds, or other deuterated solvent. The chemical shifts (δ) presented are relative to the residual protium in the deuterated solvent at 7.16 ppm, 5.32 ppm, 7.26 ppm, and 2.09 ppm for C₆D₆, CD₂Cl₂, CDCl₃, toluene-d₈, respectively.

Reagents for catalysts 4-10 were sourced as follows: 2′-bromo-3,5-di-tert-butyl-2-(methoxymethoxy)-1,1′-biphenyl was prepared as described in US Patent Application Serial No. 2020/0255556. 1,1′-Dimethyl-1H,1′H-2,2′-biimidazole was prepared as described in [Org. Lett., 2018, 20, 12, 3613-3617]. 4,4′-Dibromo-2,2′-bithiazole was prepared as described in [Heterocycles, 2000, 52, 1, 349-364]. Tetrabenzylhafnium and tetrabenzylzirconium were prepared as described in [J. Organomet. Chem. 1972, 36(1), pp. 87-92]. 2-(methoxymethoxy)-5-methyl-1,1′-biphenyl was prepared as described in [Chem Bio Chem 2018, 19, 1771-1778]. 9-(3-bromo-2-(methoxymethoxy)-5-methylphenyl)-9H-carbazole was prepared as described in [US 2006/0052554].

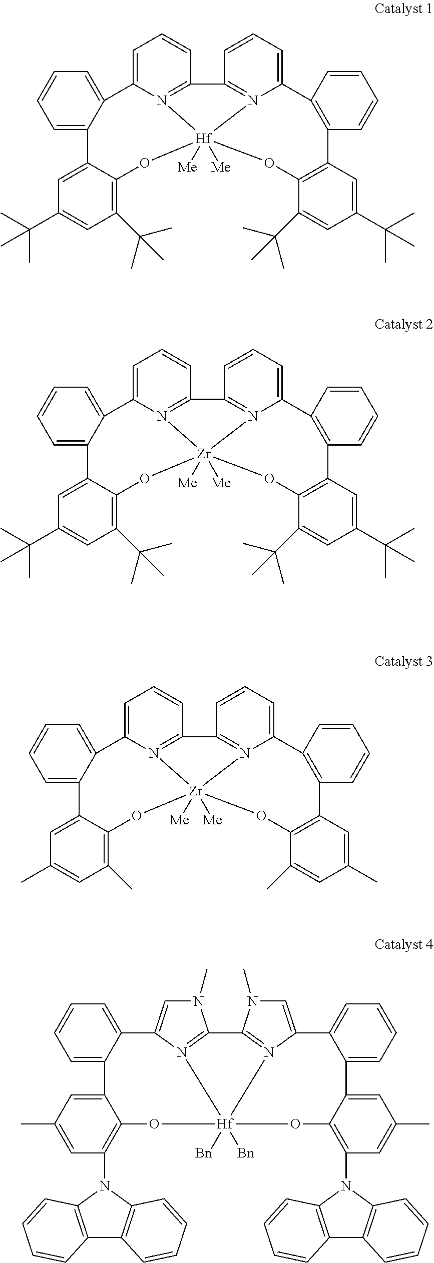

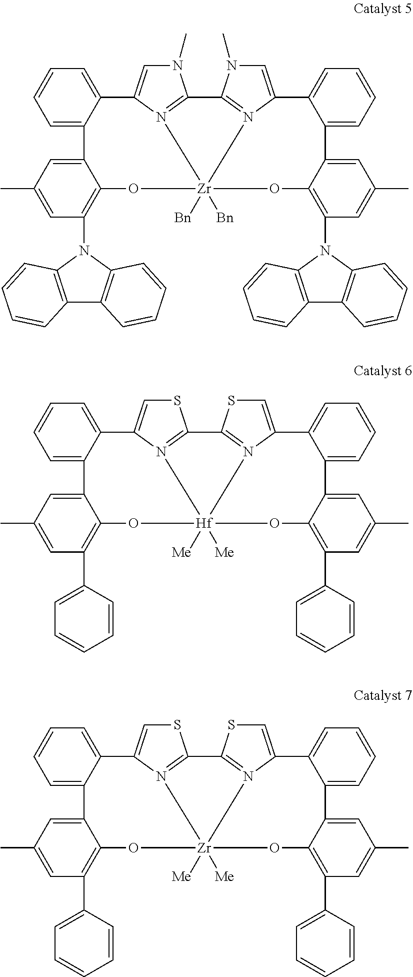

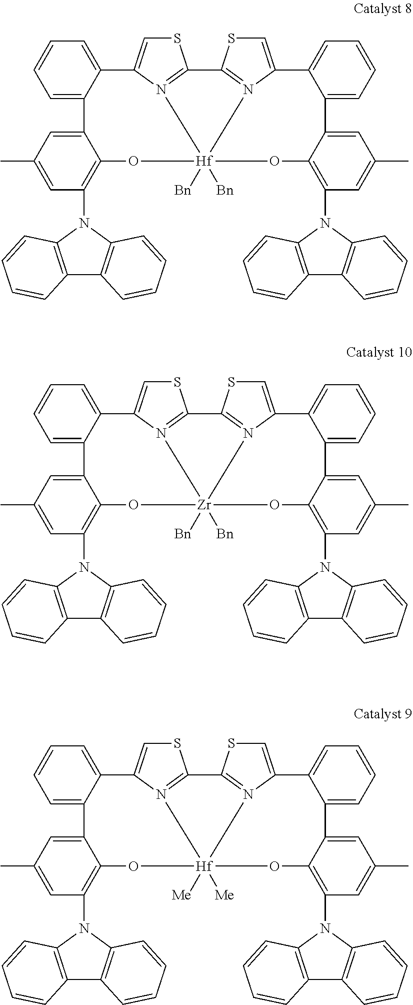

### Synthesis of Ligands

### 2′-lithium-3,5-di-tert-butyl-2-(methoxymethoxy)-1,1′-biphenyl

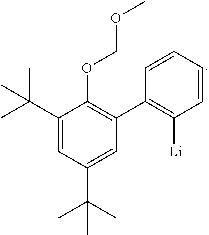

To a solution of 2′-bromo-3,5-di-tert-butyl-2-(methoxymethoxy)-1,1′-biphenyl (7.59 g, 19 mmol) in diethyl ether (50 mL), 1.7 mL of an 11 M solution of n-butyllithium in hexanes was added dropwise. The reaction mixture was stirred for 1 hour, then all volatiles were removed under vacuum. After washing with pentane, the product (4.56 g, 73%) was isolated as a white solid. ¹H NMR (400 MHz, DMSO-d₆) δ 7.46 (d, J=10.7 Hz, 3H), 7.41-7.30 (m, 2H), 7.11 (s, 1H), 4.38 (s, 2H), 3.17 (s, 3H), 1.44 (s, 9H), 1.30 (s, 9H).

### 2′,2′″-([2,2′-bipyridine]-6,6′-diyl)bis(3,5-di-tert-butyl-[1,1′-biphenyl]-2-ol)

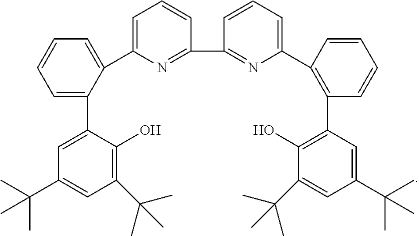 [SMILES: CC(C)(C)c1cc(-c2ccccc2-c2cccc(-c3cccc(-c4ccccc4-c4cc(C(C)(C)C)cc(C(C)(C)C)c4O)n3)n2)c(O)c(C(C)(C)C)c1]

To a solution of 2′-lithium-3,5-di-tert-butyl-2-(methoxymethoxy)-1,1′-biphenyl (1.48 g, 4.4 mmol) in THF (30 mL) was added ZnCl₂ (0.61 g, 4.4 mmol). The reaction mixture was stirred for 5 minutes, and 6,6′-dibromo-2,2′-bipyridine (0.70 g, 2.2 mmol) and Pd(P^{t}Bu₃)₂ (94 mg, 5%) were subsequently added. The resulting mixture was stirred for 2 days at 70° C., then filtered onto a silica gel pad which was then washed with dichloromethane. The solvent was then removed under vacuum. The product was isolated by recrystallization from toluene and collected by filtration. The solid was then dissolved in a 50:50 MeOH/THF solution (60 mL), and concentrated HCl (1 mL) was added. The resulting mixture was then refluxed for 2 hours. The reaction mixture was then allowed to cool to ambient temperature and quenched with a saturated NaHCO₃ aqueous solution. The product was extracted with dichloromethane (3×50 mL). The combined organic extracts were dried over MgSO₄ and evaporated to dryness. The product was purified by column chromatography and isolated as a mixture of two isomers as a white solid (0.96 g, 60%). ¹H NMR (CDCl₃, 400 MHz): δ 7.92-7.85 (m, 2H), 7.82-7.39 (m, 10H), 7.22 (d, J=7.7 Hz, 2H), 7.16 (dd, J=6.1, 2.5 Hz, 2H), 6.87 (dd, J=23.9, 2.4 Hz, 2H), 6.59 (s, 2H), 1.24 (d, J=6.6 Hz, 18H), 1.17 (s, 8H), 1.04 (s, 10H).

### 1-lithium-3,5-dimethyl-2-(methoxymethoxy)benzene

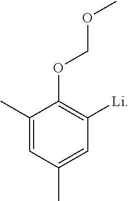

To a solution of 2,4-dimethyl phenol (4.0 g, 33.7 mmol) in THF (50 mL) was added NaH (0.96 g, 36 mmol). The reaction mixture was stirred for 1 hour. Chloromethyl methyl ether (MOMCl) (3.16 g, 39.3 mmol) was then added, and the reaction was stirred at room temperature overnight. The solvent was then removed under vacuum. The mixture was reslurried into hexane and all solids were removed by filtration on celite. The solids were washed by dichloromethane. The organic was evaporated to dryness. The crude product was then redissolved into 100 mL of diethyl ether. To the resulting mixture, 3.0 mL of an 11 M solution of n-butyllithium in hexanes was added dropwise. The reaction mixture was stirred for 30 minutes. After removal of most of the solvents under vacuum, the crude mixture was slurried into pentane for 10 minutes. The product was then isolated by filtration as a white solid (2.66 g, 46%). ¹H NMR (400 MHz, DMSO-d₆) δ 6.96 (s, 1H), 6.92 (s, 1H), 5.15 (d, J=1.5 Hz, 2H), 3.37 (d, J=1.4 Hz, 3H), 2.20 (s, 3H), 2.15 (s, 3H).

### 2′-lithium-3,5-dimethyl-2-(methoxymethoxy)-1,1′-biphenyl

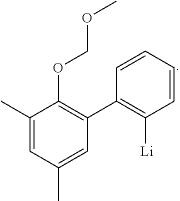

To a solution of 1-lithium-3,5-dimethyl-2-(methoxymethoxy)benzene (2.33 g, 14 mmol) in THF (30 mL) was added ZnCl₂ (1.84 g, 14 mmol). The reaction mixture was stirred for 5 minutes, and 1-bromo-2-chlorobenzene (4.98 g, 18 mmol) and Pd(P^{t}Bu₃)₂ (170 mg, 1.5%) were subsequently added. The resulting mixture was stirred at ambient temperature for 1 hour, then for 5 hours at 70° C. After removal of solvent by evaporation, the crude product was loaded onto silica gel and the product was purified by column chromatography (85:15 hexanes:dichloromethane). The product was redissolved in diethyl ether (20 mL). To the resulting mixture, 1.4 mL of an 11 M solution of n-butyllithium in hexanes was added dropwise. The reaction mixture was stirred for 30 minutes. After most of the solvent was removed under vacuum, the crude mixture was slurried into pentane for 10 minutes. The product was then isolated by filtration as a white solid (1.48 g, 40%). ¹H NMR (400 MHz, DMSO-d₆) δ 7.49-7.39 (m, 3H), 7.38-7.30 (m, 1H), 7.03 (s, 1H), 6.96 (s, 1H), 4.51 (s, 2H), 3.06 (s, 2H), 2.27 (s, 2H).

### 6,6′-bis(2′-(methoxymethoxy)-3′,5′-dimethyl-[1,1′-biphenyl]-2-yl)-2,2′-bipyridine

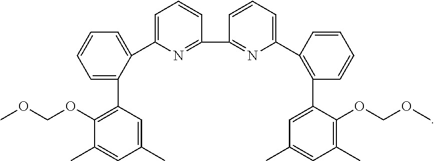

To a solution of 2′-lithium-3,5-dimethyl-2-(methoxymethoxy)-1,1′-biphenyl (1.18 g, 4.76 mmol) in THF (30 mL) was added ZnCl₂ (0.68 g, 5.0 mmol). The reaction mixture was stirred for 5 minutes and 6,6′-dibromo-2,2′-bipyridine (0.65 g, 2.07 mmol) and Pd(P^{t}Bu₃)₂ (52 mg, 3%) were subsequently added. The resulting mixture was stirred for 16 hours at 70° C. The reaction mixture was poured into an aqueous solution of EDTA which was adjusted to basic pH by addition of an aqueous solution of Na₂CO₃. After stirring for 1 hour, the organic phase was collected using a separatory funnel. The aqueous phase was washed with dichloromethane (50 mL) twice. The organic extracts were combined and dried with MgSO₄. The product (1.16 g, 76%) was then purified by silica gel column chromatography. After removal of solvent, the product was isolated as a white solid. ¹H NMR (CDCl₃, 400 MHz): δ 7.87-7.75 (m, 4H), 7.57-7.37 (m, 8H), 7.19 (d, J=7.7 Hz, 2H), 6.88 (s, 2H), 6.82 (s, 2H), 4.62 (d, J=9.8 Hz, 4H), 3.07 (d, J=1.5 Hz, 6H), 2.17 (d, J=5.4 Hz, 12H).

### 2′,2′″-([2,2′-bipyridine]-6,6′-diyl)bis(3,5-dimethyl-[1,1′-biphenyl]-2-ol)

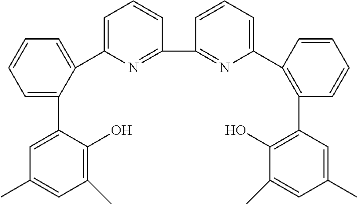

6,6′-bis(2′-(methoxymethoxy)-3′,5′-dimethyl-[1,1′-biphenyl]-2-yl)-2,2′-bipyridine was dissolved in a 50:50 MeOH:THF solution (60 mL), and concentrated HCl (0.5 mL) was added. The resulting mixture was then refluxed for 1 hour. The reaction mixture was then allowed to cool to ambient temperature and quenched with a saturated Na₂CO₃ aqueous solution. The product was extracted with dichloromethane (3×50 mL). The combined organic extracts were dried over MgSO₄ and evaporated to dryness. The crude product was purified by washing with methanol (2 mL). The pure product was isolated as two isomers as a white solid (1.0 g, 75%). ¹H NMR (CDCl₃, 400 MHz): δ 8.01 (d, J=17.3 Hz, 2H), 7.75 (t, J=7.8 Hz, 2H), 7.68-7.59 (m, 2H), 7.50 (dd, J=5.7, 3.4 Hz, 4H), 7.40-7.32 (m, 2H), 7.29 (d, J=7.7 Hz, 2H), 7.08 (br, 2H), 6.82 (s, 2H), 6.68 (s, 2H), 2.16 (s, 6H), 2.07 (d, J=39.2 Hz, 6H).

### 2-bromo-6-(1-methyl-1H-imidazol-2-yl)pyridine

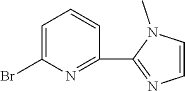

To a solution of 1-methyl-1H-imidazole (0.9 g, 11 mmol) in THF at −33° C. was added 1.0 mL of a 11 M solution of n-butyllithium in hexanes. After stirring for 15 minutes, ZnCl₂ (3.44 g, 25 mmol) was added and the reaction was stirred for an additional 1 hour. The reaction mixture was warmed to room temperature, and 2,6-dibromopyridine (2.60 g, 11 mmol) and Pd(PPh₃)₄ (127 mg, 0.01 mmol) were added. The reaction was stirred for 5 hours at 60° C. The mixture was cooled to room temperature, poured into a solution of Na₂EDTA·2H₂O (approx. 3 equiv.) in water, and the pH was adjusted to 8 with aqueous Na₂CO₃ solution (10%). The aqueous layer was extracted three times with dichloromethane. The combined organic extracts were washed with brine, dried with MgSO₄ and concentrated under vacuum. The crude product was then purified by silica gel chromatography. Impurities were removed by eluting with 10% acetone in hexane, and the product was collected by eluting with 33% acetone in hexane. The product was isolated as a white solid (2.10 g, 80.5%). ¹H NMR (CDCl₃, 400 MHz): δ 8.15 (d, J=7.9 Hz, 1H), 7.60 (t, J=7.9 Hz, 1H), 7.39 (d, J=7.8 Hz, 1H), 7.12 (s, 1H), 6.98 (d, J=1.0 Hz, 1H), 4.12 (s, 3H).

### 3,5-di-tert-butyl-2′-(6-(1-methyl-1H-imidazol-2-yl)pyridin-2-yl)-[1,1′-biphenyl]-2-ol

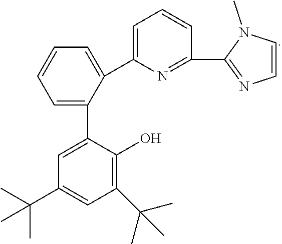 [SMILES: Cn1ccnc1-c1cccc(-c2ccccc2-c2cc(C(C)(C)C)cc(C(C)(C)C)c2O)n1]

To a solution of 2′-lithium-3,5-di-tert-butyl-2-(methoxymethoxy)-1,1′-biphenyl (1.40 g, 4 mmol) in THF (30 mL) was added ZnCl₂ (1.03 g, 8 mmol). The reaction mixture was stirred for 5 minutes and 2-bromo-6-(1-methyl-1H-imidazol-2-yl)pyridine (0.90 g, 4 mmol) and Pd(P^{t}Bu₃)₂ (62 mg, 2%) were subsequently added. The resulting mixture was stirred at ambient temperature for 15 hour at 70° C. The mixture was cooled to room temperature, poured into a solution of Na₂EDTA·2H₂O (approx. 3 equiv.) in water, and the pH was adjusted to 8 with an aqueous solution of Na₂CO₃ (10%). The aqueous layer was extracted three times with dichloromethane. The combined organic extracts were washed with brine, dried with MgSO₄ and concentrated in vacuo. The crude product was then purified by silica gel chromatography. After solvent removal, the product was dissolved in MeOH (30 mL) and concentrated HCl (0.5 mL) was added. The resulting mixture was then refluxed for 1 hour. The reaction mixture was then allowed to cool to ambient temperature and quenched with a saturated Na₂CO₃ aqueous solution. The product was extracted with dichloromethane (3×50 mL). The combined organic extracts were dried over MgSO₄ and evaporated to dryness. The crude product was purified by washing with methanol (2 mL). The pure product was isolated as a white solid (1.66 g, 100%). 1H NMR (CDCl₃, 400 MHz): δ 8.42 (d, J=7.9 Hz, 1H), 7.72-7.58 (m, 2H), 7.56-7.41 (m, 3H), 7.29 (d, J=4.2 Hz, 2H), 7.17-7.07 (m, 2H), 6.81 (s, 1H), 5.22 (br, 1H), 3.95 (s, 3H), 1.18 (s, 9H), 1.12 (s, 9H).

### 2′-([2,2′-bipyridin]-6-yl)-3,5-di-tert-butyl-[1,1′-biphenyl]-2-ol

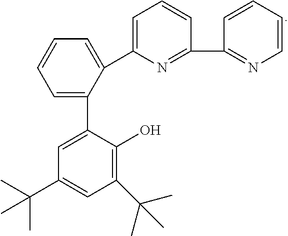 [SMILES: CC(C)(C)c1cc(-c2ccccc2-c2cccc(-c3ccccn3)n2)c(O)c(C(C)(C)C)c1]

To the solution of 2′-lithium-3,5-di-tert-butyl-2-(methoxymethoxy)-1,1′-biphenyl (0.78 g, 2.34 mmol) in THF (30 mL) was added ZnCl₂ (0.32 g, 2.34 mmol). The reaction mixture was stirred for 5 minutes and 6-bromo-2,2′-bipyridine (0.50 g, 2.13 mmol) and Pd(P^{t}Bu₃)₂ (54 mg, 3%) were subsequently added. The resulting mixture was stirred at ambient temperature for 15 hours at 70° C. The mixture was cooled to room temperature, poured into a solution of Na₂EDTA·2H₂O (approx. 3 equiv.) in water, and the pH was adjusted to 8 with an aqueous solution of Na₂CO₃ (10%). The aqueous layer was extracted three times with dichloromethane. The combined organic extracts were washed with brine, dried with MgSO₄ and concentrated under vacuum. The crude product was then purified by silica gel chromatography. After removal of solvent, the product was dissolved in MeOH (50 mL) and concentrated HCl (10 drops) was added. The resulting mixture was then refluxed for 2 hours. The reaction mixture was then allowed to cool to ambient temperature and quenched with a saturated Na₂CO₃ aqueous solution. The product was extracted with dichloromethane (3×50 mL). The combined organic extracts were dried over MgSO₄ and evaporated to dryness. The crude product was purified by washing with methanol (2 mL). The pure product was isolated as a white solid (0.77 g, 80.1%). ¹H NMR (CDCl₃, 400 MHz): δ 8.63 (d, J=4.8 Hz, 1H), 8.19 (d, J=7.9 Hz, 1H), 8.02 (d, J=8.0 Hz, 1H), 7.81-7.66 (m, 3H), 7.59-7.42 (m, 3H), 7.33-7.24 (m, 1H), 7.22 (d, J=7.7 Hz, 1H), 7.15 (d, J=2.4 Hz, 1H), 6.88 (d, J=2.4 Hz, 1H), 6.49 (br, 1H), 1.19 (s, 9H), 1.18 (s, 9H).

### Synthesis of Catalysts (Also Referred to as Complexes, or Compounds)

### Dichlorohafnium [2′,2′″-([2,2′-bipyridine]-6,6′-diyl)bis(3,5-di-tert-butyl-[1,1′-biphenyl]-2-olate)]

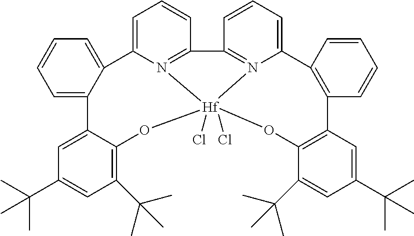

2′,2′″-([2,2′-bipyridine]-6,6′-diyl)bis(3,5-di-tert-butyl-[1,1′-biphenyl]-2-ol) (260 mg, 0.36 mmol) was combined with Hf(NMe₂)₂Cl₂·DME (155 mmg, 0.36 mmol) in 20 mL of toluene. The mixture was stirred at 90° C. for 2 days. After removal of toluene by evaporation, the mixture was stirred in diethyl ether (5 mL) for 2 minutes. The product (340 mg, 97%) was isolated as a solid by filtration. ¹H NMR (CD₂Cl₂, 400 MHz): δ 8.03-7.95 (m, 4H), 7.60-7.43 (m, 8H), 7.29 (d, J=8.1 Hz, 2H), 7.08 (d, J=2.8 Hz, 2H), 6.71 (d, J=2.7 Hz, 2H), 1.17 (s, 18H), 1.09 (s, 18H).

### Dichlorozirconium [2′,2′″-([2,2′-bipyridine]-6,6′-diyl)bis(3,5-di-tert-butyl-[1,1′-biphenyl]-2-olate)]

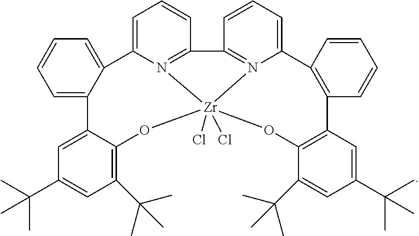

2′,2′″-([2,2′-bipyridine]-6,6′-diyl)bis(3,5-di-tert-butyl-[1,1′-biphenyl]-2-ol) (50 mg, 0.07 mmol) was combined with Zr(NMe₂)₂Cl₂·DME (24.7 mmg, 0.07 mmol) in 5 mL of toluene. The mixture was stirred at 90° C. for 3 days. After removal of toluene by evaporation, the mixture was stirred in diethyl ether (2 mL) for 2 minutes. The product (64 mg, 99%) was isolated by filtration as a mixture of isomers. ¹H NMR (CD₂Cl₂, 400 MHz): δ 9.61 (s, 2H), 8.00-7.79 (m, 4H), 7.61-7.37 (m, 6H), 7.36-7.30 (m, 2H), 7.07-6.97 (m, 2H), 6.87-6.71 (m, 2H), 1.23-1.16 (m, 18H), 1.13-1.04 (m, 18H).

### Dimethylhafnium [2′,2′″-([2,2′-bipyridine]-6,6′-diyl)bis(3,5-di-tert-butyl-[1,1′-biphenyl]-2-olate)] (Catalyst 1)

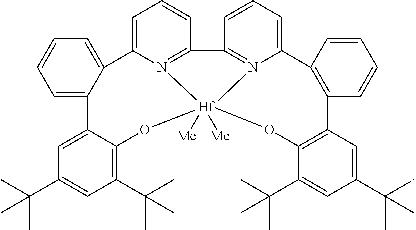

To a solution of dichlorohafnium [2′,2′″-([2,2′-bipyridine]-6,6′-diyl)bis(3,5-di-tert-butyl-[1,1′-biphenyl]-2-olate)] (55 mg, 0.06 mmol) and potassium fluoride (29 mg, 0.5 mmol) in toluene (4 mL) was added a solution of trimethylaluminum (9.0 mg, 0.1 mmol) in toluene (4 mL). The reaction was stirred at 80° C. for 7 days. All solids were then filtered off. After removal of solvent by evaporation, the product was washed with a 50:50 diethyl ether/pentane solution. Yield: 25 mg, 47%. ¹H NMR (CD₂Cl₂, 400 MHz): δ 7.85 (d, J=6.0 Hz, 4H), 7.53 (t, J=7.3 Hz, 2H), 7.46-7.30 (m, 6H), 7.23 (dd, J=5.6, 2.5 Hz, 2H), 7.11 (d, J=2.7 Hz, 2H), 6.86 (d, J=2.6 Hz, 2H), 1.22 (s, 18H), 1.14 (s, 18H), −0.93 (s, 6H).

### Dimethylzirconium [2′,2′″-([2,2′-bipyridine]-6,6′-diyl)bis(3,5-di-tert-butyl-[1,1′-biphenyl]-2-olate)] (Catalyst 2)

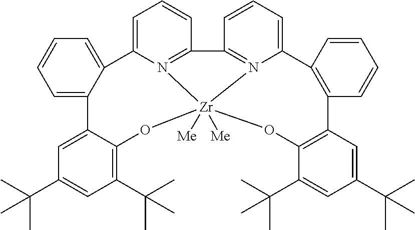

To a solution of dichlorozirconium [2′,2′″-([2,2′-bipyridine]-6,6′-diyl)bis(3,5-di-tert-butyl-[1,1′-biphenyl]-2-olate)] (64 mg, 0.07 mmol) and potassium fluoride (74 mg, 1 mmol) in toluene (4 mL) was added a solution of trimethylaluminum (23 mg, 0.3 mmol) in toluene (4 mL). The reaction was stirred at 80° C. for 5 days. All solids were then filtered off. After removal of solvent by evaporation, the product was washed with pentane and isolated as a mixture of two isomers. Yield: 25 mg, 41%. ¹H NMR (CD₂Cl₂, 400 MHz): δ 7.97-7.75 (m, 4H), 7.61-7.03 (m, 12H), 6.93 (td, J=25.1, 24.5, 2.5 Hz, 2H), 1.28-1.20 (m, 18H), 1.19-1.15 (m, 18H), −0.63-−0.87 (m, 6H).

### Dimethylzirconium [2′,2′″-([2,2′-bipyridine]-6,6′-diyl)bis(3,5-dimethyl-[1,1′-biphenyl]-2-olate)] (Catalyst 3)

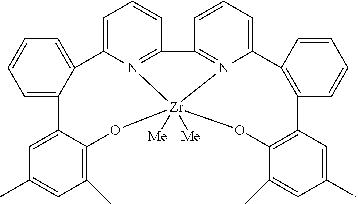

To a toluene (3 mL) solution of ZrCl₄ (42 mg, 0.18 mmol), a solution of MeMgI in diethyl ether (0.24 mL, 0.72 mmol) was added dropwise under −20° C. A solution of 2′,2′″-([2,2′-bipyridine]-6,6′-diyl)bis(3,5-dimethyl-[1,1′-biphenyl]-2-ol) (100 mg, 0.18 mmol) in toluene (4 mL) was subsequently added under −20° C. The reaction mixture was then stirred overnight at room temperature. Toluene was then removed under vacuum. The crude product was slurried into in pentane for 10 minutes. After removal of pentane, the product was isolated as a solid.

### Dibenzylhafnium[2′,2′″-(1,1′-dimethyl-1H,1′H-[2,2′-biimidazole]-4,4′-diyl)bis(3-(9H-carbazol-9-yl)-5-methyl-[1,1′-biphenyl]-2-olate)] (Catalyst 4)

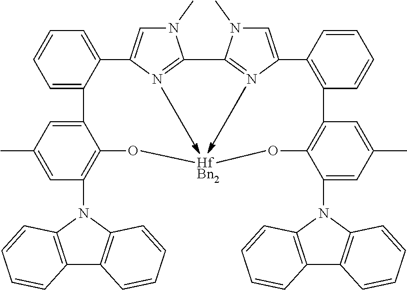

To a solution of 57 mg (0.105 mmol) of tetrabenzylhafnium in 30 ml of toluene, 90 mg (0.105 mmol) of 2′,2′″-(1,1′-dimethyl-1H,1′H-[2,2′-biimidazole]-4,4′-diyl)bis(3-(9H-carbazol-9-yl)-5-methyl-[1,1′-biphenyl]-2-ol) was added in small portions at room temperature. The resulting mixture was stirred overnight and evaporated to near dryness. The residue was triturated with 5 ml of n-hexane, the solids obtained were filtered off on a glass frit (G4), washed with small amount of n-hexane, and then dried in vacuum. Yield 87 mg (68%) of a light-yellow solid. Anal. Calc. for C₇₂H₅₆HfN₆O₂: C, 71.13; H, 4.64; N, 6.91. Found: C 71.45; H, 4.81; N 6.80. ¹H NMR (CD₂Cl₂, 400 MHz, very low solubility): δ 8.25 (d, J=7.0 Hz, 2H), 8.13 (d, J=7.3 Hz, 2H), 7.61 (d, J=8.0 Hz, 2H), 7.10-7.36 (m, 14H), 6.60-6.90 (m, 14H), 6.35 (d, J=6.3 Hz, 2H), 6.10-6.16 (m, 4H), 2.51 (br.s, 6H), 2.20 (s, 6H), 0.43 (d, J=9.7 Hz, 2H, AB), 0.04 (d, J=9.9 Hz, 2H, AB).

### Dibenzylzirconium[2′,2′″-(1,1′-dimethyl-1H,1′H-[2,2′-biimidazole]-4,4′-diyl)bis(3-(9H-carbazol-9-yl)-5-methyl-[1,1′-biphenyl]-2-olate)] (Catalyst 5)

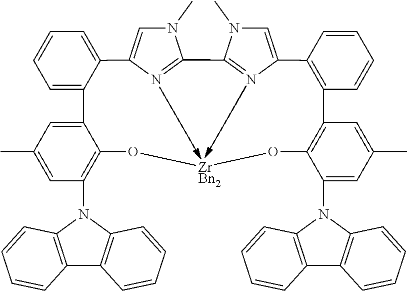

To a solution of 120 mg (0.263 mmol) of tetrabenzylzirconium in 60 ml of toluene, 225 mg (0.263 mmol) of 2′,2′″-(1,1′-dimethyl-1H,1′H-[2,2′-biimidazole]-4,4′-diyl)bis(3-(9H-carbazol-9-yl)-5-methyl-[1,1′-biphen-yl]-2-ol) was added in small portions at room temperature. The resulting mixture was stirred overnight and then evaporated to near dryness. The residue was triturated with 15 ml of n-hexane, the solids obtained were filtered off on a glass frit (G4), washed with small amount of n-hexane, and then dried in vacuum. Yield 139 mg (47%) of a yellow solid. Anal. Calc. for C₇₂H₅₆ZrN₆O₂: C, 76.63; H, 5.00; N, 7.45. Found: C 76.82; H, 5.23; N 7.24. ¹H NMR (CD₂Cl₂, 400 MHz, very low solubility): (8.12 (d, J=7.6 Hz, 2H), 8.03 (d, J=7.8 Hz, 2H), 6.99-7.35 (m, 22H), 6.78-6.80 (m, 4H), 6.68 (t, J=8.1 Hz, 2H), 6.33 (dd, J=7.4, 1.0 Hz, 2H), 6.11-6.16 (m, 4H), 6.02 (t, J=7.3 Hz, 2H), 4.14 (s, 6H), 2.24 (s, 6H), −0.15 (d, J=10.3 Hz, 2H, AB), −0.42 (d, J=10.7 Hz, 2H, AB).

### Dimethylhafnium[2,2′″-([2,2′-bithiazole]-4,4′-diyl)bis(5′-methyl-[1,1′:3′,1″-terphenyl]-2′-olate)] (Catalyst 6)

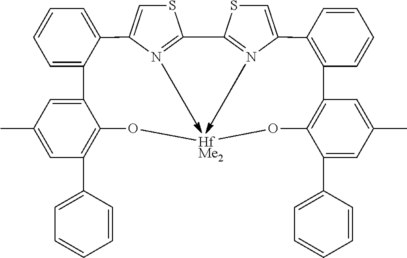

To a suspension of 94 mg (0.292 mmol) of hafnium tetrachloride in 60 ml of dry toluene, 422 ul (1.22 mmol) of 2.9 M MeMgBr in diethyl ether was added in one portion via syringe at −40° C. To the resulting suspension, 200 mg (0.292 mmol) of 2,2′″-([2,2′-bithiazole]-4,4′-diyl)bis(5′-methyl-[1,1′:3′,1″-terphenyl]-2′-ol) was added in one portion. The reaction mixture was stirred overnight at room temperature and then evaporated to near dryness. The solids obtained were extracted with 2×30 ml of hot toluene, and the combined organic extract was filtered through a thin pad of Celite 503. Next, the filtrate was evaporated to dryness. The residue was triturated with 5 ml of n-hexane, the obtained precipitate was filtered off, washed two times with 5 ml of n-hexane, and then dried in vacuo. Yield 175 mg (67%) of an orange solid. Anal. Calc. for C₄₆H₃₆HfN₂O₂S₂: C, 61.98; H, 4.07; N, 3.14. Found: C 62.22; H, 4.35; N 2.96. ¹H NMR (C₆D₆, 400 MHz, low solubility): δ 7.40-7.45 (m, 6H), 7.27 (dt, J=7.5, 1.5 Hz, 2H), 7.21 (dt, J=7.5, 1.4 Hz, 2H), 7.08-7.16 (m, 6H), 6.93 (d, J=2.3 Hz, 2H), 6.88 (dd, J=7.3, 1.4 Hz, 2H), 6.78 (d, J=2.3 Hz, 2H), 6.09 (s, 2H), 2.13 (s, 6H), −0.37 (s, 6H).

### Dimethylzirconium[2,2′″-([2,2′-bithiazole]-4,4′-diyl)bis(5′-methyl-[1,1′:3′,1″-terphenyl]-2′-olate)] (Catalyst 7)

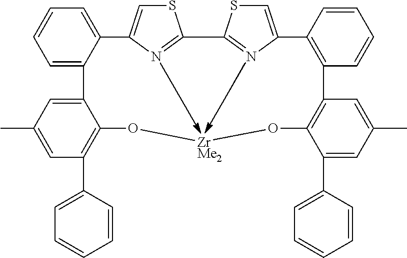

To a suspension of 85 mg (0.365 mmol) of zirconium tetrachloride in 70 ml of dry toluene, 530 ul (1.53 mmol) of 2.9 M MeMgBr in diethyl ether was added in one portion via a syringe at −40° C. To the resulting suspension, 250 mg (0.365 mmol) of 2,2′″-([2,2′-bithiazole]-4,4′-diyl)bis(5′-methyl-[1,1′:3′,1″-terphenyl]-2′-ol) was added in one portion. The reaction mixture was stirred overnight at room temperature and then evaporated to near dryness. The solids obtained were extracted with 3×30 ml of hot toluene, and the combined organic extract was filtered through a thin pad of Celite 503. Next, the filtrate was evaporated to dryness. The residue was triturated with 5 ml of n-hexane, the obtained precipitate was filtered off, washed two times with 5 ml of n-hexane, and then dried in vacuo. Yield 120 mg (41%) of an orange solid. Anal. Calc. for C₄₆H₃₆ZrN₂O₂S₂: C, 68.71; H, 4.51; N, 3.48. Found: C 68.95; H, 4.74; N 3.27. ¹H NMR (C₆D₆, 400 MHz, low solubility): δ 7.40-7.46 (m, 6H), 7.26 (dt, J=7.6, 1.5 Hz, 2H), 7.18 (dt, J=7.5, 1.3 Hz, 2H), 7.07-7.16 (m, 6H), 6.94 (d, J=2.4 Hz, 2H), 6.80-6.83 (m, 4H), 6.14 (s, 2H), 2.13 (s, 6H), −0.18 (s, 6H). ¹³C NMR (CD₂Cl₂, 100 MHz, low solubility): δ 157.2, 157.0, 156.0, 143.6, 140.9, 133.2, 132.4, 132.1, 131.1, 131.05, 131.01, 130.4, 129.9, 129.87, 128.2, 127.3, 127.0, 126.4, 119.8, 40.2, 20.7.

### Dibenzylhafnium[2′,2′″-([2,2′-bithiazole]-4,4′-diyl)bis(3-(9H-carbazol-9-yl)-5-methyl-[1,1′-biphenyl]-2-olate)] (Catalyst 8)

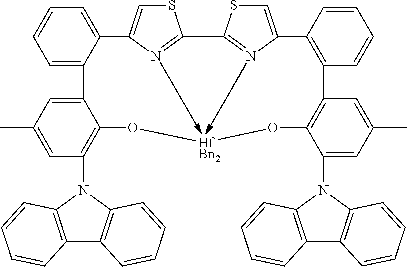

To a solution of 200 mg (0.370 mmol) of tetrabenzylhafnium in 30 ml of toluene, 320 mg (0.370 mmol) of 2′,2′″-([2,2′-bithiazole]-4,4′-diyl)bis(3-(9H-carbazol-9-yl)-5-methyl-[1,1′-biphenyl]-2-ol was added in small portions at room temperature. The resulting mixture was stirred overnight, and the crystals obtained were filtered off on a glass frit (G4), washed with small amount of n-hexane, and then dried in vacuum. Yield 234 mg (52%) of a red-brown solid. Anal. Calc. for C₇₀H₅₀HfN₄O₂S₂: C, 68.81; H, 4.13; N, 4.59. Found: C 69.12; H, 4.24; N 4.71. ¹H NMR (CD₂Cl₂, 400 MHz): (8.10 (t, J=7.9 Hz, 4H), 7.33 (dt, J=7.8, 1.1 Hz, 2H), 7.14-7.26 (m, 8H), 7.13 (s, 2H), 7.07 (t, J=7.1 Hz, 2H), 7.03 (dt, J=7.5, 1.5 Hz, 2H), 6.94 (d, J=2.5 Hz, 2H), 6.81-6.86 (m, 4H), 6.38 (d, J=7.6 Hz, 2H), 6.32 (t, J=7.6 Hz, 4H), 6.23 (d, J=8.1 Hz, 2H), 6.19 (t, J=7.3 Hz, 2H), 5.48 (d, J=7.1 Hz, 4H), 2.22 (s, 6H), −0.19 (d, J=11.9 Hz, 2H, AB), −0.59 (d, J=11.9 Hz, 2H, AB). ¹³C NMR (CD₂Cl₂, 100 MHz): (158.5, 157.1, 156.4, 148.2, 143.2, 142.3, 142.2, 134.1, 133.2, 132.3, 131.4, 130.7, 130.64, 130.69, 130.2, 128.5, 128.0, 127.6, 127.1, 126.6, 126.5, 125.1, 123.9, 123.3, 120.8, 120.5, 120.2, 119.9, 119.8, 119.2, 111.8, 109.2, 75.6, 20.5.

### Dimethylhafnium[2′,2′″-([2,2′-bithiazole]-4,4′-diyl)bis(3-(9H-carbazol-9-yl)-5-methyl-[1,1′-biphenyl]-2-olate)] (Catalyst 9)

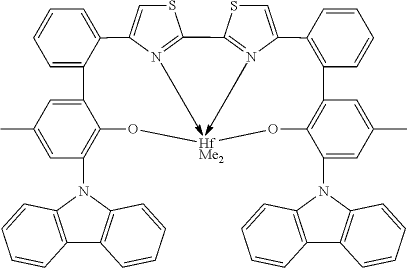

To a suspension of 75 mg (0.231 mmol) of hafnium tetrachloride in 60 ml of dry toluene, 330 ul (1.00 mmol) of 2.9 M MeMgBr in diethyl ether was added in one portion via syringe at −40° C. To the resulting suspension 200 mg (0.231 mmol) of 2′,2′″-([2,2′-bithiazole]-4,4′-diyl)bis(3-(9H-carbazol-9-yl)-5-methyl-[1,1′-biphenyl]-2-ol was added in one portion. The reaction mixture was stirred overnight at room temperature and then evaporated to near dryness. The solids obtained were extracted with 3×30 ml of hot toluene, and the combined organic extract was filtered through a thin pad of Celite 503. Next, the filtrate was evaporated to dryness. The residue was triturated with 5 ml of n-hexane, the obtained precipitate was filtered off, washed two times with 5 ml of n-hexane, and then dried in vacuo. Yield 68 mg (27%) of a yellow solid. Anal. Calc. for C₅₈H₄₂HfN₄O₂S₂: C, 65.13; H, 3.96; N, 5.24. Found: C 65.37; H, 4.19; N 5.01. ¹H NMR (CD₂Cl₂, 400 MHz): δ 8.15 (d, J=7.7 Hz, 2H), 8.10 (d, J=7.3 Hz, 2H), 7.39 (dt, J=7.6, 1.2 Hz, 2H), 7.36 (dt, J=7.6, 1.3 Hz, 2H), 7.27 (dt, J=7.2, 1.2 Hz, 2H), 7.20 (dt, J=7.3, 1.2 Hz, 2H), 7.10 (d, J=8.1 Hz, 2H), 7.01 (dt, J=7.2, 1.0 Hz, 2H), 6.96 (dt, J=7.1, 1.2 Hz, 2H), 6.86 (d, J=2.5 Hz, 2H), 6.85 (s, 2H), 6.80 (d, J=2.5 Hz, 2H), 6.68 (d, J=7.5 Hz, 2H), 6.26 (d, J=7.6 Hz, 2H), 2.19 (s, 6H), −2.19 (s, 6H). ¹³C NMR (CD₂Cl₂, 100 MHz): δ 157.9, 156.2, 155.9, 142.6, 142.2, 142.0, 133.6, 132.9, 132.3, 130.4, 130.3, 130.1, 130.0, 127.7, 127.3, 126.5, 126.3, 125.7, 123.2, 122.7, 120.5, 120.1, 120.0, 119.4, 119.0, 111.5, 108.5, 47.0, 20.5.

### Dibenzylzirconium[2′,2′″-([2,2′-bithiazole]-4,4′-diyl)bis(3-(9H-carbazol-9-yl)-5-methyl-[1,1′-biphenyl]-2-olate)] (Catalyst 10)

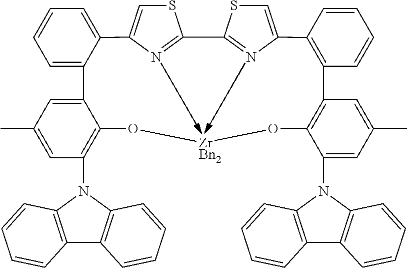

To a solution of 85 mg (0.185 mmol) of tetrabenzylzirconium in 10 ml of toluene, 160 mg (0.185 mmol) of 2′,2′″-([2,2′-bithiazole]-4,4′-diyl)bis(3-(9H-carbazol-9-yl)-5-methyl-[1,1′-biphenyl]-2-ol was added in small portions at room temperature. The resulting mixture was stirred overnight, and the powder precipitated was filtered off on a glass frit (G4), washed with small amount of n-hexane, and then dried in vacuum. Yield 118 mg (56%) of a yellow-brown solid. Anal. Calc. for C₇₀H₅₀ZrN₄O₂S₂: C, 74.11; H, 4.44; N, 4.94. Found: C 74.42; H, 4.68; N 4.79. ¹H NMR (C₆D₆, 400 MHz): δ 8.08 (d, J=7.5 Hz, 2H), 7.96 (d, J=7.5 Hz, 2H), 7.49 (d, J=8.2 Hz, 2H), 7.22-7.26 (m, 4H), 7.01-7.09 (m, 4H), 6.90-6.95 (m, 4H), 6.84 (dt, J=7.5, 1.3 Hz, 2H), 6.70-6.74 (m, 4H), 6.67 (dt, J=7.0, 1.2 Hz, 2H), 6.55-6.60 (m, 4H), 6.40 (dd, J=7.5, 1.1 Hz, 2H), 6.32 (d, J=8.0 Hz, 2H), 6.17 (s, 2H), 6.02 (d, J=7.0 Hz, 4H), 1.99 (s, 6H), 0.54 (d, J=10.9 Hz, 2H, AB), 0.20 (d, J=10.9 Hz, 2H, AB).

### High Throughput Polymerization

Solvents, polymerization grade toluene and/or isohexanes are supplied by ExxonMobil Chemical Company and are purified by passing through a series of columns: two 500 cm³ Oxyclear cylinders in series from Labclear (Oakland, California), followed by two 500 cm³ columns in series packed with dried 3 Å molecular sieves (8 mesh-12 mesh; Aldrich Chemical Company), and two 500 cm³ columns in series packed with dried 5 Å molecular sieves (8 mesh-12 mesh; Aldrich Chemical Company).

1-Octene (98%) (Aldrich Chemical Company) is dried by stirring over Na—K alloy overnight followed by filtration through basic alumina (Aldrich Chemical Company, Brockman Basic 1). Tri-(n-octyl)aluminum (TNOA) are purchased from either Aldrich Chemical Company or Akzo Nobel and are used as received.

Polymerization grade ethylene is further purified by passing it through a series of columns: 500 cm³ Oxyclear cylinder from Labclear (Oakland, California) followed by a 500 cm³ column packed with dried 3 Å molecular sieves (8 mesh-12 mesh; Aldrich Chemical Company), and a 500 cm³ column packed with dried 5 Å molecular sieves (8 mesh-12 mesh; Aldrich Chemical Company).

Polymerization grade propylene was purified by passage through a series of columns: 2,250 cc OXICLEAR cylinder from Labclear followed by a 2,250 cc column packed with 3 Å molecular sieves (8-12 mesh; Aldrich Chemical Company), then two 500 cc columns in series packed with 5 Å molecular sieves (8-12 mesh; Aldrich Chemical Company), then a 500 cc column packed with SELEXSORB CD (BASF), and finally a 500 cc column packed with SELEXSORB COS (BASF).

N,N-dimethylanilinium tetrakis(pentafluorophenyl)borate, also referred to as Activator 1, was purchased from Albemarle Corporation. Trityl tetrakis(pentafluorophenyl)borate, also referred to as Activator 2, was purchased from AGC Chemicals. All complexes and the activators are added to the reactor as dilute solutions in toluene. The concentrations of the solutions of activator, scavenger, and complexes that are added to the reactor are chosen so that between 40 microliters-200 microliters of the solution are added to the reactor to ensure accurate delivery.

Reactor Description and Preparation. Polymerizations are conducted in an inert atmosphere (N₂) drybox using autoclaves equipped with an external heater for temperature control, glass inserts (internal volume of reactor=23.5 mL for C₂ and C₂/C₈ runs; 22.5 mL for C₃ runs), septum inlets, regulated supply of nitrogen, ethylene and propylene (if used), and equipped with disposable polyether ether ketone mechanical stirrers (800 RPM). The autoclaves are prepared by purging with dry nitrogen at 110° C. or 115° C. for 5 hours and then at 25° C. for 5 hours.

### Ethylene Polymerization (PE) or Ethylene/1-Octene Copolymerization (EO)

The reactor is prepared as described above, and then is purged with ethylene. Toluene (solvent unless stated otherwise), optional 1-octene (0.1 mL when used), and optional methylalumoxane (if used) are added via syringe at room temperature and atmospheric pressure. The reactor is then brought to process temperature (typically 80° C.) and charged with ethylene to process pressure (typically 75 psig=618.5 kPa or 200 psig=1480.3 kPa) while stirring at 800 RPM. An optional scavenger solution (e.g., TNOA in isohexane) is then added via syringe to the reactor at process conditions. A non-coordinating activator (e.g., Activator 1 or 2) solution (in toluene) is added via syringe to the reactor at process conditions, followed by a pre-catalyst (i.e., complex or catalyst) solution (in toluene) via syringe to the reactor at process conditions. Ethylene is allowed to enter (through the use of computer controlled solenoid valves) the autoclaves during polymerization to maintain reactor gauge pressure (+/−2 psi). Reactor temperature is monitored and typically maintained within +/−1° C. Polymerizations are halted by addition of approximately 50 psi O₂/Ar (5 mol % 02) gas mixture (over the reactor pressure) to the autoclaves for approximately 30 seconds. The polymerizations are quenched after a predetermined cumulative amount of ethylene is added (20 psid of ethylene uptake for runs using 75 psig ethylene, or 15 psid of ethylene uptake for runs using 200 psig of ethylene, or for a maximum of 30 minutes polymerization time. The reactors are cooled and vented. The polymer is isolated after the solvent is removed under reduced pressure. Yields to be reported include total weight of polymer and residual catalyst. Catalyst activity is reported as grams of polymer per mmol transition metal compound per hour of reaction time (g/mmol/hr).

### Propylene Polymerizations (PP):

The reactor was prepared as described above, heated to 40° C., and then purged with propylene gas at atmospheric pressure. For MAO-activated runs, toluene, MAO, propylene (1.0 ml unless otherwise listed in the tables) and comonomer (if used) were added via syringe. The reactor was then heated to process temperature (typically 70° C. or 100° C. unless otherwise mentioned) while stirring at 800 RPM. The pre-catalyst solution was added via syringe with the reactor at process conditions. The reactor temperature was monitored and typically maintained within +/−1° C. Polymerizations were halted by addition of approximately 50 psi O₂/Ar (5 mole % 02) or an air gas mixture to the autoclaves for approximately 30 seconds. The polymerizations were quenched based on a predetermined pressure loss of approximately 8 psi unless specified differently (max quench value in psi) or for a maximum of 30 minutes polymerization time unless specified differently. The reactors were then cooled and vented. The polymers were isolated after solvent removal in vacuo. Actual quench times are reported. Quench times less than maximum reaction times indicate the reaction quenched with uptake. Yields reported include total weight of polymer and residual catalyst. Catalyst activity is reported as grams of polymer per mmol metallocene complex per hour of reaction time (gP/mmol cat·hr). Propylene homopolymerization examples including characterization are summarized in Tables 3 and 4.

### Polymer Characterization

For analytical testing, polymer sample solutions are prepared by dissolving the polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution is between 0.1 mg/mL to 0.9 mg/mL with a BHT concentration of 1.25 mg BHT/mL of TCB. Samples are cooled to 135° C. for testing.

High temperature size exclusion chromatography is performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw) and number average molecular weight (Mn)) and molecular weight distribution (MWD=Mw/Mn), which is also sometimes referred to as the polydispersity index (PDI) of the polymer, are measured by Gel Permeation Chromatography using a Symyx Technology GPC equipped with evaporative light scattering detector and calibrated using polystyrene standards (Polymer Laboratories: Polystyrene Calibration Kit S-M-10: Mp (peak Mw) between 5,000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,000,000). Samples (250 μL of a polymer solution in TCB are injected into the system) are run at an eluent flow rate of 2.0 mL/minute (135° C. sample temperatures, 165° C. oven/columns) using three Polymer Laboratories: PLgel 10 μm Mixed-B 300×7.5 mm columns in series. No column spreading corrections are employed. Numerical analyses are performed using Epoch® software available from Symyx Technologies or Automation Studio software available from Freeslate. The molecular weights obtained are relative to linear polystyrene standards.

Rapid Differential Scanning Calorimetry (Rapid-DSC) measurements are performed on a TA-Q100 instrument to determine the melting point of the polymers. Samples are pre-annealed at 220° C. for 15 minutes and then allowed to cool to room temperature overnight. The samples are then heated to 220° C. at a rate of 100° C./minute and then cooled at a rate of 50° C./minute. Melting points are collected during the heating period.

Samples for infrared analysis are prepared by depositing the stabilized polymer solution onto a silanized wafer (Part number S10860, Symyx). By this method, approximately between 0.12 mg and 0.24 mg of polymer is deposited on the wafer cell. The samples are subsequently analyzed on a Bruker Equinox 55 FTIR spectrometer equipped with Pikes' MappIR specular reflectance sample accessory. Spectra, covering a spectral range of 5,000 cm-1 to 500 cm-1, are collected at a 2 cm-1 resolution with 32 scans.

For ethylene-1-octene copolymers, the wt % octene in the copolymer is determined via measurement of the methyl deformation band at ˜1,375 cm-1. The peak height of this band is normalized by the combination and overtone band at ˜4,321 cm-1, which corrects for path length differences. The normalized peak height is correlated to individual calibration curves from ¹H NMR data to predict the wt % octene in the copolymer content within a concentration range of ˜2 wt % to 35 wt % for octene. Typically, R² correlations of 0.98 or greater are achieved. Reported values (C8 wt %) below 4.1 wt % are outside the calibration range.

### ¹³C-NMR Spectroscopy on Polyolefins

¹³C NMR spectroscopy was used to characterize some polypropylene polymer samples produced in experiments. Unless otherwise indicated, the polymer samples for ¹³C NMR spectroscopy were dissolved in d₂-1,1,2,2-tetrachloroethane and the samples were recorded at 120° C. using a NMR spectrometer with a ¹³C NMR frequency of 125 MHz or greater. Polymer resonance peaks are referenced to mmmm=21.83 ppm. Calculations involved in the characterization of polymers by NMR follow the work of Bovey, F. A. (1969) in Polymer Conformation and Configuration, Academic Press, New York and Randall, J. (1977) in Polymer Sequence Determination, Carbon-¹³NMR Method, Academic Press, New York.

The stereo defects measured as “stereo defects/10,000 monomer units” are calculated from the sum of the intensities of mmrr, mmrm+rrmr, and rmrm resonance peaks times 5,000. The intensities used in the calculations are normalized to the total number of monomers in the sample.

### Polymerization Examples

Ethylene homopolymerizations (PE) were performed according to the above description under the following conditions using the indicated Catalysts (Cat ID) and indicated Activators (Act ID): catalyst complex=25 nmol, Activator=1.1 molar equivalent, ethylene=75 psig, Al(n-octyl)₃=500 nmol, temperature=80° C., total volume=5 mL, solvent=toluene, and a quench pressure of 20 psid pressure loss or a maximum reaction time of 30 minutes. The polymerization conditions and data are reported in Table 1.

TABLE 1
Ethylene polymerization.

| PE | Cat | Act | Yield | | Activity | Mn | Mw | PDI | Tm |
|---|---|---|---|---|---|---|---|---|---|
| Run | ID | ID | (mg) | Time (s) | (g mmol⁻¹h⁻¹) | (g/mol) | (g/mol) | (Mw/Mn) | (° C.) |
| 1 | 1 | 1 | 0 | 1,800 | — | — | — | — | — |
| 2 | 1 | 1 | 0 | 1,800 | — | — | — | — | — |
| 3 | 1 | 1 | 0 | 1,801 | — | — | — | — | — |
| 4 | 1 | 2 | 0 | 1,800 | — | — | — | — | — |
| 5 | 1 | 2 | 0 | 1,801 | — | — | — | — | — |
| 6 | 1 | 2 | 0 | 1,800 | — | — | — | — | — |
| 7 | 2 | 1 | 8.2 | 1,801 | 656 | — | — | — | — |
| 8 | 2 | 1 | 9.1 | 1,800 | 728 | — | — | — | — |
| 9 | 2 | 1 | 8.6 | 1,801 | 688 | — | — | — | — |
| 10 | 4 | 1 | 91.8 | 40 | 330,480 | 209,146 | 373,439 | 1.79 | 133.0 |
| 11 | 4 | 1 | 52.0 | 37 | 202,378 | 221,182 | 382,830 | 1.73 | 133.9 |
| 12 | 4 | 1 | 91.8 | 35 | 377,691 | 195,518 | 362,368 | 1.85 | 134.4 |
| 13 | 5 | 1 | 99.1 | 17 | 839,435 | 33,811 | 59,095 | 1.75 | 130.2 |
| 14 | 5 | 1 | 102.7 | 18 | 821,600 | 27,472 | 58,433 | 2.13 | 130.2 |
| 15 | 5 | 1 | 104.4 | 15 | 1,002,240 | 28,816 | 62,676 | 2.18 | 130.3 |
| 16 | 6 | 1 | 50.0 | 133 | 54,135 | 240,784 | 538,569 | 2.24 | 136.1 |
| 17 | 6 | 1 | 35.4 | 105 | 48,549 | 447,288 | 712,424 | 1.59 | 136.9 |
| 18 | 6 | 1 | 41.3 | 83 | 71,653 | 403,292 | 667,642 | 1.66 | 136.9 |
| 19 | 7 | 1 | 16.3 | 79 | 29,711 | 134,850 | 215,719 | 1.60 | 136.2 |
| 20 | 7 | 1 | 45.0 | 67 | 96,716 | 132,147 | 211,968 | 1.60 | 136.3 |
| 21 | 7 | 1 | 37.3 | 90 | 59,680 | 135,030 | 220,270 | 1.63 | 136.7 |
| 22 | 8 | 1 | 92.1 | 65 | 204,037 | 376,059 | 641,188 | 1.71 | 133.9 |
| 23 | 8 | 1 | 97.8 | 59 | 238,698 | 421,630 | 977,021 | 2.32 | 134.3 |
| 24 | 8 | 1 | 95.4 | 62 | 221,574 | 465,064 | 1,099,453 | 2.36 | 134.3 |
| 25 | 9 | 1 | 93.5 | 61 | 220,721 | 342,997 | 604,531 | 1.76 | 133.8 |
| 26 | 9 | 1 | 95.3 | 66 | 207,927 | 356,348 | 634,654 | 1.78 | 134.1 |
| 27 | 9 | 1 | 95.5 | 73 | 188,384 | 323,708 | 609,260 | 1.88 | 134.6 |
| 28 | 10 | 1 | 109.6 | 12 | 1,315,200 | 55,880 | 106,918 | 1.91 | 132.3 |
| 29 | 10 | 1 | 107.2 | 11 | 1,403,345 | 61,149 | 116,268 | 1.90 | 132.2 |
| 30 | 10 | 1 | 102.3 | 11 | 1,339,200 | 58,370 | 111,091 | 1.90 | 132.2 |

Ethylene-Octene copolymerizations were performed according to the above description under the following conditions using the indicated Catalysts (Cat ID) and indicated Activators (Act ID): catalyst complex=25 nmol, Activator=1.1 molar equivalent, 0.1 mL octene, Al(n-octyl)₃=500 nmol, temperature=80° C., total volume=5 mL, solvent=toluene, and a quench pressure of 15 psid pressure loss or a maximum reaction time of 30 minutes. The polymerization conditions and characterization data are reported in Table 2.

TABLE 2
Ethylene-octene copolymerization.

| EO | Cat | Act | C₂ | Yield | Time | Activity | Mn | Mw | PDI | C8 | Tm |
|---|---|---|---|---|---|---|---|---|---|---|---|
| Run | ID | ID | (psig) | (mg) | (s) | (g mmol⁻¹h⁻¹) | (g/mol) | (g/mol) | (Mw/Mn) | (wt %) | (° C.) |
| 1 | 1 | 1 | 75 | 0 | 1,801 | — | — | — | — | — | — |
| 2 | 1 | 1 | 75 | 0 | 1,800 | — | — | — | — | — | — |
| 3 | 1 | 1 | 75 | 0 | 1,800 | — | — | — | — | — | — |
| 4 | 1 | 2 | 75 | 0 | 1,800 | — | — | — | — | — | — |
| 5 | 1 | 2 | 75 | 0 | 1,801 | — | — | — | — | — | — |
| 6 | 1 | 2 | 75 | 0 | 1,801 | — | — | — | — | — | — |
| 7 | 1 | 1 | 200 | 0 | 1,801 | — | — | — | — | — | — |
| 8 | 1 | 1 | 200 | 0.4 | 1,800 | 32 | — | — | — | — | — |
| 9 | 1 | 1 | 200 | 0 | 1,801 | — | — | — | — | — | — |
| 10 | 1 | 2 | 200 | 0 | 1,801 | — | — | — | — | — | — |
| 11 | 1 | 2 | 200 | 0.1 | 1,802 | 8 | — | — | — | — | — |
| 12 | 1 | 2 | 200 | 0 | 1,800 | — | — | — | — | — | — |
| 13 | 2 | 1 | 75 | 7.7 | 1,803 | 615 | — | — | — | — | — |
| 14 | 2 | 1 | 75 | 8.6 | 1,801 | 688 | — | — | — | — | — |
| 15 | 2 | 1 | 75 | 7.6 | 1,801 | 608 | — | — | — | — | — |
| 16 | 2 | 1 | 200 | 24.3 | 1,782 | 1,964 | 4,210 | 7,170 | 1.70 | | 125 |
| 17 | 2 | 1 | 200 | 21.4 | 1,505 | 2,048 | 3,817 | 6,599 | 1.73 | | 125 |
| 18 | 2 | 1 | 200 | 25.7 | 1,801 | 2,055 | 4,615 | 7,990 | 1.73 | | 126 |
| 19 | 4 | 1 | 75 | 139.3 | 30 | 668,640 | 43,590 | 129,466 | 2.97 | 25.8 | 115.9 |
| 20 | 4 | 1 | 75 | 141.8 | 29 | 704,110 | 26,891 | 124,102 | 4.62 | 26.8 | 115.5 |
| 21 | 4 | 1 | 75 | 140.9 | 29 | 699,641 | 42,255 | 134,796 | 3.19 | 19.9 | 117.1 |
| 22 | 4 | 1 | 200 | 210.6 | 12 | 2,527,200 | 96,344 | 173,424 | 1.80 | 10.7 | 121.3 |
| 23 | 4 | 1 | 200 | 212.0 | 12 | 2,544,000 | 114,932 | 181,168 | 1.58 | 11.1 | 121.7 |
| 24 | 4 | 1 | 200 | 207.8 | 13 | 2,301,785 | 102,633 | 175,571 | 1.71 | 11.0 | 122.1 |
| 25 | 5 | 1 | 75 | 127.7 | 17 | 1,081,694 | 12,831 | 24,239 | 1.89 | 13.8 | 120.4 |
| 26 | 5 | 1 | 75 | 133.5 | 19 | 1,011,789 | 9,264 | 23,899 | 2.58 | 12.7 | 120.5 |
| 27 | 5 | 1 | 75 | 132.7 | 18 | 1,061,600 | 12,852 | 25,344 | 1.97 | 13.0 | 120.7 |
| 28 | 5 | 1 | 200 | 227.6 | 5 | 6,554,880 | 14,731 | 29,687 | 2.02 | 8.4 | 124.6 |
| 29 | 5 | 1 | 200 | 229.7 | 5 | 6,615,360 | 16,531 | 29,938 | 1.81 | 8.2 | 124.2 |
| 30 | 5 | 1 | 200 | 230.7 | 5 | 6,644,160 | 16,496 | 31,214 | 1.89 | 7.4 | 125.1 |
| 31 | 6 | 1 | 75 | 46.2 | 106 | 62,762 | 303,488 | 496,650 | 1.64 | 10.8 | 118.1 |
| 32 | 6 | 1 | 75 | 40.2 | 100 | 57,888 | 308,713 | 502,266 | 1.63 | 10.7 | 114.0 |
| 33 | 6 | 1 | 75 | 40.9 | 96 | 61,350 | 324,259 | 509,099 | 1.57 | 7.8 | 114.2 |
| 34 | 6 | 1 | 200 | 80.0 | 232 | 49,655 | 655,873 | 949,212 | 1.45 | 5.1 | 121.7 |
| 35 | 6 | 1 | 200 | 79.4 | 240 | 47,640 | 560,794 | 969,688 | 1.73 | 4.5 | 121.9 |
| 36 | 6 | 1 | 200 | 85.5 | 260 | 47,354 | 543,299 | 917,019 | 1.69 | 5.7 | 122.1 |
| 37 | 7 | 1 | 75 | 43.2 | 85 | 73,186 | 95,807 | 147,339 | 1.54 | 5.4 | 118.6 |
| 38 | 7 | 1 | 75 | 42.5 | 87 | 70,345 | 95,724 | 146,473 | 1.53 | 6.5 | 119.4 |
| 39 | 7 | 1 | 75 | 46.3 | 73 | 91,332 | 99,850 | 150,964 | 1.51 | 6.8 | 119.1 |
| 40 | 7 | 1 | 200 | 73.8 | 24 | 442,800 | 114,300 | 185,696 | 1.62 | 4.5 | 125.7 |
| 41 | 7 | 1 | 200 | 92.0 | 23 | 576,000 | 107,218 | 182,082 | 1.70 | 4.9 | 125.7 |
| 42 | 7 | 1 | 200 | 89.9 | 23 | 562,852 | 110,867 | 185,432 | 1.67 | 4.0 | 126.3 |
| 43 | 8 | 1 | 75 | 139.5 | 46 | 436,696 | 9,208 | 197,164 | 21.41 | 29.7 | 113.3 |
| 44 | 8 | 1 | 75 | 137.1 | 66 | 299,127 | 8,729 | 225,126 | 25.79 | 29.0 | 113.8 |
| 45 | 8 | 1 | 75 | 136.1 | 54 | 362,933 | 16,508 | 230,836 | 13.98 | 29.8 | 113.8 |
| 46 | 8 | 1 | 200 | 202.2 | 25 | 1,164,672 | 124,039 | 287,194 | 2.32 | 16.2 | 119.8 |
| 47 | 8 | 1 | 200 | 207.2 | 27 | 1,105,067 | 132,328 | 299,061 | 2.26 | 15.0 | 118.8 |
| 48 | 8 | 1 | 200 | 210.1 | 25 | 1,210,176 | 103,314 | 282,945 | 2.74 | 12.1 | 120.6 |
| 49 | 9 | 1 | 75 | 147.4 | 51 | 416,188 | 12,205 | 200,871 | 16.46 | 34.7 | 115.6 |
| 50 | 9 | 1 | 75 | 144.1 | 52 | 399,046 | 11,885 | 213,209 | 17.94 | 31.7 | 114.3 |
| 51 | 9 | 1 | 75 | 143.2 | 42 | 490,971 | 19,804 | 213,715 | 10.79 | 30.4 | 113.9 |
| 52 | 9 | 1 | 200 | 212.3 | 24 | 1,273,800 | 107,874 | 250,646 | 2.32 | 14.1 | 117.4 |
| 53 | 9 | 1 | 200 | 200.6 | 26 | 1,111,015 | 104,338 | 256,015 | 2.45 | 15.3 | 118.2 |
| 54 | 9 | 1 | 200 | 204.0 | 21 | 1,398,857 | 109,144 | 257,749 | 2.36 | 12.0 | 117.9 |
| 55 | 10 | 1 | 75 | 125.2 | 15 | 1,201,920 | 18,837 | 39,202 | 2.08 | 16.3 | 119.9 |
| 56 | 10 | 1 | 75 | 131.9 | 15 | 1,266,240 | 16,166 | 37,956 | 2.35 | 16.6 | 119.4 |
| 57 | 10 | 1 | 75 | 124.6 | 14 | 1,281,600 | 18,738 | 37,229 | 1.99 | 18.7 | 119.3 |
| 58 | 10 | 1 | 200 | 208.3 | 5 | 5,999,040 | 26,042 | 47,750 | 1.83 | 9.6 | 124.4 |
| 59 | 10 | 1 | 200 | 216.7 | 5 | 6,240,960 | 27,975 | 48,505 | 1.73 | 9.0 | 122.8 |
| 60 | 10 | 1 | 200 | 213.5 | 5 | 6,148,800 | 30,527 | 51,701 | 1.69 | 8.1 | 124.6 |

Propylene polymerizations were performed according to the above description under the following conditions using the indicated Catalysts (Cat ID) and Activator 1: catalyst complex=25 nmol, Activator=1.1 molar equivalent, 1.0 ml propylene, 3.895 ml isohexane and 0.205 ml toluene (used as solvent for the catalyst and activator solutions), Al(n-octyl)₃=500 nmol, temperature=70 or 100° C., and a quench pressure of 8 psid pressure loss or a maximum reaction time of 30 minutes. The polymerization conditions and characterization data are reported in Table 3. The polymers exhibited no melting peaks via DSC. ¹³C NMR data for select examples are presented in Table 4.

TABLE 3
Propylene polymerization runs.

| | | | | | Activity (g | | | | |
|---|---|---|---|---|---|---|---|---|---|
| | Cat | T | | | P/mmol | | | | |
| PP run | ID | (° C.) | Yield (g) | Time (s) | cat.hr) | Mn | Mw | Mz | PDI |
| 1 | 4 | 70 | 0.2650 | 31 | 1,230,968 | 28,361 | 48,178 | 93,133 | 1.70 |
| 2 | 4 | 70 | 0.3317 | 41 | 1,164,995 | 25,509 | 44,646 | 93,313 | 1.75 |
| 3 | 4 | 70 | 0.3611 | 32 | 1,624,950 | 24,656 | 42,725 | 85,902 | 1.73 |
| 4 | 4 | 100 | 0.2386 | 35 | 981,669 | 10,820 | 22,507 | 53,330 | 2.08 |
| 5 | 4 | 100 | 0.2666 | 26 | 1,476,554 | 8,593 | 20,418 | 52,437 | 2.38 |
| 6 | 4 | 100 | 0.2618 | 28 | 1,346,400 | 9,026 | 20,706 | 52,731 | 2.29 |
| 7 | 5 | 70 | 0.2137 | 74 | 415,849 | 4,135 | 7,900 | 17,739 | 1.91 |
| 8 | 5 | 70 | 0.2618 | 87 | 433,324 | 4,583 | 8,008 | 15,817 | 1.75 |
| 9 | 5 | 70 | 0.2833 | 62 | 657,987 | 4,591 | 8,195 | 17,437 | 1.78 |
| 10 | 5 | 100 | 0.2562 | 124 | 297,523 | 4,110 | 7,334 | 15,057 | 1.78 |
| 11 | 5 | 100 | 0.1908 | 60 | 457,920 | 3,931 | 7,145 | 14,712 | 1.82 |
| 12 | 5 | 100 | 0.1773 | 53 | 481,721 | 4,292 | 7,677 | 17,113 | 1.79 |
| 13 | 6 | 70 | 0.0106 | 1801 | 848 | 40,513 | 61,607 | 111,255 | 1.52 |
| 14 | 6 | 70 | 0.0107 | 1800 | 856 | 38,265 | 62,132 | 119,410 | 1.62 |
| 15 | 6 | 70 | 0.0119 | 1801 | 951 | 41,199 | 67,452 | 128,567 | 1.64 |
| 16 | 6 | 100 | 0.0069 | 1801 | 552 | — | — | — | — |
| 17 | 6 | 100 | 0.0076 | 1800 | 608 | — | — | — | — |
| 18 | 6 | 100 | 0.0082 | 1800 | 656 | — | — | — | — |
| 19 | 7 | 70 | 0.0034 | 1801 | 272 | — | — | — | — |
| 20 | 7 | 70 | 0.0061 | 1802 | 487 | — | — | — | — |
| 21 | 7 | 70 | 0.0032 | 1800 | 256 | — | — | — | — |
| 22 | 7 | 100 | 0.0069 | 1801 | 552 | — | — | — | — |
| 23 | 7 | 100 | 0.0066 | 1801 | 528 | — | — | — | — |
| 24 | 7 | 100 | 0.0061 | 1801 | 488 | — | — | — | — |
| 25 | 8 | 70 | 0.4094 | 22 | 2,679,709 | 14,848 | 52,664 | 153,741 | 3.55 |
| 26 | 8 | 70 | 0.3893 | 22 | 2,548,145 | 16,565 | 59,319 | 193,398 | 3.58 |
| 27 | 8 | 70 | 0.3939 | 20 | 2,836,080 | 10,504 | 53,647 | 165,502 | 5.11 |
| 28 | 8 | 100 | 0.2305 | 16 | 2,074,500 | 4,859 | 23,523 | 86,625 | 4.84 |
| 29 | 8 | 100 | 0.2445 | 13 | 2,708,308 | 5,550 | 20,656 | 66,414 | 3.72 |
| 30 | 8 | 100 | 0.3097 | 18 | 2,477,600 | 4,159 | 21,969 | 77,247 | 5.28 |
| 31 | 9 | 70 | 0.3982 | 22 | 2,606,400 | 15,802 | 55,959 | 186,024 | 3.54 |
| 32 | 9 | 70 | 0.4072 | 23 | 2,549,426 | 17,994 | 57,158 | 159,673 | 3.18 |
| 33 | 9 | 70 | 0.4468 | 21 | 3,063,771 | 14,167 | 56,754 | 183,309 | 4.01 |
| 34 | 9 | 100 | 0.2645 | 23 | 1,656,000 | 7,594 | 25,584 | 97,194 | 3.37 |
| 35 | 9 | 100 | 0.3225 | 23 | 2,019,130 | 3,832 | 18,967 | 74,254 | 4.95 |
| 36 | 9 | 100 | 0.3078 | 18 | 2,462,400 | 6,150 | 24,412 | 85,505 | 3.97 |
| 37 | 10 | 70 | 0.2980 | 24 | 1,788,000 | 8,961 | 15,550 | 31,546 | 1.74 |
| 38 | 10 | 70 | 0.3172 | 26 | 1,756,800 | 9,245 | 15,585 | 28,608 | 1.69 |
| 39 | 10 | 70 | 0.3417 | 27 | 1,822,400 | 8,182 | 15,369 | 32,437 | 1.88 |
| 40 | 10 | 100 | 0.1208 | 26 | 669,046 | 7,283 | 12,855 | 25,015 | 1.77 |
| 41 | 10 | 100 | 0.2486 | 33 | 1,084,800 | 7,291 | 13,753 | 28,258 | 1.89 |
| 42 | 10 | 100 | 0.2387 | 31 | 1,108,800 | 6,427 | 13,001 | 26,099 | 2.02 |

TABLE 4
¹³C NMR data for select propylene polymerization runs.

| PP | Cat | | | | | | | | | | | stereo |
|---|---|---|---|---|---|---|---|---|---|---|---|---|
| run | ID | m | mmmm | mmmr | rmmr | mmrr | mmrm + rmrr | rmrm | rrrr | mrrr | mrrm | defects* |
| 2 | 4 | 0.586 | 0.214 | 0.160 | 0.036 | 0.202 | 0.112 | 0.038 | 0.052 | 0.077 | 0.110 | 1759 |
| 6 | 4 | 0.574 | 0.202 | 0.155 | 0.039 | 0.195 | 0.119 | 0.043 | 0.056 | 0.080 | 0.111 | 1784 |
| 8 | 5 | 0.640 | 0.292 | 0.168 | 0.030 | 0.186 | 0.090 | 0.026 | 0.040 | 0.063 | 0.106 | 1505 |
| 12 | 5 | 0.628 | 0.277 | 0.165 | 0.031 | 0.184 | 0.097 | 0.030 | 0.042 | 0.068 | 0.107 | 1553 |
| 26 | 8 | 0.465 | 0.085 | 0.121 | 0.051 | 0.172 | 0.176 | 0.067 | 0.103 | 0.129 | 0.097 | 2075 |
| 30 | 8 | 0.460 | 0.083 | 0.115 | 0.053 | 0.165 | 0.177 | 0.073 | 0.102 | 0.130 | 0.101 | 2077 |
| 32 | 9 | 0.463 | 0.083 | 0.123 | 0.049 | 0.172 | 0.177 | 0.067 | 0.103 | 0.129 | 0.097 | 2078 |
| 36 | 9 | 0.460 | 0.086 | 0.113 | 0.053 | 0.166 | 0.178 | 0.073 | 0.102 | 0.129 | 0.100 | 2082 |
| 38 | 10 | 0.488 | 0.121 | 0.132 | 0.045 | 0.190 | 0.146 | 0.044 | 0.096 | 0.118 | 0.109 | 1898 |
| 42 | 10 | 0.488 | 0.120 | 0.131 | 0.044 | 0.186 | 0.151 | 0.048 | 0.094 | 0.118 | 0.108 | 1925 |

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

1. A catalyst compound represented by the Formula (I): 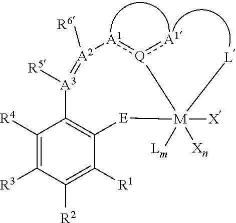
wherein:
M is a group 3, 4, 5, or 6 transition metal or Lanthanide;
E is O, S, or NR⁹⁹, where R⁹⁹ is hydrogen, C₁-C₄₀ hydrocarbyl, C₁-C₄₀ substituted hydrocarbyl, monovalent heteroatom, or a monovalent substituted heteroatom group;
Q is group 14, 15, or 16 atom that forms a bond to metal M;
A¹ and A^{1′} are independently C, N, or C(R³²), where R³² is selected from hydrogen, C₁-C₂₀ hydrocarbyl, C₁-C₂₀ substituted hydrocarbyl, monovalent heteroatom, or a monovalent substituted heteroatom group;
A¹QA^{1′} are part of a heterocyclic Lewis base containing 4 to 40 non-hydrogen atoms;
A² and A³ are independently a group 14 atom;
each R^{5′} and R^{6′} is independently hydrogen, C₁-C₄₀ hydrocarbyl, C₁-C₄₀ substituted hydrocarbyl, monovalent heteroatom, or a monovalent substituted heteroatom group;
R^{6′}-A²=A³-R^{5′} is a divalent group containing 2 to 40 non-hydrogen atoms, where R^{5′} and R^{6′} optionally join to form a hydrocarbyl ring, a substituted hydrocarbyl ring, a heterocyclic ring, or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
L′ is a neutral Lewis base joined to the heterocyclic Lewis base containing A¹QA^{1′};
X′ is an anionic ligand that is optionally joined to L′;
L is a neutral Lewis base;
X is an anionic ligand;
n is 1 or 2;
m is 0 or 1;
n+m is 0, 1 or 2;
each of R¹, R², R³, and R⁴ is independently hydrogen, C₁-C₄₀ hydrocarbyl, C₁-C₄₀ substituted hydrocarbyl, monovalent heteroatom, or a monovalent substituted heteroatom group, or optionally one or more of R¹ and R², R² and R³, R³ and R⁴, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms; and
an X group may be joined to an L group to form a monoanionic bidentate group, and any two X groups may be joined together to form a dianionic ligand group.

2. The catalyst compound of claim 1, wherein the catalyst compound is represented by the Formula (Ia): 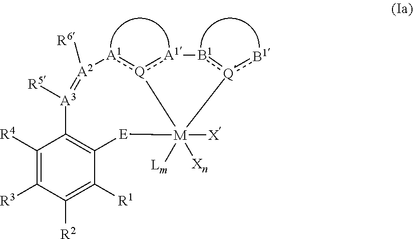
wherein Q′ is group 14, 15, or 16 atom that forms a bond to metal M;
B¹ and B^{1′} are independently C, N, or C(R³²), where R³² is selected from hydrogen, C₁-C₂₀ hydrocarbyl, C₁-C₂₀ substituted hydrocarbyl, monovalent heteroatom, or a monovalent substituted heteroatom group;
B¹QB^{1′} are part of a heterocyclic Lewis base containing 4 to 40 non-hydrogen atoms joined to the heterocyclic Lewis base containing A¹QA^{1′};
X′ is an anionic ligand that is optionally joined to the heterocyclic Lewis base containing B¹Q′B^{1′}.

3. The catalyst compound of claim 1, wherein the catalyst compound is represented by the Formula (Ib): 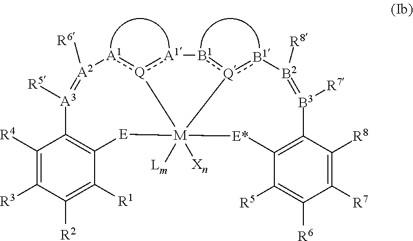
wherein B² and B³ are independently a group 14 atom;
each R^{7′} and R^{8′} is independently hydrogen, C₁-C₄₀ hydrocarbyl, C₁-C₄₀ substituted hydrocarbyl, monovalent heteroatom, or a monovalent substituted heteroatom group;
R^{7′}—B³═B²—R^{8′} is a divalent group containing 2 to 40 non-hydrogen atoms, where R^{5′} and R^{6′} optionally join to form a hydrocarbyl ring, a substituted hydrocarbyl ring, a heterocyclic ring, or a substituted heterocyclic ring, where the ring has 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
each R⁵, R⁶, R⁷, and R⁸ is independently a hydrogen, a C₁-C₄₀ hydrocarbyl, a C₁-C₄₀ substituted hydrocarbyl, a heteroatom, or substituted heteroatom, or optionally one or more adjacent R groups, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms;
E* is O, S, or NR⁹⁹, where R⁹⁹ is hydrogen, C₁-C₄₀ hydrocarbyl, C₁-C₄₀ substituted hydrocarbyl, or a heteroatom-containing group.

4. The catalyst compound of claim 1, wherein the catalyst compound is represented by the Formula (III): 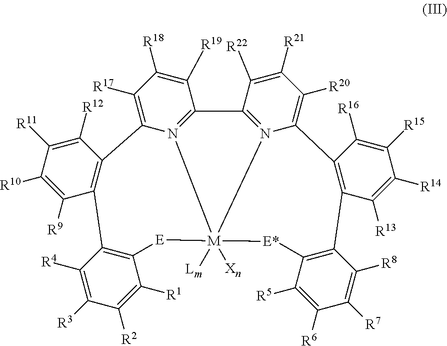
wherein each R¹³, R¹⁴, R¹⁵, and R¹⁶, is independently a hydrogen, a C₁-C₄₀ hydrocarbyl, a C₁-C₄₀ substituted hydrocarbyl, a heteroatom, or substituted heteroatom, or optionally one or more adjacent R groups, join to form a hydrocarbyl ring, substituted hydrocarbyl ring, heterocyclic ring, or substituted heterocyclic ring, said ring having 5, 6, 7, or 8 ring atoms, and where substituents on the ring can join to form one or more additional hydrocarbyl rings, substituted hydrocarbyl rings, heterocyclic rings, or substituted heterocyclic rings, said rings having 5, 6, 7, or 8 ring atoms.

5. The catalyst compound of claim 1, wherein the catalyst compound is represented by Formula (IV): 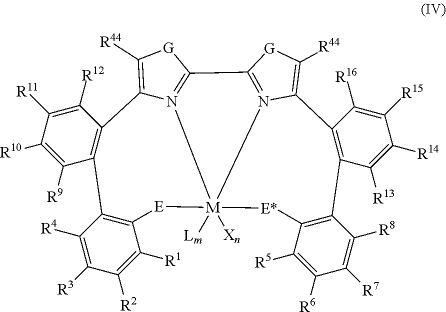
wherein, M, m, n, L, X, E, E*, R¹, R², R³, R⁴, R⁵, R⁶, R⁷, R⁸, R⁹, R¹⁰, R¹¹, R¹², R¹³, R¹⁴, R¹⁵, R¹⁶, and R⁹⁹ are as described in the above claims, each G is independently S, O, or NR²⁴, and each R²⁴ group and each R⁴⁴ group is independently selected from hydrogen, heteroatoms, C₁-C₂₀ alkyls, C₁-C₂₀ alkoxides, C₁-C₂₀ amides, and C₁-C₂₀ substituted alkyls, and wherein two adjacent R²⁴ and or R⁴⁴ groups on the same ring can be joined to form one or more hydrocarbyl rings, substituted hydrocarbyl rings, heterocyclic rings or a substituted heterocyclic rings, where each ring has 5, 6, 7, or 8 ring atoms, and where substituents on the ring can join to form one or more additional hydrocarbyl rings, substituted hydrocarbyl rings, heterocyclic rings, or substituted heterocyclic rings.

6. The catalyst compound of claim 1, wherein M is Hf, Ti or Zr.

7. The catalyst compound of claim 1, wherein E and E* if present are oxygen.

8. The catalyst compound of claim 1, wherein Q is nitrogen.

9. The catalyst compound of claim 1, wherein the fragment R^{6′}-A²=A³-R^{5′} forms an aromatic ring.

10. The catalyst compound of claim 1, wherein the fragment R^{6′}-A²=A³-R^{5′} forms a 5 or 6 membered aromatic ring.

11. The catalyst compound of claim 1, wherein A¹QA^{1′} forms a substituted or unsubstituted pyridyl ring.

12. The catalyst compound of claim 1, wherein L′ is a substituted or unsubstituted pyridyl ring.

13. The catalyst compound of claim 5, wherein E and E* are O, each G is S or NR²⁴, each R²⁴ is selected from C₁-C₂₀ alkyl, and each R⁴⁴ is selected from hydrogen or C₁-C₂₀ alkyl.

14. The catalyst compound of claim 13, wherein each G is NR²⁴, each R²⁴ is methyl, ethyl, or propyl, and each R⁴⁴ is hydrogen.

15. The catalyst compound of claim 13, wherein each G is S and each R⁴⁴ is hydrogen.

16. The catalyst compound of claim 1, wherein R¹ and R⁵ (if present) is independently all isomers of methyl, ethyl, propyl, butyl, pentyl, hexyl, heptyl, octyl, nonyl, decyl, undecyl, docecyl, phenyl, substituted phenyl, carbazolyl, substituted carbazolyl, indolyl, substituted indolyl, pyrrolyl, substituted pyrrolyl, naphthyl, substituted naphthyl, anthracenyl, substituted anthracenyl, fluorenyl, substituted fluorenyl, cyclohexyl, cyclooctyl, cyclododecyl, adamantanyl, and substituted adamantanyl.

17. The catalyst compound of claim 1, wherein the catalyst compound comprises one or more of the following catalyst compounds:

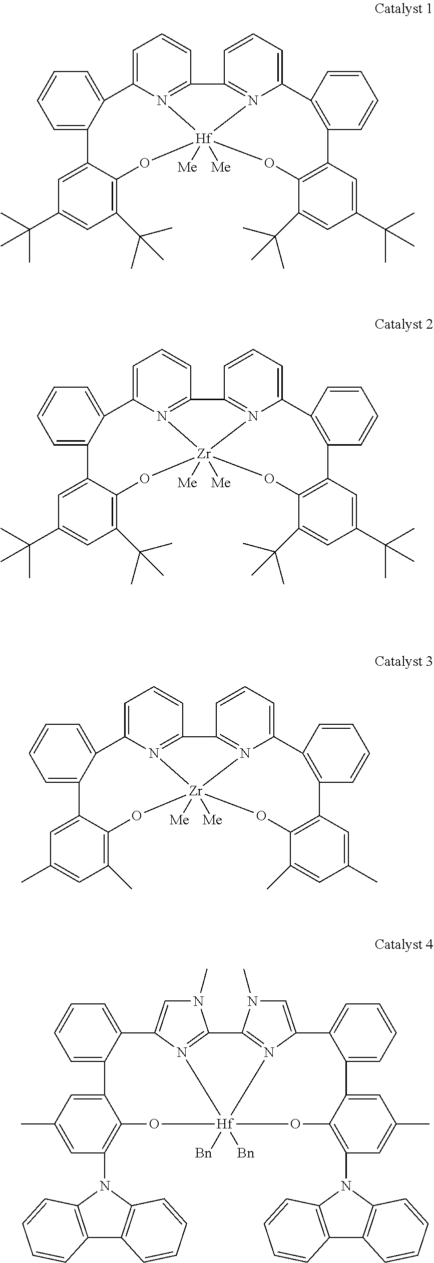

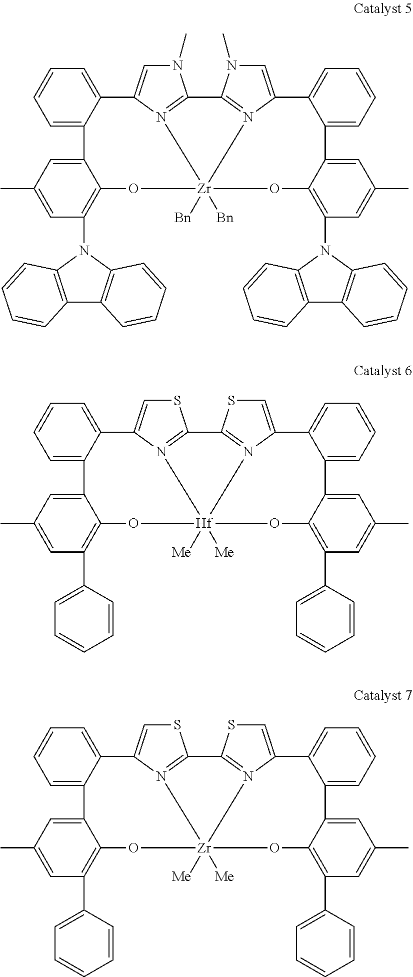

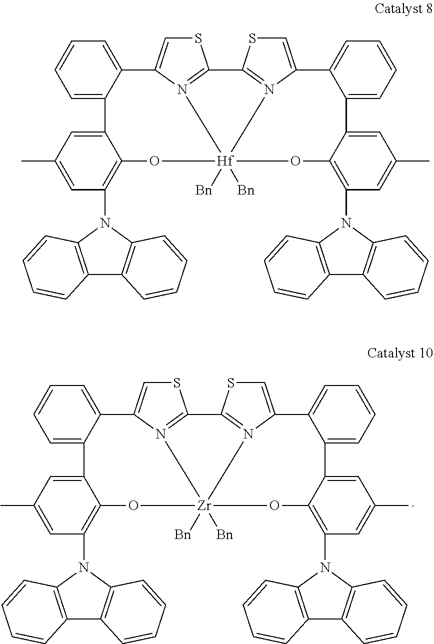

18. A process to polymerize olefins, comprising:
contacting one or more olefins with a catalyst system including the catalyst compound of claim 1; and
obtaining a polymer.
